(19) United States
(12) Patent Application Publication
(10) Pub. No.: US 2022/0372272 A1
(43) Pub. Date: Nov. 24, 2022

(54) MAGNETIC SHAPE-MEMORY POLYMERS (mSMPs) AND METHODS OF MAKING AND USING THEREOF

(71) Applicants: OHIO STATE INNOVATION FOUNDATION, Columbus, OH (US); GEORGIA TECH RESEARCH CORPORATION, Atlanta, GA (US)

(72) Inventors: Ruike ZHAO, Columbus, OH (US); Xiao KUANG, Atlanta, GA (US); Hang QI, Atlanta, GA (US); Qiji ZE, Columbus, OH (US); Shuai WU, Columbus, OH (US)

(21) Appl. No.: 17/621,150

(22) PCT Filed: Jun. 19, 2020
(86) PCT No.: PCT/US2020/038759

§ 371 Date: Dec. 20, 2021

Related U.S. Application Data
(60) Provisional application No. 62/907,230, filed on Sep. 27, 2019.
(60) Provisional application No. 62/863,848, filed on Jun. 19, 2019.

(51) Int. Cl. C08L 63/00

(52) U.S. Cl. CPC C08L 63/00; C08L 2201/12; C08L 2207/04; C08L 2203/02

(57) ABSTRACT

Disclosed magnetic shape-memory compositions that comprise a polymer matrix and a population of hard-magnetic particles dispersed within the polymer matrix. In some embodiments, the magnetic shape-memory compositions can further comprise a population of auxiliary magnetic particles (e.g., ferrite particles) dispersed within the polymer matrix. The compositions can exhibit 1) reversible, fast, and controllable transforming deformation, 2) shape-locking, and 3) reprogramming capabilities.

### CROSS-REFERENCE TO RELATED APPLICATIONS

This application claims the benefit of priority to 62/863,848 filed Jun. 19, 2019, and 62/907,230 filed Sep. 27, 2019, the disclosure of which is incorporated herein by reference in its entirety.

### STATEMENT REGARDING FEDERALLY SPONSORED RESEARCH OR DEVELOPMENT

This invention was made with government grant support under award abstract numbers FA9550-19-1-0151 awarded by the AFOSR, CMMI-1943070, and CMMI-1939543 by the National Science Foundation. The government has certain rights in the invention.

### BACKGROUND

Soft active materials are flexible, functional materials or composites that are sensitive and responsive to stimuli, such as heat, light, electric and/or magnetic fields, etc. Soft active materials (SAM) capable of transforming into programmed shapes in a rapid, untethered, and controllable manner can bring promising applications in diverse fields such as reconfigurable structures, flexible electronics, soft robots, morphing structures, active acoustic metamaterials, drug delivery, minimally invasive surgery, biomedical engineering, and biomedical devices. Several types of shape-programmable soft matter have been proposed but often limited to unchangeable deformation patterns, low responsive speed, and low controllability, which substantially limit their applications in such potentially useful areas. A wide range of materials have been developed in the past, including liquid crystals elastomers, hydrogels, magnetic soft materials (MSM), and shape memory polymers (SMPs).

SAMs, magnetic-responsive soft materials that incorporate hard-magnetic particles into soft matrices are particularly attractive due to their capability of undergoing rapid, large and reversible deformation when a magnetic field is applied. In addition, the magnetic stimulation offers a safe and effective manipulation method for biomedical applications, which typically require remote actuation in enclosed and confined spaces. Although efforts have been made to program complex magnetic domains and control external fields, to date, however, existing magnetic-actuated materials have some significant limitations. First, they can only keep their actuated state with a prescribed formation pattern under a continuous application of an external magnetic field. Once the external magnetic field is removed, the material goes back to its undeformed shape, making it impossible to sustain the deformed shape without a continuous consumption of external energy. In addition, the actuation pattern is limited by the initial design of the magnetic domain. These constraints substantially limit the material system's versatility. Therefore, a reprogrammable magnetic soft material with flexibilities on shape-locking and reversible fast-transforming is highly desirable as it offers a transformative way to address these limitations, permits its multifunctionality with tunable physical properties such as geometry, stiffness, acoustic properties and many others.

### SUMMARY

Disclosed are magnetic shape-memory compositions that comprise a polymer matrix and a population of hard-magnetic particles dispersed within the polymer matrix. In some embodiments, the magnetic shape-memory compositions can further comprise a population of auxiliary magnetic particles (e.g., ferrite particles) dispersed within the polymer matrix. The compositions can exhibit 1) reversible, fast, and controllable transforming deformation, 2) shape-locking, and 3) reprogramming capabilities.

FIGS. 2A-2B schematically illustrates the mSMPs described herein. The mSMP comprise a shape memory polymer matrix with embedded hard-magnetic particles that can have large magnetic remanence (such as NdFeB). In some examples, the shape memory polymer can have glass transition temperature Tg above room temperature and/or above physiological temperature (e.g., approximately 50° C., approximately 55° C., approximately 60° C., approximately 65° C., approximately 70° C., approximately 75° C., or approximately 80° C.).

The material can be cured (e.g., thermally cured, photocured, or a combination thereof) to form articles (or portions of articles) with a prescribed shape. The composition can then be magnetized by applying a large impulse magnetic field (e.g., about 1 T, about 1.5 T, about 2 T, about 2.5 T, about 3 T, about 3.5 T, about 4 T, about 4.5 T, or about 5 T) to achieve a desired magnetic domain distribution. At room temperature (e.g., below the Tg of the polymer matrix), the material is too stiff to be activated by applying a regular actuation magnetic field (below 100 mT). However, as shown in FIG. 2A, heating the sample to a temperature above its Tg will significantly decrease the stiffness; at this time, applying a small magnetic field will rapidly activate the material to the programmed shape. At this moment, turning off the applied magnetic field will return the material to its original shape this behavior is referred to as reversible fast-transforming behavior. However, if the magnetic actuation is maintained and the material is cooled below its Tg, then its deformed shape can be locked at low temperature without further application of magnetic field (e.g., referred to as shape locking behavior). Therefore, by controlling the temperature and the application of magnetic field, we can achieve shape-locking and reversible fast-transforming behaviors in a single material system.

Further, one can readily reprogram the mSMP material. As shown in FIG. 2B, the initial magnetic domain of the mSMP is in the horizontal direction, leading to a bending motion when a vertical magnetic field is applied. By way of example, to reprogram the material's deformation to reach an arc shape, the material is first heated to a temperature above its Tg, deform it into an arc, then lower down the temperature to lock the shape. A strong impulse magnetic field can then be applied to re-magnetize the particles to form new magnetic domains. Heating the material and applying the actuation magnetic field will deform the material into the new shape. With this remagnetization strategy, the material can essentially be reprogrammed into any shape on demand.

The compositions can be used to form (in whole or in part) a variety of articles including medical devices.

### DESCRIPTION OF DRAWINGS

FIG. 1 illustrates mechanisms associated with magnetic-actuated soft materials and their fabrication by 3D printing.

FIGS. 2A-2B are schematics of the mSMP working mechanisms. FIG. 2A illustrates fast-transforming and shape-locking. FIG. 2B illustrates magnetic reprogramming. White arrows indicate magnetic polarity of the material.

FIG. 3 illustrates chemical structures of acrylate oligomers, cross-linker, and initiators used to prepare polyacrylate smp.

FIG. 4 illustrates the epoxy oligomer, chain extender, and cross-linker used to prepare an example SMP.

FIG. 5 illustrates the magnetic field superposition for mSMP unlocking and actuation. Panel A shows the applied high-frequency magnetic field for heating and low-frequency magnetic field for actuation. Panel B includes a plot and photographs showing the displacement.

FIG. 6 illustrates mSMP reprogramming.

FIG. 7 is a plot showing magnetic induction heating for mSMP unlocking. B1<B2<B3.

FIG. 8 illustrates some promising applications of mSMP on soft robotics and metamaterials.

FIG. 9A-9D are schematics and properties of magnetic shape memory polymers (M-SMPs). FIG. 9A illustrates the working mechanism of M-SMPs. FIG. 9B is a plot of storage modulus and tan δ versus temperature for the neat SMP and P15-15 (M-SMP with 15 vol % Fe₃O₄ and 15 vol % NdFeB). FIG. 9C is a graph of the effect of NdFeB and Fe₃O₄ particle loadings on the Young's modulus of the M-SMP at 85° C. FIG. 9D is a graph of the shape memory performance of P15-15 (dashed line: stress; solid line: strain; dotted line: temperature).

FIG. 10A-10G illustrates fast-transforming and shape locking of M-SMPs via superimposed magnetic fields. FIG. 10A illustrates the experimental setup for the superimposed magnetic fields: the two parallel electric coils are used to generate the actuation magnetic field, Bₐ; the solenoid coil in the middle is used to generate the heating magnetic field, Bₕ. Scale bar: 15 mm. FIG. 10B illustrates the cantilever bending and shape locking. Scale bar: 5 mm. FIG. 10C shows the magnetic field profiles of Bₐ and Bₕ and beam deflection and temperature with respect to time. The gradient background color illustrates the time-dependent temperature change with the scale bar on the side. FIG. 10D illustrates the locked bending beam carrying a weight (23 g) 64 times heavier than its own weight (0.36 g). FIG. 10E illustrates the design and magnetization profile of a four-arm M-SMP gripper (0.47 g). FIG. 10F illustrates the M-SMP gripper lifting a lead ball (23 g) without shape locking. Scale bar: 5 mm. FIG. 10G illustrates the M-SMP gripper lifting a lead ball (23 g) with shape locking. Scale bar: 5 mm.

FIG. 11A-11J shows sequential actuation of M-SMPs and its application as digital logic circuits. FIG. 11A is a graph of temperature and corresponding Young's moduli of three M-SMPs containing different Fe₃O₄ loadings. FIG. 11B illustrates the design of a flower-like structure using P5-15 and P25-15 M-SMPs. FIG. 11C shows the magnetic field profiles (Bₐ and Bₕ) and deflection of the sequentially actuated M-SMPs with respect to time. FIG. 11D shows sequential shape transforming and shape locking. Scale bars 5 mm. FIG. 11E shows a truth table for a D-latch. FIG. 11F is an schematic of an M-SMP D-latch logic with two magnetic fields (Bₐ and Bₕ) serving as input and LED state as output. FIG. 11G is a graph showing the relationship between Bₕ and the enabled input E of the D-latch. FIG. 11H shows the design of the sequential logic circuit using M-SMPs with different Fe₃O₄ loadings (P5-15, P15-15, and P25-15). FIG. 11I shows magnetic control for a sequential logic circuit with three steps and tunable outputs. FIG. 11J show LED indications for four different output states. Scale bars 5 mm.

FIG. 12A-12G shows the application of M-SMP for morphing antennas. FIG. 12A is a schematic of a single-cantilever monopole antenna. FIG. 12B illustrates cantilever antenna with two different magnetization profiles by reprogramming. Scale bars 5 mm. FIG. 12C is a plot of experimental (solid lines) and simulation (dashed lines) results of the S₁₁ spectrum. FIG. 12D is a schematic and magnetization profile of a reconfigurable helical antenna. FIG. 12E shows the actuation of the helical antenna under different Bₐ. Scale bars 5 mm. FIG. 12F is a plot of experimental (solid lines) and simulation (dashed lines) results of S₁₁ band for the reconfigurable helical antenna at different heights. FIG. 12G is a 2D polar plot of the simulated radiation patterns of the helical antenna at different heights.

FIG. 13A-B shows resin formulation and morphology of magnetic particles. FIG. 13A shows the chemical structures of each component for the resin. FIG. 13B shows SEM images of Fe₃O₄. Scale bars: 50 μm. FIG. 13C shows SEM images of NdFeB. Scale bars: 50 μm.

FIG. 14 is a graph showing the FTIR spectrum of polymer matrix before and after curing at 80° C. for 4 h and post-treated at 120° C. for 30 min. The sharp decrease of the band intensity at 1637 cm⁻¹ is attributed to vinyl carbon-carbon stretching vibration and indicates the polymerization of the cross-linkers and monomers into a polymer.

FIG. 15 shows SEM images of M-SMP(P15-15) at two different magnifications. Scale bars: 50 μm.

FIG. 16A-16D shows the mechanical properties of M-SMP. FIG. 16A is a graph of the tensile stress-strain curves of SMP at 25° C., 55° C., and 85° C. FIG. 16B is a graph of the comparison of the temperature-dependent Young's moduli for neat matrix (SMP) and P15-15. FIG. 16C is a graph of the cyclic tensile test of P15-15 loaded to 10% stain at 85° C. FIG. 16D is a graph of the cyclic test of P15-15 with different maximum strains. The strain rate is 0.2/min.

FIG. 17A-17D shows the characterization of shape memory performance of neat SMP and M-SMP (P15-15) using DMA. FIG. 17A is a graph of temperature, strain, and stress as functions of time for neat SMP in one cycle. FIG. 17B is a graph of temperature, strain, and stress as functions of time for M-SMP in four cycles (dashed line: stress; solid line: strain; dotted line: temperature). FIG. 17C is a graph of R_{f} and Rᵣ as functions of applied stress for neat SMP. FIG. 17D is a graph of R_{f} and Rᵣ as functions of cycle number for SMP and M-SMP (P15-15).

FIG. 18A-18D illustrates magnetic inductive heating characterization. FIG. 18A is a schematic of the experimental setup for measuring high-frequency hysteresis loops. FIG. 18B are hysteresis loops of P15-15 under 60 kHz AC magnetic field with different strengths (19.4 mT, 31.4 mT, 43.5 mT, and 55.5 mT). FIG. 18C are hysteresis loops of M-SMPs with different Fe₃O₄ loadings (P0-15, P5-15, P15-15, and P25-15) under 60 kHz AC magnetic field. FIG. 18D is a graph of the magnetic heating power density of M-SMPs with different Fe₃O₄ loadings under different magnetic field strengths.

FIG. 19 is a graph of static magnetization curves of M-SMPs. The remnant magnetic moment densities of P15-0 and P15-15 are 3.32 kA/m and 88.42 kA/m, respectively.

FIG. 20A-20B shows temperature-dependent demagnetization property curve of P15-15. FIG. 20A is a graph of the influence of temperature on the magnetization of P15-15. FIG. 20B is a temperature-time diagram of inductively heated M-SMP using different heating magnetic fields (Bₕ₁<Bₕ₂<Bₕ₃). T_{g} is the glass transition temperature, and T_{dm} is the demagnetization temperature at which the magnetization of the M-SMP starts to drop significantly. Since it is reasonable to assume that the normalized remnant magnetization should be applied to M-SMPs with different NdFeB loadings, this figure should be applicable to all M-SMP samples used in this paper. At 150° C., the normalized remnant magnetization M̅ᵣ̅ is approximately 0.91, which can be considered as a significant reduction. Therefore, we choose 150° C. as the demagnetization temperature.

FIG. 21 illustrates the design and magnetization process of the gripper. (a) Unfolded view of the gripper. (b) Magnetization process of the gripper, Bᵢ indicates the impulse magnetic field. Scale bar: 5 mm.

FIG. 22A-22C illustrates the tensile properties of M-SMPs with different Fe₃O₄ loading at different temperatures. FIG. 22A is a graph of the comparison of tensile stress-strain curves for three different M-SMPs at 85° C. FIG. 22B is a graph of the tensile stress-strain curves of P15-15 at different temperatures with 3% strain. FIG. 22C is a graph of Young's moduli of three M-SMPs as functions of temperature. The strain rate is 0.2/min.

FIG. 23 illustrates the design and dimensions of the samples used for sequential actuations. (a) shows unfolded view and dimensions of the flower structure. (b) shows unfolded view and dimensions of the flower sample. The top, middle, and bottom layers are P5-15, P15-15, and P25-15, respectively. The ratio between the dimensions of P5-15, P15-15, and P25-15 is 0.8:0.9:1.

FIG. 24A-24B illustrates the design of the M-SMP-enabled D-latch system. FIG. 24A is schematic of the system. FIG. 24B is a diagram of the equivalent RC delay circuit. T—the temperature of M-SMP, Tₘₐₓ—the maximum temperature which the M-SMP can reach, Tₐ—the threshold temperature at which the M-SMP can be actuated, Uᵢₙ—the input voltage of the RC delay circuit, Uₒᵤₜ—the voltage of capacitor C₁, Uₘₐₓ—the maximum voltage which the capacitor can reach, Uₜ—the threshold voltage at which the input signal can be recognized as high voltage level (Binary 1) by the D-latch. Theoretically, Uₘₐₓ=Uᵢₙ×R₂/(R₁+R₂).

FIG. 25 is schematic of the sequential logic circuit using three M-SMPs with different Fe₃O₄ loadings (P5-15, P15-15, and P25-15). R1>R2>R3 means the time constants of three materials increase with the Fe₃O₄ loadings.

FIG. 26A-26C shows characterizations of the cantilever-beam antenna. FIG. 26A is a graph showing height versus actuation magnetic field. FIG. 26B is a graph showing frequency properties of different heights. FIG. 26C is a 2D polar plot of simulated radiation patterns of the antenna at different heights.

FIG. 27 shows design and magnetization process of the helical antenna. (a) Unfolded view of the helical antenna. (b) Magnetization process of helix antenna, Bᵢ indicates the impulse magnetic field. Scale bar: 5 mm.

FIG. 28 is a table showing the formulation of the resin matrix for the SMP.

FIG. 29 is a table showing the formulation for the M-SMPs.

FIG. 30 is a table showing the input definition of the sequential logic circuit using M-SMPs with different Fe₃O₄ loadings.

FIG. 31 is a logic table of the sequential logic circuit using M-SMPs with different Fe₃O₄ loadings.

FIG. 32A-32C shows a M³DIW system and working mechanism. FIG. 32A is a schematic of the M³DIW fabrication and material composition. FIG. 32B shows the material distribution and magnetization directions of a one-dimensional stripe with four segments. FIG. 32C shows four different actuation modes achieved by temperature changing, shape locking, and magnetic field reversing.

FIG. 33A-33F shows characterizations of the inks and the printed materials. FIG. 3A shows the effects of NdFeB particle size and UV exposure time on the curable depth. The NdFeB loading is fixed to 20 vol %. FIG. 33B shows the effects of NdFeB loading and UV exposure time on the curable depth. The NdFeB particle size range is fixed to G2. FIG. 33C shows the effects of silica loading, printing pressure, and nozzle moving speed on the printed filament shape. FIG. 33D is a graph of the storage modulus and tan δ versus temperature of M-SMP and MSM using 15 vol % G2 NdFeB. The T_{g} of M-SMP is about 66° C. The printed specimen for characterization is shown on the left. FIG. 33E is a graph of the nominal stress versus stretch of M-SMP and MSM using 15 vol % G2 NdFeB at 22° C. and 90° C. Solid lines are from experiments, and the dash lines are fitting results using the Neo-Hookean constitution. FIG. 33F shows the magnetic moment densities of M-SMP and MSM using 15 vol % G2 NdFeB.

FIG. 34A-34B are schematic designs, experiments, and simulations of pop-up structures with multimodal actuation. FIG. 34A illustrates an asterisk design with alternating material distribution and magnetization directions. FIG. 34B illustrates a square frame design with inwards-pointing magnetization directions.

FIG. 35A-35F shows a chiral active metamaterial with tunable Poisson's ratio and shear strain. FIG. 35A is a schematic design of material distribution and magnetization directions. FIG. 35B shows printed metamaterials. FIG. 35C illustrates experiments and simulations of the deformed shapes actuated by upward external magnetic field at 22° C. and 90° C. FIG. 35D illustrates experiments and simulations of the deformed shapes actuated by downward external magnetic field at 22° C. (e) and 90° C. (f). FIG. 35E is a graph of strains and Poisson's ratio versus magnetic field at 22° C. obtained from simulations. FIG. 35F is a graph of strains and Poisson's ratio versus magnetic field at 90° C. obtained from simulations.

### DETAILED DESCRIPTION

Disclosed are magnetic shape-memory compositions that comprise a shape memory polymer matrix and a population of hard-magnetic particles dispersed within the polymer matrix. In some embodiments the term “shape memory polymer matrix” refers to a polymer matrix that exhibits variable physical properties (e.g., variable stiffness) based on temperature. In some embodiments, the magnetic shape-memory compositions can further comprise a population of auxiliary magnetic particles (e.g., ferrite particles) dispersed within the polymer matrix.

The compositions can be formed into articles, including medical devices, guidewire or portion thereof, such as a guidewire tip (e.g., a TAVR guidewire or TAVR guidewire tip). In some embodiments, the article exhibits one or more of (1) reversible, fast, and controllable transforming deformation, 2) shape-locking, and 3) reprogramming capabilities. In some embodiments, the article exhibits an actuation speed ranging from 1 millisecond to 10 minutes. For example, the actuation speed can range from 1 millisecond to 5 minutes, from 10 milliseconds to 1 minute, from 1 millisecond to 1 minute, from 1 millisecond to 10 milliseconds, from 1 millisecond to 1 second, from 1 millisecond to 30 milliseconds, from 1 minute to 5 minutes, from 1 second to 10 seconds, or from 1 second to 30 seconds.

Shape Memory Polymer Matrix

The shape memory polymer matrix can comprise any suitable polymer or blend of polymers. Examples of suitable materials include thermoplastics (e.g., thermoplastic elastomers), thermosets, single-single crosslinked network, interpenetrating networks, semi-interpenetrating networks, or mixed networks. The polymers can be a single polymer or a blend of polymers. The polymers can be linear or branched thermoplastic elastomers or thermosets with side chains or dendritic structural elements.

Suitable polymer include, but are not limited to, polyepoxides (epoxy resins), polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate). Examples of other suitable polymers include polystyrene, polypropylene, polyvinyl phenol, polyvinylpyrrolidone, chlorinated polybutylene, poly(octadecyl vinyl ether), ethylene vinyl acetate, polyethylene, poly(ethylene oxide)-poly(ethylene terephthalate), polyethylene/nylon (graft copolymer), polycaprolactones-polyamide (block copolymer), poly(caprolactone) dimethacrylate-n-butyl acrylate, poly(norbornyl-polyhedral oligomeric silsequioxane), polyvinylchloride, urethane/butadiene copolymers, polyurethane block copolymers, styrene-butadiene-styrene block copolymers, and the like.

In some embodiments, the polymer matrix can comprise a shape memory polymer (SMPs). SMPs are known in the art and generally refer to polymeric materials that demonstrate the ability to return to some previously defined shape when subjected to an appropriate thermal stimulus. Shape memory polymers are capable of undergoing phase transitions in which their shape is altered as a function of temperature. Generally, SMPs have two main segments, a hard segment and a soft segment. The previously defined or permanent shape can be set by melting or processing the polymer at a temperature higher than the highest thermal transition followed by cooling below that thermal transition temperature. The highest thermal transition is usually the glass transition temperature (Tg) or melting point of the hard segment. A temporary shape can be set by heating the material to a temperature higher than the Tg or the transition temperature of the soft segment, but lower than the Tg or melting point of the hard segment. The temporary shape is set while processing the material at the transition temperature of the soft segment followed by cooling to fix the shape. The material can be reverted back to the permanent shape by heating the material above the transition temperature of the soft segment.

In some embodiments, the polymer matrix can comprise a biocompatible polymer or blend of biocompatible polymers. In certain embodiments, the polymer matrix can comprise a polyester (e.g., polycaprolactone, polylactic acid, polyglycolic acid, a polyhydroxyalkanoate, and copolymers thereof), a polyether (e.g., a polyalkylene oxides such as polyethylene glycol, polypropylene oxide, polybutylene oxide, and copolymers thereof), blends thereof, and copolymers thereof.

In some embodiments, the polymer or blend of polymers forming the polymer matrix can have a Tg of at least −40° C. (e.g., at least −20° C., at least 0° C., at least 25° C., at least 30° C., at least 35° C., at least 40° C., at least 45° C., at least 50° C., at least 55° C., at least 60° C., at least 65° C., at least 70° C., at least 75° C., at least 80° C., at least 85° C., at least 90° C., at least 95° C., at least 100° C., at least 105° C., at least 110° C., at least 115° C., at least 120° C., at least 150° C., at least 200° C. or more). In some embodiments, the polymer or blend of polymers forming the polymer matrix can have a Tg above room temperature (23° C.). In some embodiments, the polymer or blend of polymers forming the polymer matrix can have a Tg above physiological temperature (37° C.). In some embodiments, the polymer or blend of polymers forming the polymer matrix can have a Tg of 250° C. or less (e.g., 200° C. or less, 150° C. or less, 120° C. or less, 115° C. or less, 110° C. or less, 105° C. or less, 100° C. or less, 95° C. or less, 90° C. or less, 85° C. or less, 80° C. or less, 75° C. or less, 70° C. or less, 65° C. or less, 60° C. or less, 55° C. or less, 50° C. or less, 45° C. or less, 40° C. or less, 35° C. or less, 30° C. or less, or 25° C. or less).

The polymer or blend of polymers forming the polymer matrix can have a Tg ranging from any of the minimum values described above to any of the maximum values described above. In some embodiments, the polymer or blend of polymers forming the polymer matrix can have a Tg of from 0° C. to 100° C., a Tg of from 150° C. to 250° C., a Tg of from 25° C. to 100° C., a Tg of from 30° C. to 100° C., a Tg of from 30° C. to 80° C., a Tg of from 38° C. to 100° C., a Tg of from 38° C. to 80° C., a Tg of from 40° C. to 100° C., a Tg of from 40° C. to 80° C., a Tg of from 50° C. to 100° C., or a Tg of from 50° C. to 80° C.

In some embodiments, the polymer matrix can exhibit a Young's modulus of from 10 kPa to 20 MPa (e.g., from 10 kPa to 10 MPa, from 10 kPa to 5 MPa, from 10 kPa to 1 MPa, from 1 MPa to 5 MPa, from 1 MPa to 10 MPa, from 1 MPa to 20 MPa, from 10 kPa to 800 kPa, from 10 kPa to 600 kPa, from 10 kPa to 500 kPa, from 50 kPa to 800 kPa, from 100 kPa to 800 kPa, from 200 kPa to 800 kPa, from 50 kPa to 600 kPa, from 100 kPa to 600 kPa, from 200 kPa to 600 kPa, from 50 kPa to 500 kPa, from 100 kPa to 500 kPa, or from 200 kPa to 500 kPa) when heated to a temperature at or above the Tg of the polymer or blend of polymers but below the melting point or decomposition point of the polymer or blend of polymers. In some embodiments, the polymer matrix can exhibit a Young's modulus of from 10 kPa to 20 MPa (e.g., from 10 kPa to 10 MPa, from 10 kPa to 5 MPa, from 10 kPa to 1 MPa, from 1 MPa to 5 MPa, from 1 MPa to 10 MPa, from 1 MPa to 20 MPa, from 10 kPa to 800 kPa, from 10 kPa to 600 kPa, from 10 kPa to 500 kPa, from 50 kPa to 800 kPa, from 100 kPa to 800 kPa, from 200 kPa to 800 kPa, from 50 kPa to 600 kPa, from 100 kPa to 600 kPa, from 200 kPa to 600 kPa, from 50 kPa to 500 kPa, from 100 kPa to 500 kPa, or from 200 kPa to 500 kPa) when heated to a temperature at or above the Tg of the polymer or blend of polymers (e.g., a temperature equal to the Tg of the polymer or blend of polymers, a temperature equal to 5° C. above the Tg of the polymer or blend of polymers, a temperature equal to 10° C. above the Tg of the polymer or blend of polymers, a temperature equal to 20° C. above the Tg of the polymer or blend of polymers, or a temperature equal to 30° C. above the Tg of the polymer or blend of polymers).

In some embodiments, the polymer matrix can exhibit a Young's modulus of at least 0.1 GPa (e.g., at least 0.5 GPa, at least 1.0 GPa, at least 1.5 GPa, at least 2.0 GPa, at least 2.5 GPa, at least 3 GPa, at least 3.5 GPa, or at least 4 GPa) at a temperature below the Tg (e.g., a temperature at 25° C., a temperature at 37° C., a temperature at 38° C., a temperature at 40° C., or a temperature at 45° C.).

In some embodiments, the polymer matrix can exhibit a Young's modulus of at least 0.1 GPa (e.g., at least 0.5 GPa, at least 1.0 GPa, at least 1.5 GPa, at least 2.0 GPa, at least 2.5 GPa, at least 3 GPa, at least 3.5 GPa, or at least 4 GPa) at 25° C.

In some embodiments, the polymer matrix can exhibit a Young's modulus of at least 0.1 GPa (e.g., at least 0.5 GPa, at least 1.0 GPa, at least 1.5 GPa, at least 2.0 GPa, at least 2.5 GPa, at least 3 GPa, at least 3.5 GPa, or at least 4 GPa) at 37° C.

In some embodiments, the polymer matrix can exhibit a Young's modulus of at least 0.1 GPa (e.g., at least 0.5 GPa, at least 1.0 GPa, at least 1.5 GPa, at least 2.0 GPa, at least 2.5 GPa, at least 3 GPa, at least 3.5 GPa, or at least 4 GPa) at 38° C.

In some embodiments, the polymer matrix can exhibit a Young's modulus of at least 0.1 GPa (e.g., at least 0.5 GPa, at least 1.0 GPa, at least 1.5 GPa, at least 2.0 GPa, at least 2.5 GPa, at least 3 GPa, at least 3.5 GPa, or at least 4 GPa) at 40° C.

In some embodiments, the polymer matrix can exhibit a Young's modulus of at least 0.1 GPa (e.g., at least 0.5 GPa, at least 1.0 GPa, at least 1.5 GPa, at least 2.0 GPa, at least 2.5 GPa, at least 3 GPa, at least 3.5 GPa, or at least 4 GPa) at 45° C.

In some embodiments, the polymer matrix can exhibit a Young's modulus of from 10 kPa to 20 MPa (e.g., from 10 kPa to 10 MPa, from 10 kPa to 5 MPa, from 10 kPa to 1 MPa, from 1 MPa to 5 MPa, from 1 MPa to 10 MPa, from 1 MPa to 20 MPa, from 10 kPa to 800 kPa, from 10 kPa to 600 kPa, from 10 kPa to 500 kPa, from 50 kPa to 800 kPa, from 100 kPa to 800 kPa, from 200 kPa to 800 kPa, from 50 kPa to 600 kPa, from 100 kPa to 600 kPa, from 200 kPa to 600 kPa, from 50 kPa to 500 kPa, from 100 kPa to 500 kPa, or from 200 kPa to 500 kPa) at 50° C.

In some embodiments, the polymer matrix can exhibit a Young's modulus of from 10 kPa to 20 MPa (e.g., from 10 kPa to 10 MPa, from 10 kPa to 5 MPa, from 10 kPa to 1 MPa, from 1 MPa to 5 MPa, from 1 MPa to 10 MPa, from 1 MPa to 20 MPa, from 10 kPa to 800 kPa, from 10 kPa to 600 kPa, from 10 kPa to 500 kPa, from 50 kPa to 800 kPa, from 100 kPa to 800 kPa, from 200 kPa to 800 kPa, from 50 kPa to 600 kPa, from 100 kPa to 600 kPa, from 200 kPa to 600 kPa, from 50 kPa to 500 kPa, from 100 kPa to 500 kPa, or from 200 kPa to 500 kPa) at 60° C.

In some embodiments, the polymer matrix can comprise a thermoplastic polymer or a thermoset. In certain embodiments, the polymer matrix can be elastomeric.

In certain examples, the polymer matrix can comprise a crosslinked epoxy resin (e.g., an epoxy resin derived from the reaction of bisphenol A and epichlorohydrin).

Hard-Magnetic Particles

The compositions can further comprise a population of hard-magnetic particles dispersed within the polymer matrix.

The hard-magnetic particles can be present in varying amounts within the polymer matrix. In some examples, the hard-magnetic particles can be present in the polymer matrix at a concentration ranging from 0.1% v/v to 60% v/v hard-magnetic particles, such as from 0.1% v/v to 50% v/v hard-magnetic particles, from 1% v/v to 50% v/v hard-magnetic particles, from 5% v/v to 50% v/v hard-magnetic particles, from 5% v/v to 60% v/v hard-magnetic particles, from 1% v/v to 60% v/v hard-magnetic particles, from 10% v/v to 60% v/v hard-magnetic particles, from 10% v/v to 50% v/v hard-magnetic particles, from 5% v/v to 30% v/v hard-magnetic particles, from 10% v/v to 30% v/v hard-magnetic particles, from 5% v/v to 25% v/v hard-magnetic particles, or from 10% v/v to 25% v/v hard-magnetic particles.

The population of hard-magnetic particles can have any suitable average particle size. In some examples, the population of hard-magnetic particles can have an average particle size of from 1 nm to 1 mm (e.g., from 30 nm to 500 microns, from 1 nm to 100 microns, from 30 nm to 100 microns, from 0.1 microns to 100 microns, from 0.5 microns to 100 microns, from 1 micron to 100 microns, from 1 micron to 50 microns, from 1 micron to 500 microns, or from 50 microns to 500 microns). The “particle size” in the polymer matrix can be measured by a transmission electron microscope (TEM). The average particle size is defined as the average value of the particle sizes of 500 particles randomly extracted and measured in a photograph taken by a transmission electron microscope.

The hard-magnetic particles can be formed from any suitable hard-magnetic material (i.e., material which exhibits hard magnetism). Such materials can not exhibit changes in polarity under the designated working conditions.

In some embodiments, the term “hard magnetism” can refer to a coercive force of equal to or higher than 10 kA/m. That is, the hard-magnetic particles can have a coercive force of equal to or higher than 10 kA/m. A hard-magnetic particle with a coercive force of equal to or higher than 10 kA/m can exhibit a high crystal magnetic anisotropy, and can thus have good thermal stability.

The constant of crystal magnetic anisotropy of the hard-magnetic particle (also referred to as the “hard-magnetic phase” hereinafter) can be equal to or higher than 1×10⁻¹ J/cc (1×10⁶ erg/cc) (e.g., equal to or higher than 6×10⁻¹ J/cc (6×10⁶ erg/cc)).

The saturation magnetization of the hard-magnetic particles can be from 0.4×10⁻¹ to 2 A·m²/g (40 to 2,000 emu/g) (e.g., from 5×10⁻¹ to 1.8 A·m²/g (500 to 1,800 emu/g)). They can be of any shape, such as spherical or polyhedral.

Examples of the hard-magnetic phase are magnetic materials comprised of rare earth elements and transition metal elements; oxides of transition metals and alkaline earth metals; metal alloy; and magnetic materials comprised of rare earth elements, transition metal elements, and metalloids (also referred to as “rare earth-transition metal-metalloid magnetic materials” hereinafter). In certain embodiments, the hard-magnetic particles can comprise a rare earth-transition metal-metalloid magnetic materials and hexagonal ferrite. In certain embodiments, the hard-magnetic particles can comprise metal alloys (e.g., AlNiCo, FeCrCo). Depending on the type of hard-magnetic particle, there are times when oxides such as rare earth oxides can be present on the surface of the hard-magnetic particle. Such hard-magnetic particles are also included among the hard-magnetic particles.

More detailed descriptions of rare earth-transition metal-metalloid magnetic materials and hexagonal ferrite are given below.

Rare Earth-Transition Metal-Metalloid Magnetic Materials Examples of rare earth elements are Y, Ce, Pr, Nd, Sm, Gd, Tb, Dy, Ho, Er, Tm, and Lu. Of these, Y, Ce, Pr, Nd, Gd, Tb, Dy, and Ho, which exhibit single-axis magnetic anisotropy, are preferred; Y, Ce, Gd, Ho, Nd, and Dy, which having constants of crystal magnetic anisotropy of 6×10⁻¹ J/cc to 6 J/cc (6×10⁶ erg/cc to 6×10⁷ erg/cc), are of greater preference; and Y, Ce, Gd, and Nd are of even greater preference.

The transition metals Fe, Ni, and Co are desirably employed to form ferromagnetic materials. When employed singly, Fe, which has the greatest crystal magnetic anisotropy and saturation magnetization, is desirably employed.

Examples of metalloids are boron, carbon, phosphorus, silicon, and aluminum. Of these, boron and aluminum are desirably employed, with boron being optimal. That is, magnetic materials comprised of rare earth elements, transition metal elements, and boron (referred to as “rare earth-transition metal-boron magnetic materials”, hereinafter) are desirably employed as the above hard-magnetic phase. Rare earth-transition metal-metalloid magnetic materials including rare earth-transition metal-boron magnetic materials are advantageous from a cost perspective in that they do not contain expensive noble metals such as Pt.

The composition of the rare earth-transition metal-metalloid magnetic material can be 10 atomic percent to 15 atomic percent rare earth, 70 atomic percent to 85 atomic percent transition metal, and 5 atomic percent to 10 atomic percent metalloid.

When employing a combination of different transition metals as the transition metal, for example, the combination of Fe, Co, and Ni, denoted as Fe_{(1-x-y)}CoₓNi_{y}, can have a composition in the ranges of x=0 atomic percent to 45 atomic percent and y=25 atomic percent to 30 atomic percent; or the ranges of x=45 atomic percent to 50 atomic percent and y=0 atomic percent to 25 atomic percent, from the perspective of ease of controlling the coercive force of the hard-magnetic material to the range of 240 kA/m to 638 kA/m (3,000 Oe to 8,000 Oe).

From the perspective of low corrosion, the ranges of x=0 atomic percent to 45 atomic percent and y=25 atomic percent to 30 atomic percent, or the ranges of x=45 atomic percent to 50 atomic percent and y=10 atomic percent to 25 atomic percent, are desirable.

In other cases, the ranges of x=20 atomic percent to 45 atomic percent and y=25 atomic percent to 30 atomic percent, or the ranges of x=45 atomic percent to 50 atomic percent and y=0 atomic percent to 25 atomic percent, can be desirable.

Accordingly, from the perspectives of coercive force, corrosion, and temperature characteristics, the ranges of x=20 atomic percent to 45 atomic percent and y=25 atomic percent to 30 atomic percent or the ranges of x=45 atomic percent to 50 atomic percent and y=10 atomic percent to 25 atomic percent are desirable, and the ranges of x=30 atomic percent to 45 atomic percent and y=28 atomic percent to 30 atomic percent are preferred.

In certain embodiments, the hard-magnetic particles can comprise NdFeB particles.

Hexagonal Ferrite Magnetic Materials

Examples of hexagonal ferrites include barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed. There are cases where a substitution element which substitutes for Fe is added as a coercive force-adjusting component for reducing a coercive force of hexagonal ferrite. However, incorporation of the substitution element can reduce crystal magnetic anisotropy. To that end, in some cases, hexagonal ferrites containing no substitution elements can be selected for use as the hard-magnetic particle. Hexagonal ferrites containing no substitution elements can have a composition denoted by general formula: AFe₁₂O₁₉ [wherein A is at least one element selected from the group consisting of Ba, Sr, Pb, and Ca].

Auxiliary Magnetic Particles

In some embodiments, the magnetic shape-memory compositions can further comprise a population of auxiliary magnetic particles (e.g., soft magnetic particles) dispersed within the polymer matrix. The auxiliary magnetic particles can be used to inductively heat the polymer matrix (e.g., to above the Tg of the polymer or blend of polymers forming the polymer matrix) under application of a high frequency magnetic field.

The auxiliary magnetic particles can be present in varying amounts within the polymer matrix. In some examples, the auxiliary magnetic particles can be present in the polymer matrix at a concentration ranging from 0.1% v/v to 60% v/v auxiliary magnetic particles, such as from 0.1% v/v to 50% v/v auxiliary magnetic particles, from 1% v/v to 50% v/v auxiliary magnetic particles, from 5% v/v to 50% v/v auxiliary magnetic particles, from 5% v/v to 60% v/v auxiliary magnetic particles, from 1% v/v to 60% v/v auxiliary magnetic particles, from 10% v/v to 60% v/v auxiliary magnetic particles, from 10% v/v to 50% v/v auxiliary magnetic particles, from 5% v/v to 30% v/v auxiliary magnetic particles, from 10% v/v to 30% v/v auxiliary magnetic particles, from 5% v/v to 25% v/v auxiliary magnetic particles, or from 10% v/v to 25% v/v auxiliary magnetic particles.

The population of auxiliary magnetic particles can have any suitable average particle size. In some examples, the population of auxiliary magnetic particles can have an average particle size of from 1 nm to 1 mm (e.g., from 30 nm to 500 microns, from 1 nm to 100 microns, from 30 nm to 100 microns, from 0.1 microns to 100 microns, from 0.5 microns to 100 microns, from 1 micron to 100 microns, from 1 micron to 50 microns, from 1 micron to 500 microns, or from 50 microns to 500 microns). The “particle size” in the polymer matrix can be measured by a transmission electron microscope (TEM). The average particle size is defined as the average value of the particle sizes of 500 particles randomly extracted and measured in a photograph taken by a transmission electron microscope.

In certain embodiments, the auxiliary magnetic particles can comprise a second population of hard-magnetic particles, such as any of the hard-magnetic particles described above. In some embodiments, the hard-magnetic particles have a higher coercive force than the soft magnetic particles. In some embodiments, the auxiliary magnetic particles exhibit a coercive force of less than 40 kA/m, such as a coercive force ranging from 1 kA/m to less than 40 kA/m, from 5 kA/m to 10 kA/m, from 5 kA/m to less than 40 kA/m, from 5 kA/m to 20 kA/m, from 5 kA/m to 30 kA/m, from 5 kA/m to 40 kA/m.

In some embodiments, the auxiliary magnetic particles can comprise ferromagnetic hexagonal ferrite particles, wherein the particles have a specific Curie temperature (Tc) in the matrix material. In some embodiments, the ferromagnetic hexagonal ferrite particles can comprise SrFe₁₂O₁₉ (hereinafter referred to as “SrF”), Meₐ-2W, Meₐ-2Y, and Meₐ-2Z, wherein 2 W is BaO:2MeₐO:8Fe₂O₃, 2Y is 2(BaO:MeₐO:3Fe₂O₃), and 2Z is 3BaO:2MeₐO:12Fe₂O₃, and wherein Meₐ is a divalent cation. The divalent cation can be selected from Mg, Co, Mn and Zn. In some cases, the ferromagnetic hexagonal ferrite particles can have the composition SrF, Co₂Ba₂Fe₁₂O₂₂(hereinafter referred to as Co-2Y), Mg₂Ba₂Fe₁₂O₂₂ (hereinafter referred to as “Mg-2Y”), Zn₁Mg₁Ba₂Fe₁₂O₂₂ (hereinafter referred to as “Zn/Mg-2Y”) and Zn₁Co₁Ba₂Fe₁₂O₂₂ (hereinafter referred to as “Zn/Co-2Y”) or combinations thereof.

In some embodiments, the auxiliary magnetic particles can comprise a material with a low curie temperature (e.g., from 40-100 degrees Celsius). Such materials can include Ni—Si, Fe—Pt, and Ni—Pd alloys. A number of magnetic powders can be used including Ni—Zn—Fe—O, Ba—Co—Fe—O, and Fe—O. Another material is a substituted magnetite or ferric oxide crystalline lattice with a portion of the iron atoms substituted by one of the following, cobalt, nickel, manganese, zinc, magnesium, copper, chromium, cadmium, or gallium. A Palladium Cobalt alloy that also has a controllable curie temperature in the range of 40-100 degrees Celsius can also be used. Nickel Zinc Ferrite (a soft ferrite) can also be used. A very useful property of this material is that its curie temperature can be greatly influenced by the amount of Zinc present in the material. Curie temperatures ranging from 30-600 degrees Celsius are achievable [Strontium Ferrite (a hard ferrite) and Nickel (an elemental ferromagnetic material)] can be used.

In some embodiments, the auxiliary magnetic particles can comprise soft magnetic particles (e.g., the particles can be formed from a soft magnetic material). In some cases, the constant of crystal magnetic anisotropy of the soft magnetic material can be from 0 to 5×10⁻²Fcc (0 to 5×10⁵ erg/cc) (e.g., from 0 to 1×10⁻²Fcc (0 to 1×10⁵ erg/cc)). In some embodiments, the saturation magnetization of the soft magnetic material can range from 1×10⁻¹ to 2 A·m²/g (100 emu/g to 2,000 emu/g) (e.g., from 3×10⁻¹ to 1.8 A·m²/g (300 to 1,800 emu/g)).

In some examples, Fe, an Fe alloy, or an Fe compound, such as iron, permalloy, sendust, or soft ferrite, can be employed as the soft magnetic material. The soft magnetic material can be selected from the group consisting of transition metals and compounds of transition metals and oxygen. Examples of transition metals are Fe, Co, and Ni. Fe and Co are desirable.

In some examples, the constant of crystal magnetic anisotropy of the soft magnetic material can be from 0.01 to 0.3-fold that of the hard-magnetic particles.

In some embodiments, the auxiliary magnetic particles can comprise magnetically soft ferrite particles. In certain examples, the particles can have the composition 1Me_{b}O:1Fe₂O₃, where Me_{b}O is a transition metal oxide. Examples of Me_{b} include Ni, Co, Mn, and Zn. Example particles include, but are not limited to: (Mn, ZnO) Fe₂O₃ and (Ni, ZnO)Fe₂O₃.

Methods of Actuating the Article

In some embodiments, a method of actuating an article includes the steps of: providing the article, wherein the device is capable of being programmed to possess a specific primary shape, reformed into a secondary stable shape, and controllably actuated to recover the specific primary shape; and applying a magnetic field to controllably actuate the article such that it recovers its specific primary shape.

The magnetic field applied to controllably actuate the article can be either a DC field or an AC field. In some embodiments, the DC field has a frequency below 10 kHz, such as below 9 kHz, below 8 kHz, below 7 kHz, below 6 kHz, below 5 kHz, below 4 kHz, below 3 kHz, below 2 kHz, below 1 kHz, below 500 Hz, below 250 Hz, below 100 Hz. In some embodiments, the AC field has a frequency below 1 kHz, such as below 900 Hz, below 800 Hz, below 700 Hz, below 600 Hz, below 500 Hz, below 400 Hz, below 300 Hz, below 200 Hz, or below 100 Hz.

The magnetic field applied to controllably actuate the article can have a magnetic field strength of from 0.1 mT to 500 mT. For example, the magnetic field strength can range from 0.1 mT to 400 mT, from 0.1 mT to 300 mT, from 0.1 mT to 200 mT, from 0.1 mT to 100 mT, from 0.1 mT to 50 mT, from 0.1 mT to 10 mT, from 0.1 mT to 1 mT, from 0.1 mT to 5 mT, from 1 mT to 400 mT, from 1 mT to 300 mT, from 1 mT to 200 mT, from 1 mT to 100 mT, from 1 mT to 50 mT, from 1 mT to 10 mT, from 5 mT to 400 mT, from 5 mT to 300 mT, from 5 mT to 200 mT, from 5 mT to 100 mT, from 10 mT to 500 mT, from 10 mT to 200 mT, from 10 mT to 100 mT, from 10 mT to 50 mT, from 50 mT to 500 mT, from 50 mT to 250 mT, or from 50 mT to 100 mT

In some embodiments, applying the magnetic field can comprise inductively heating the shape memory polymer matrix to a temperature at or above the Tg of the polymer or blend of polymers forming the polymer matrix. Inductive heating can be performed using an alternating current (AC) magnetic field and/or a direct current (DC) magnetic field.

In some embodiments, the magnetic field applied to inductively heat the polymer matrix can have a frequency of from 40 Hz to 50 MHz. For example, the magnetic field applied to inductively heat the polymer matrix can have a frequency of from 40 Hz to 10 MHz, from 40 Hz to 1 MHz, from 40 Hz to 500 kHz, from 40 Hz to 250 kHz, from 40 Hz to 100 kHz, from 40 Hz to 50 kHz, from 40 Hz to 10 kHz, from 40 Hz to 1 kHz, from 40 Hz to 500 Hz, from 40 Hz to 250 Hz, from 40 Hz to 100 Hz, from 40 Hz to 60 Hz, from 10 kHz to 200 kHz, from 10 kHz to 100 kHz, from 10 kHz to 50 kHz, from 30 kHz to 300 kHz, from 30 kHz to 200 kHz, from 30 kHz to 100 kHz, from 60 kHz to 200 kHz, or from 60 kHz to 100 kHz.

In some embodiments, the magnetic field applied to inductively heat the polymer matrix can have a magnetic field strength of from 0.1 mT to 100 mT. For example, the magnetic field applied to inductively heat the polymer matrix can have a magnetic field strength of from 0.1 mT to 80 mT, from 0.1 mT to 60 mT, from 0.1 mT to 40 mT, from 0.1 mT to 20 mT, from 0.1 mT to 10 mT, from 0.1 mT to 1 mT, from 0.1 mT to 5 mT, from 1 mT to 80 mT, from 1 mT to 60 mT, from 1 mT to 40 mT, from 1 mT to 20 mT, from 1 mT to 10 mT, from 10 mT to 100 mT, from 10 mT to 70 mT, from 10 mT to 50 mT, from 10 mT to 30 mT, from 20 mT to 50 mT, or from 20 mT to 100 mT.

In some embodiments, a method of actuating a device to perform an activity on a subject, including the steps of: positioning a device formed (in whole or in part) from the composition described herein, in a desired position with regard to said subject, wherein the device is capable of being programmed to possess a specific primary shape, reformed into a secondary stable shape, and controllably actuated to recover the specific primary shape; and actuating the device using an applied magnetic field to controllably actuate the device such that it recovers its specific primary shape. In some embodiments, actuating the device includes applying magnetic field to inductively heat the polymer matrix to a temperature at or above the Tg of the polymer or blend of polymers forming the polymer matrix.

By way of non-limiting illustration, examples of certain embodiments of the present disclosure are given below.

### EXAMPLES

### Example 1: Magnetic Shape Memory Polymer (mSMP) for Reprogrammable Ultrafast Shape-Changing/-Locking

This example describes the fundamental physics and mechanics and to provide a design framework for a class of soft active material, namely magnetic shape memory polymers (mSMP), a magnetic-thermal coupled multiphysics material that integrates 1) reversible fast and controllable transforming; 2) shape locking; and 3) deformation reprogramming capabilities in one material system, to effectively overcome the existing limitations of soft active materials. By embedding reprogrammable magnetic particles in thermal-responsive SMP matrices, one can activate the material to deform into a predefined pattern, which can be locked when mSMP is cooled. The deformation pattern of the mSMP can be reprogrammed via a large remagnetization field (about 2 T to about 5 T). By the synergetic effort on experimental investigation, theoretical modeling and finite element analysis, the success of this work will not only permit a revolutionary multifunctional material, but also advance the science of soft functional materials for future antennas, grippers, hingers, changing surface fraction and relectivity, drug delivery and other medical applications.

Background

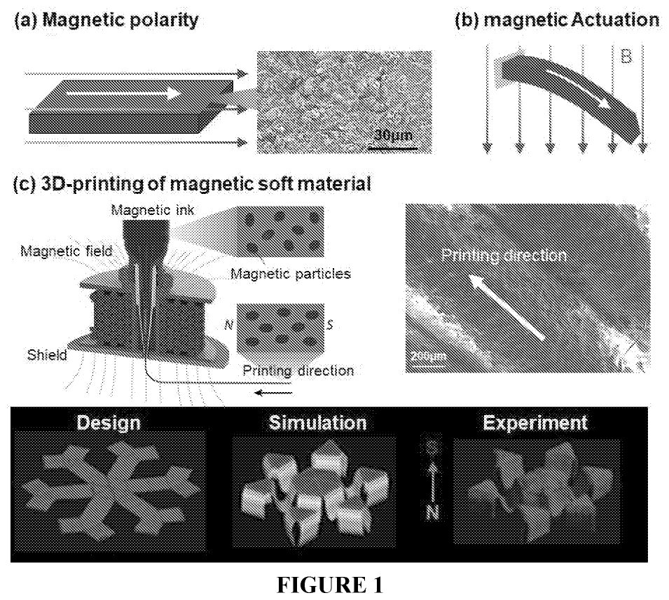

Soft active materials (SAM) are flexible, functional materials or composites that are sensitive and responsive to stimuli, such as heat, light, electric and/or magnetic fields, etc. SAMs have attracted a great deal of interest owing to their potential applications in reconfigurable structures, flexible electronics, soft robots, and biomedical devices. Among SAMs, magnetic-responsive soft materials that incorporate hard-magnetic particles into soft matrices are particularly attractive due to their capability of undergoing rapid, large and reversible deformation when a magnetic field is applied. In addition, the magnetic stimulation offers a safe and effective manipulation method for biomedical applications, which typically require remote actuation in enclosed and confined spaces. FIG. 1 shows the design and fabrication of magnetic-responsive soft materials. There, a magnetic-responsive soft material is composed of an elastomer matrix with embedded micrometer-sized magnetic particles (NdFeB). After fabrication, the particles are magnetized by applying a strong impulse magnetic field (˜1.5 T), after which these particles retain strong remnant magnetic polarities. When a small magnetic field (less than 100 mT) is applied, these domains can induce magnetic stresses or torques for rapid and dramatic mechanical deformation. FIG. 1, panel a and panel b schematically illustrated this process. In FIG. 1, panel a, the magnetic particles are magnetized in the horizontal direction. After the magnetization, a vertically applied magnetic field causes the soft active material to bend downward to align its dipole moment direction with the applied magnetic field direction (FIG. 1, panel b). In addition, this approach can be integrated with 3D printing where the particles are magnetized during the 3D printing process (FIG. 1, panel c). Taking advantage of flexibility in structure fabrication offered by 3D printing, very exciting actuation mode and shape change can be obtained (FIG. 1, panel c).

Although efforts have been made to program complex magnetic domains and control external fields, to date, however, existing magnetic-actuated materials have some significant limitations. First, they can only keep their actuated state with a prescribed formation pattern under a continuous application of an external magnetic field. Once the external magnetic field is removed, the material goes back to its undeformed shape, making it impossible to sustain the deformed shape without a continuous consumption of external energy. In addition, the actuation pattern is limited by the initial design of the magnetic domain. These constraints substantially limit the material system's versatility. Therefore, a reprogrammable magnetic soft material with flexibilities on shape-locking and reversible fast-transforming is highly desirable as it offers a transformative way to address these limitations, permits its multifunctionality with tunable physical properties such as geometry, stiffness, acoustic properties and many others.

Shape memory polymer (SMP) and its composites are a kind of smart materials, which are capable of memorizing temporary shapes and recovering to their original shapes upon external stimulus, such as temperature, light, electrical field, etc. Because these materials are capable of having large programmable shape change, they have been investigated for applications ranging from aerospace to biomedical devices. The shape memory effect (SME) typically involves two steps: programming and recovery. In a thermally triggered SMP, in the programming step, the SMP is first heated to a temperature above the transition temperature (such as the glass transition temperature Tg) then is deformed. After the material is cooled down below Tg, it stays in the deformed shape. To recover, the SMP is heated to a temperature above the Tg, and it returns to its original shape. In thermosetting polymers, since programming is conducted above Tg, the material is in the rubbery state, allowing easy and large deformation. These offer some big advantages. First, more than 100% length change can be achieved, which is much larger than other active materials, such as shape memory alloys, whose actuation strain is below 8%. In addition, because the fixed temporary shape is the deformed one at the high temperature, an SMP essentially can be programmed into any desired shape. However, SMPs also have some limitations, such as low actuation force, relatively slow responsive rate, etc.

Concept and Scientific Questions

In these examples, magnetic shape memory polymers (mSMPs) which harness the advantages of SMPs and address the current limitation in magnetic soft active materials are described. These mSMP integrate 1) reversible, fast, and controllable transforming deformation, 2) shape-locking, and 3) reprogramming capabilities to effectively overcome the existing limitations of soft active materials.

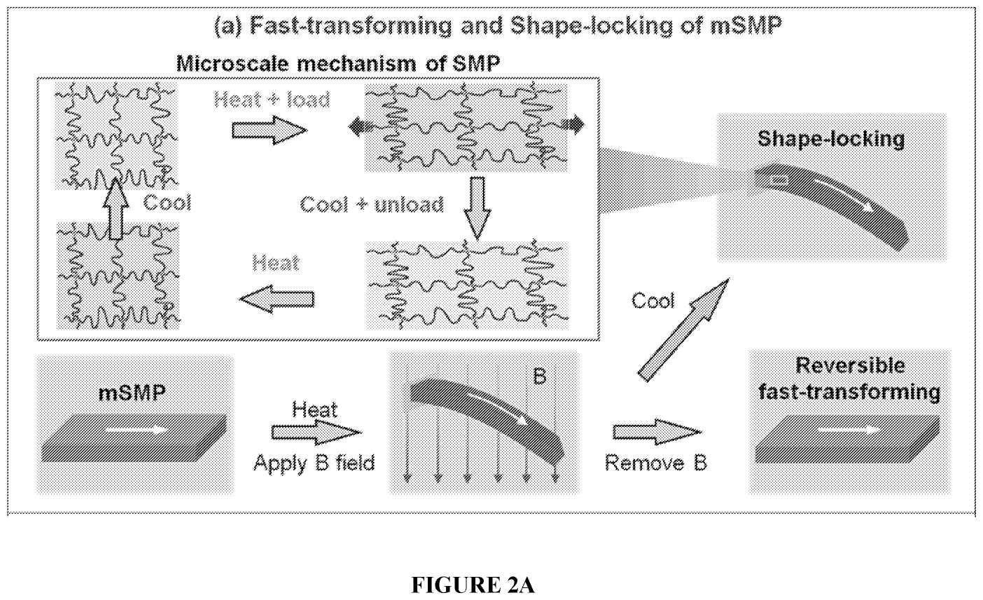

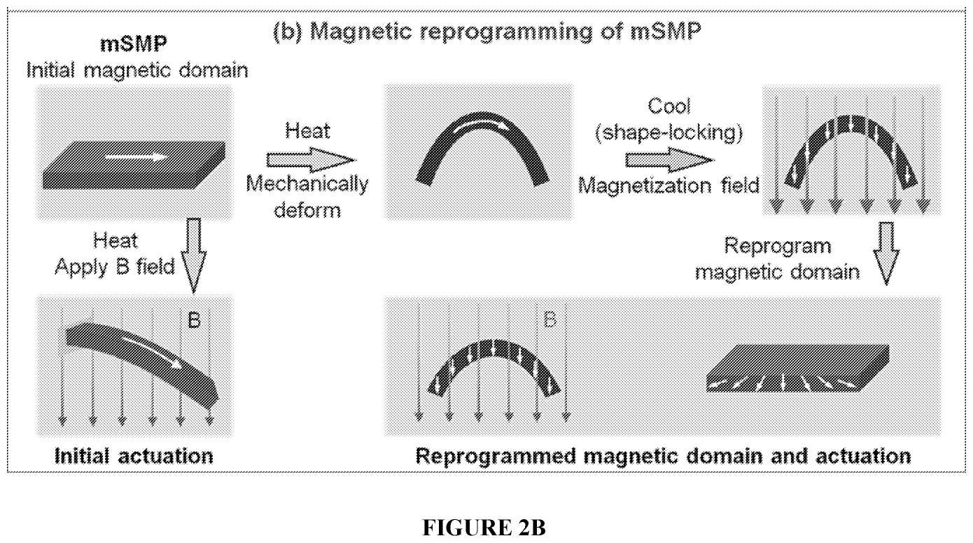

FIGS. 2A-2B schematically illustrates the mSMPs described herein. The mSMP comprise a shape memory polymer matrix with embedded hard-magnetic particles that can have large magnetic remanence (such as NdFeB). In these examples, we selected a shape memory polymer with glass transition temperature Tg above room temperature (e.g., approximately 50° C.).

The material is cured with a prescribed shape. It can then be magnetized by applying a large impulse magnetic field of about 1.5 T (e.g., about 1 T, about 1.5 T, about 2 T, about 2.5 T, about 3 T, about 3.5 T, about 4 T, about 4.5 T, or about 5 T) to achieve a desired magnetic domain distribution. At room temperature, which is below Tg, the material is too stiff to be activated by applying a regular actuation magnetic field (below 100 mT). However, as shown in FIG. 2A, heating the sample to a temperature above its Tg will significantly decrease the stiffness; at this time, applying a small magnetic field will rapidly activate the material to the programmed shape. At this moment, turning off the applied magnetic field will return the material to its original shape. However, if we hold the magnetic actuation and cool down the material, then its deformed shape can be locked at low temperature without further application of magnetic field, which is the shape locking behavior. Therefore, by controlling the temperature and the application of magnetic field, we can achieve shape-locking and reversible fast-transforming behaviors in a single material system.

Further, one can readily reprogram the mSMP material. As shown in FIG. 2B, the initial magnetic domain of the mSMP is in the horizontal direction, leading to a bending motion when a vertical magnetic field is applied. To reprogram the material's deformation to reach an arc shape, we first heat the sample at a temperature above its T_{g}, deform it into an arc, then lower down the temperature to lock the shape. We then apply a strong impulse magnetic field to re-magnetize the particles to form new magnetic domains. Heating the material and applying the actuation magnetic field will deform the material into the new shape. With this remagnetization strategy, we can essentially reprogram the material into any shape on demand. This offers a significant advantage over the single actuation pattern of traditional soft active materials.

It should also be noted that the proposed mSMP is fundamentally different from previous research on magnetically activated shape memory polymer where a high-frequency magnetic field (˜500 kHz) is used to heat the particles and then the SMP. Here, a strong impulse magnetic field is used to program the mSMP and a weak magnetic field is used to deform the material.

The above concept provides a solution to the limitations of current applications of soft active materials.

Technical Approaches

Material preparation. Although our ultimate goal is to develop mSMPs with superior performance, a relatively simple polymer system was explored initially to focus our efforts on understanding the underlying fundamental physics. When preparing magnetic SMPs, we selected an elastomer whose Young's modulus in the range of 100 kPa-500 kPa. For SME, we selected materials having a glass transition temperature around 50° C. so that mechanical deformation at high temperature can be applied easily in the lab environment, such as using hot water bath. Therefore, we will synthesize an SMP with a glass transition temperature (T_{g}=45˜70° C.) and low rubbery modulus (Young's modulus: 200˜600 kPa). However, materials with a range of materials properties can be used depending on the desired application of the material.

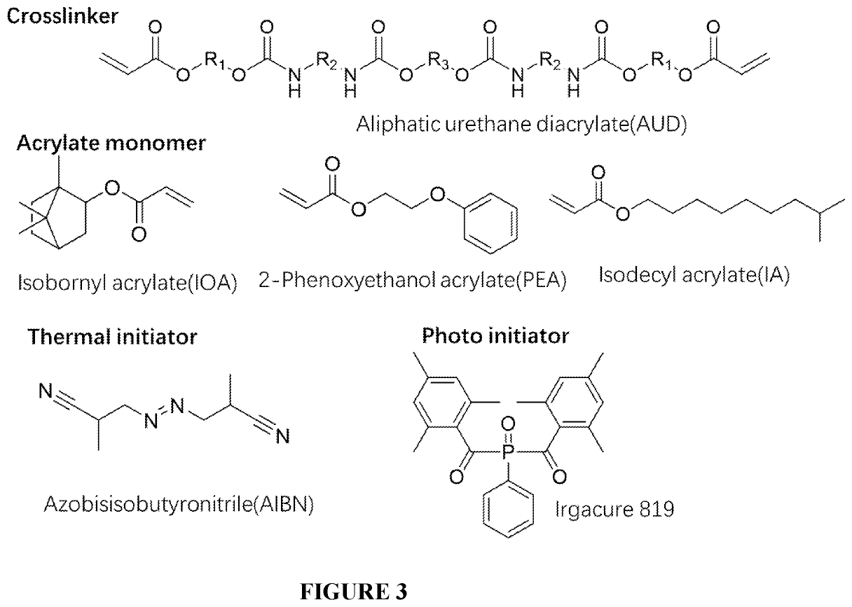

Initially, an SMP epoxy resin was used, which was prepared by mixing an epoxy oligomer (Epon 828), thiol chain extender (2,2-(ethylenedioxy) diethanethiol) and Jeffamine D230 cross-linker. FIG. 3 shows the chemical structures of the epoxy oligomer, chain extender, and crosslinker. The curing condition for this epoxy is at 100° C. for 1 h and at 130° C. for 2 h. NdFeB microparticles were selected as the hard-magnetic particles. NdFeB microparticles can be magnetized by applying a strong magnetic field (>1.5 T).

An acrylic SMP was also used. As an example, aliphatic urethane diacrylate (Ebecryl 8807) as crosslinker, isobornyl acrylate (IOA) 2-phenoxyethanol acrylate and isodecyl acylate with a weight ratio of 0.7:60.2:30.1:9 was mixed and then 1.5 wt % of Irgacure 819 or 0.3 wt % of 2,2′-azoisobutyronitrile as thermal initiator was added to form a homogeneous resin. Thermal curing of the resin was conducted at 80° C. for 3 hours. The resin can be also photo cured by UV irradiation.

Understanding the thermoviscoelastic properties and shape memory performance of the mSMP. The thermoviscoelastic properties of an SMP play a role in determining the shape memory performance, such as shape fixity, shape recovery ratio, and shape recovery speed. Therefore, it is important to understand the thermoviscoelastic properties and shape memory performance of mSMP and how these properties are affected by the inclusion of particles.

Thermoviscoelastic property characterization. The thermoviscoelastic behaviors of the neat SMP, and the mSMPs with NdFeB microparticles at four different volume fractions (5%, 10%, 15%, and 20%, respectively) will be characterized. For mSMPs, we will characterize the non-magnetized the sample first; we will then magnetize the sample, then characterize the sample again. We will conduct the following three different thermomechanical tests: Differential Scanning calorimetry (DSC) tests. This test will provide the information about the transition temperatures, including glass transition temperature of the sample.

Dynamic Mechanical Analysis (DMA) tests. The peak of the tan-delta curve from the DMA test is typically used as the glass transition temperature, which is usually 10-20° C. higher than the T_{g} determined from DSC. Here, we are particularly interested in if and how the addition of microparticles can change the T_{g} and other thermoviscoelastic behaviors. In addition, we will evaluate if magnetization will change these behaviors.

Stress relaxation tests at different temperature. We will use a DMA tester to conduct the tests under uniaxial tensile mode under different temperatures (10° C., 20° C., 30° C., 40° C., 50° C., 60° C., 70° C., and 80° C.; more temperatures will be added around the T_{g}). The sample will be stretched at a high strain rate to 1%, then held for 10-50 min to observe the stress relaxation. The obtained stress relaxation results will be used to construct the master curve by using the time-temperature superposition principle. We will investigate if the addition of magnetic microparticles and magnetization will shift the master curve.

The multibranch model can be used to represent the thermoviscoelastic behaviors as well as shape memory behaviors of an SMP. After the characterization of the neat SMP and mSMP, the multibranch model will be used to fit the DMA tan-delta curve as well as the stress relaxation curves to obtain the thermoviscoelastic material parameters, which can be used to predict the shape memory behaviors of these materials.

Characterization of shape memory behaviors. The shape memory behaviors of the neat SMP and mSMPs (before and after magnetization) will be characterized. For each test, the above described programming steps and recovery steps will be followed. The shape fixity and the shape recovery ratio as a function of recovery time will be measured. These measurements will be used to compare with model predictions discussed above.

Studying the resultant magnetic polarization due to remagnetization. To reprogram, we first lock the shape (as shown in FIG. 2A), which can be used for room-temperature remagnetization. Once the shape is locked to a desired actuation deformation, the magnetic domain can be reprogramed by applying a large impulse magnetic field along the direction that will be later used to apply the actuation field. Ideally, we want the material's reprogramed magnetic domain to follow the remagnetization direction with the same magnetic moment density, so that the deformation shape and amplitude can be accurately controlled. However, in reality, the resultant magnetic domain direction may not perfectly align with the desired remagnetization.

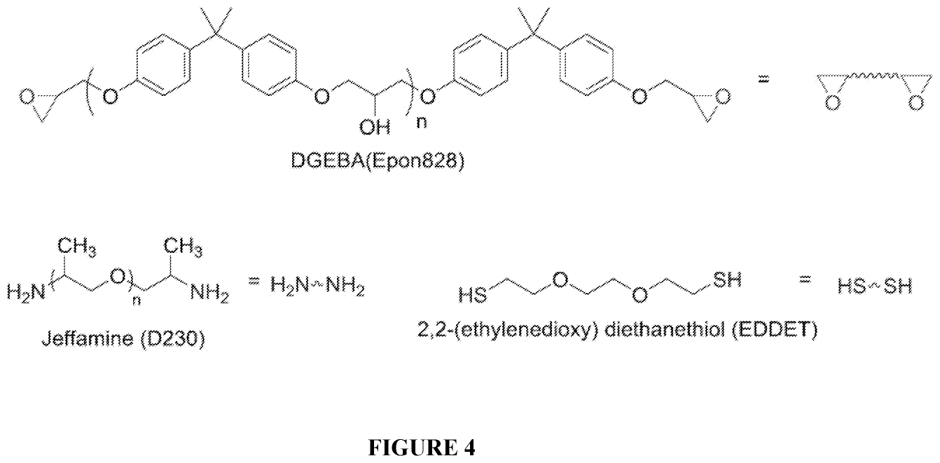

FIG. 4 shows the preliminary data of magnetic monodomain reprogramming. Here, we embedded NdFeB particles with a volume fraction of 20% to PDMS and cured the composite. The disk samples were first magnetized along the X-direction (horizontal) at 1.5 T magnetic field. To test the magnetic reprogramming, two samples were then magnetized in the Y-direction, 90° to the first magnetization direction at 1.5 T and 2.8 T, respectively. To illustrate the resultant reprogrammed magnetic polarity, a small alignment field of 30 mT was applied along the X-direction, causing the samples to align their magnetization direction with the applied field. Ideally, the remagnetized samples would turn 90° clockwise. However, the results showed that under a 1.5 T remagnetization field, the magnetic domain only turned 60°, and the strong field (2.8 T) sample turned to 77°. One main reason for this discrepancy is that the magnetic field used to magnetize the material did not reach the magnitude needed to completely saturate the NdFeB particles, which is 5.5 T. However, such a large magnetic field can be difficult to achieve in many regular research settings as it requires over 1 kA instant current (to give a sense, MRI usually operates at 1.5 T). Therefore, an effective strategy for accurate magnetic reprogramming using impulse magnetic field around 1.5 T is desirable. We propose to use multiple magnetization steps to achieve the desired magnetic reprogramming directions. The following two subtasks will be studied to quantitatively understand the fundamental of magnetic domain reprogramming and to guide the reprogramming process.

Developing a testing platform to evaluate reprogrammed magnetic and mechanical property. To ensure effective actuation of the reprogramed mSMP, which is determined by the material's mechanical and magnetic property, experiments will be conducted to measure the stiffness and magnetic moment density of the reprogramed mSMP using universal testing machine (Instron 3340, load cell 100N) and vibrating sample magnetometer (VSM), respectively. Since the remagnetization domain direction and strength are functions of the material's initial magnetic moment density, reprogramming direction and its field strength, a parametric investigation on the resultant magnetic properties will be conducted to provide guidelines on the combination of remagnetization fields and directions for desired magnetic reprogramming.

Unveiling the fundamental mechanics of reprogrammable mSMP material. A theoretical framework for magnetic domain reprogramming will also be developed and integrated with the mSMP model to describe the material's reprogrammed actuation under external magnetic field. The developed theoretical model will be implemented through finite element analysis to guide the functional material design.

Developing a simulation-based design frame for mSMP. In the magnetic-thermal coupled reprogramming and actuation of mSMP, various physical behaviors can be accomplished by different functional material ingredients. Fast transforming deformation can induced by a DC magnetic field when the temperature of the SMP matrix exceeds its thermal transition temperature Tg, leading to a low-stiffness state (Young's modulus: 100˜500 kPa) that can be easily actuated by magnetic field. Shape-locking can be achieved under magnetic actuation when the matrix temperature is cooled to below T_{g}, leading to a high-stiffness state (Young's modulus ˜1 GPa) that can hardly be actuated by either magnetic field or mechanical loading. Reprogramming can be achieved by programming the mSMP into a temporary shape then applying a large magnetic field, which could cause the mechanical deformation of the mSMP, thus affect the accuracy of reprogramming.

To quantitatively understand the material's physical behavior, a multiphysics theoretical model that couples magnetic actuation of the particles and the temperature-dependent thermomechanical behaviors of the matrix material will be used. Work related to the mechanics of hard-magnetic soft matrix materials has introduced a theoretical framework to accurately describe the material's behavior under applied magnetic fields. A constitutive law has been established by coupling the material's magnetic potential with its strain energy. The theoretical framework was numerically implemented through finite element method (FEM) to predict the material's large deformation under magnetic actuation.

Establishing a magnetic-thermal coupling multiphysics theoretical framework to describe the material behavior of mSMP. The constitutive model will be interpreted through material's free energy density, which is composed of two parts: a) strain energy density of a temperature-dependent viscoelastic polymeric model for the SMP matrix, whose thermoviscoelastic behaviors can be modeled by using the multibranch model; and b) magnetic potential that provides the driving force for deformation.

Implement the theoretical model into finite element analysis to predict the material behavior under various environments. The developed constitutive model will be coded by a user defined element in the commercial FEM software ABAQUS (Dassault Systemes Inc, France). The material properties and external stimulations will be used as input to the numerical model. Mechanical properties of the material will be tested by a universal testing machine. The material's magnetic moment density will be tested using vibrating sample magnetometer.

### Example 2

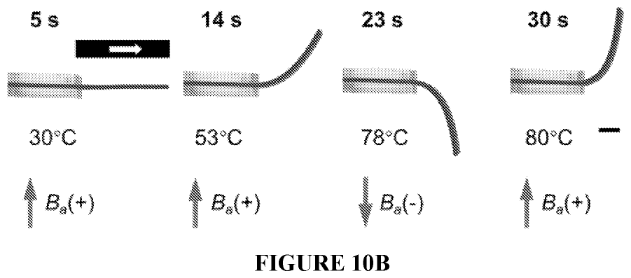

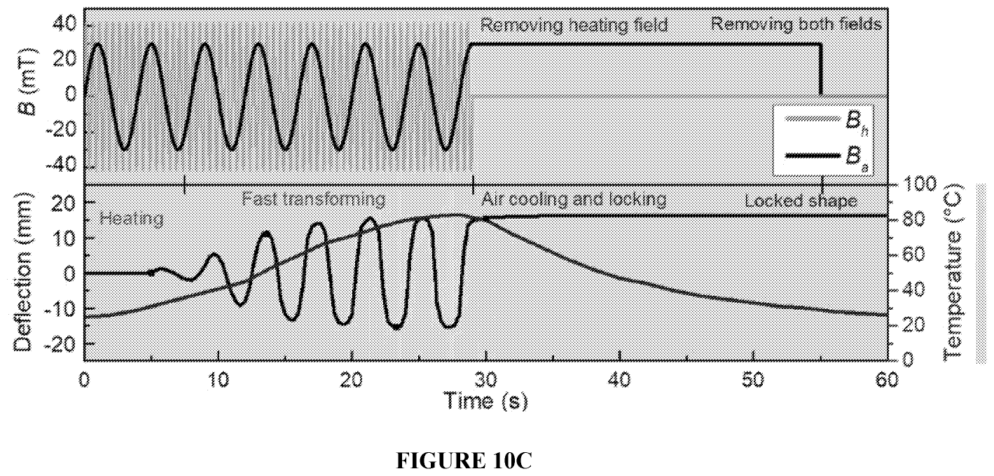

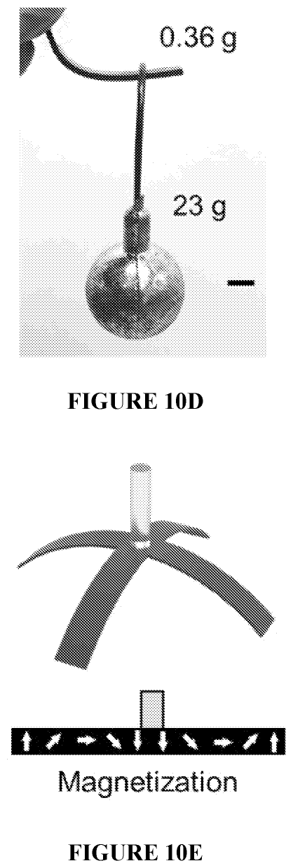

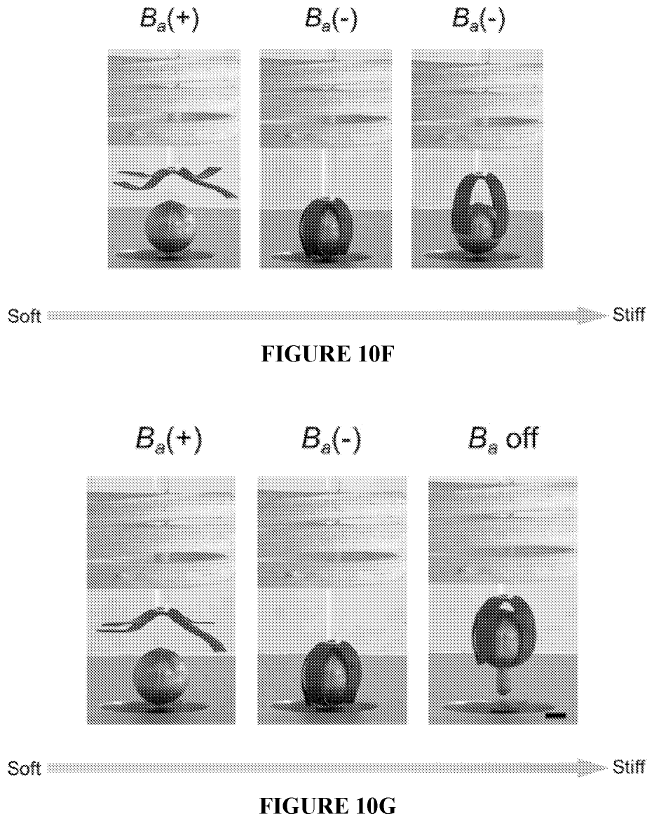

In this example, a magnetic-thermal coupled multiphysics material, namely magnetic shape memory polymer (mSMP) that integrates (1) reversible fast and controllable shape-changing; (2) shape-locking; and (3) actuation reprogramming capabilities into one material system is described. The mSMP can comprise micro-sized active magnetic particles (NdFeB and ferrite) and a thermally triggered shape memory polymer (SMP) matrix, an active material that is capable of memorizing temporary shapes. In addition, an SMP can be softened when it is heated to a temperature above the glass transition temperature T_{g}. As shown in FIGS. 10A-10B, when the SMP is heated and an external magnetic field is applied, the magnetic particles generate torques to align their magnetization with the external field direction. After the material is cooled down below T_{g}, it locks its deformed shape (FIG. 2A). More excitingly, utilizing the shape-locking effect, one can reprogram the magnetic domains (FIG. 2B), which permits new and nearly arbitrary actuation deformations under the same applied magnetic fields.

The fundamental multiphysics-coupled mechanics to provide a design framework for mSMP, and to explore its mechanics-guided material and structural design for inconceivable properties and functions for the explorations in new generation of multifunctional composites for potential applications such as soft robots and acoustic materials was evaluated. By the synergetic effort on experimental investigation, theoretical modeling and finite element analysis, the success of this work will permit a revolutionary multifunctional composite with a plethora of promising applications.

Results

Implement mSMP for reversible fast shape-changing and shape-locking. We have developed a 3D printable magnetic soft material to achieve complex formation (FIG. 1). We have also developed a material constitutive law and implemented it through finite-element analysis (FEA) to accurately predict the magnetic-actuated deformation.

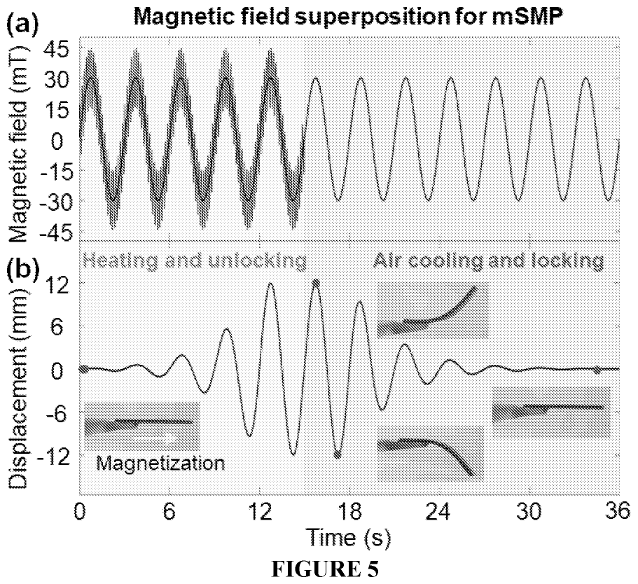

As a proof of concept, we have fabricated an mSMP with magnetic control for both material locking/unlocking and fast shape-changing actuation. The material system comprises an SMP matrix with two types of particles: micro-sized ferrite particles for inducting heating to soften and unlock the SMP matrix and micro-sized NdFeB particles for programmable shape-changing actuation. As shown in FIG. 5, a beam, which is magnetized horizontally, will bend toward the vertically applied magnetic field at high temperature. To effectively switch the mSMP between shape-change and shape-locking modes, a superposed high frequency magnetic field is designed to regulate the temperature and thus the modulus of the mSMP.

FIG. 5, panel A shows the imposed magnetic field. The displacement plot (FIG. 5, panel B) indicates that when the system is heated up, the actuation amplitude gradually increases (within 12 s). When the temperature exceeds the mSMP's glassy temperature T_{g} (˜55° C. in this case), the material system exhibits fast shape-changing behavior. Once the high-frequency magnetic field is removed, the material gradually cools down and stiffens and the deformed shape can be locked at desired state depending on the actuation magnetic field.

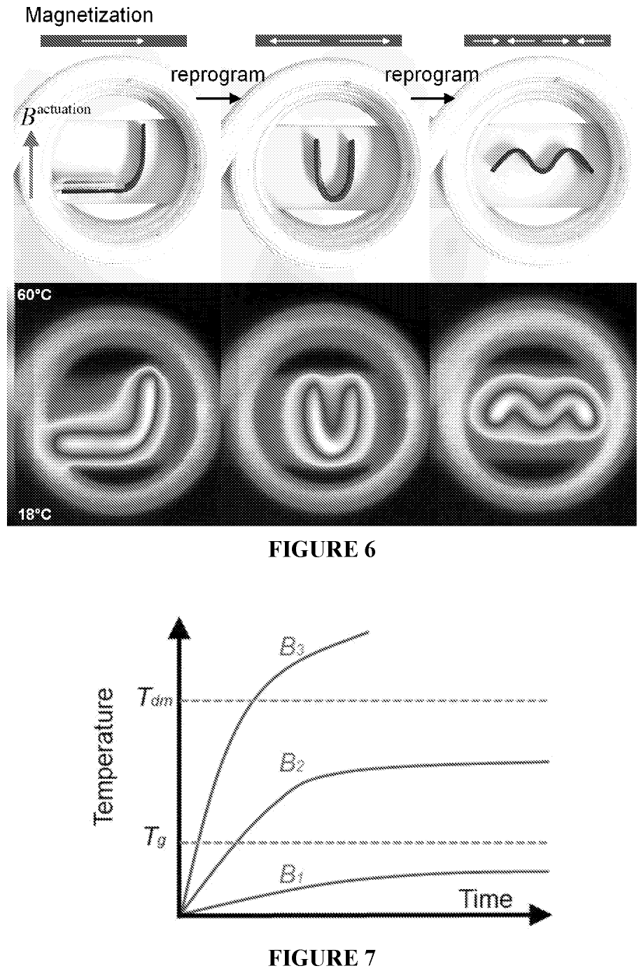

Reprogrammable mSMP. FIG. 6 shows some preliminary results related to mSMP deformation reprogramming. Here, the same mSMP sample was remagnetized to trigger different actuation (cantilever bending; arc; wave). With this remagnetization strategy, we can essentially reprogram the material into any shape on demand. This will break the previous barrier of single actuation pattern of soft active materials. However, our preliminary results also revealed that the reprogrammed magnetic domains may not follow exactly the applied remagnetization field as they show a small angle with the applied field and the angle is related to the strength of the remagnetization field. Fundamental studies will allow us to accurately predict the reprogrammed shape.

Research Directions

Theoretical foundations for mSMPs. The thermoviscoelastic properties of an SMP can play a role in determining the shape memory performance. Therefore, it is important to understand the thermoviscoelastic properties and shape memory performance of mSMP and how these properties are affected by the inclusion of particles. Accordingly, we will (1) study the particle interaction (at different particle volume fractions) induced changes in thermoviscoelastic behavior; (2) establish a constitutive law to describe the magneto-thermal coupled actuation and large deformation by integrating a) a strain energy density function of the time-temperature-dependent viscoelastic behaviors and b) a magnetic potential that provides the driving force for deformation; and (3) implement the theoretical model into finite element analysis to predict the material behavior under various environments.

Investigate effective magnetic superposition for induction heating and actuation. Upon actuation, magnetic induction heating can be achieved by applying high frequency magnetic field B^{heat} to mSMP. To ensure the accurate and repeatable actuation, a stable temperature environment can provide for constant mechanical properties of the mSMP as its stiffness changes with temperature. When the applied B^{heat} is too small, heating process is slow and it may not reach the glassy temperature T_{g} for actuation (FIG. 7, trace B₁); when B^{heat} is too large, the system heats up very fast, but it fails to reach a plateau temperature for stable actuation. In addition, if the temperature is near the Curie temperature of the magnetic particles, it can demagnetize them, causing the loss of magnetic driven force for actuation (FIG. 7, trace B₃). However, a well-designed input magnetic field can provide for inductive heating that achieves a short converge time to above glassy temperature and below particle demagnetization temperature (FIG. 7, trace B₂). Accordingly, we will (1) study particle size and volume fraction's effect on temperature regulation and actuation; and (2) develop a simulation platform to study the heat exchange by considering the input power of inductive heating, effective temperature increase due to heat conduction between particles and matrix, heat loss due to conduction between mSMP and actuation environment.

Study mSMP reprogramming with predictable actuation. As demonstrated in our preliminary results (FIG. 6), the reprogrammed magnetic domain may not follow the exact applied remagnetization field. An effective controllable strategy will be used to predict the reprogrammed actuation, which is determined by the material's mechanical and magnetic property. Accordingly, we will (1) develop a testing platform to evaluate reprogrammed magnetic and mechanical property; and (2) develop a theoretical framework for magnetic domain reprogramming and integrate the model with the mSMP model to describe the material's reprogrammed actuation

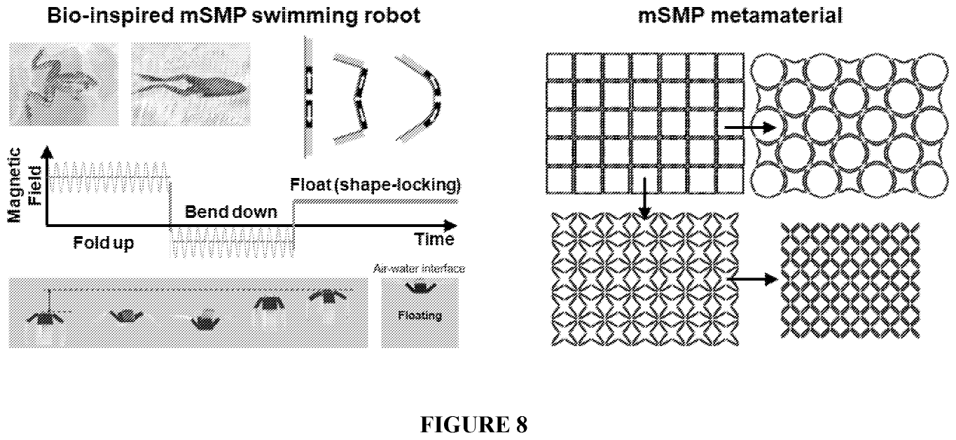

Explore multifunctional mSMP robots and metamaterial. We will also evaluate the potential applications of these mSMP in example applications, including (1) a multifunctional and multitasking soft robot with efficient propulsion and floating and sinking capability; and (2) acoustic metamaterial with tunable stiffness and bandgap (FIG. 8).

### Example 3: Magnetic Shape Memory Polymers with Integrated Multifunctional Shape Manipulations

Abstract

Shape-programmable soft materials that exhibit integrated multifunctional shape manipulations, including reprogrammable, untethered, fast, and reversible shape transformation and locking, are highly desirable for a plethora of applications, including soft robotics, morphing structures, and biomedical devices, etc. Despite recent progress, it remains challenging to achieve multiple shape manipulations in one material system. Here, we report a magnetic shape memory polymer to achieve this. The composite consists of two types of magnetic particles in an amorphous shape memory polymer matrix. The matrix softens via magnetic inductive heating of low-coercivity particles, and high-remanence particles with reprogrammable magnetization profiles drive the rapid and reversible shape change under actuation magnetic fields. Once cooled, the actuated shape can be locked. Also, varying the particle loadings for heating enables sequential actuation. The integrated multifunctional shape manipulations are further exploited for applications including soft magnetic grippers with large grabbing force, sequential logic for computing, and reconfigurable antennas.

Introduction

Shape programmable soft materials that exhibit integrated multifunctional shape manipulations, including reprogrammable, untethered, fast, and reversible shape transformation and locking, in response to external stimuli, such as heat, light, or magnetic field¹⁻⁵, are highly desirable for a plethora of applications, including soft robotics⁶, actuators⁷⁻⁹, deployable devices^{10,11}, and biomedical devices^{6,12-15}. A wide range of materials have been developed in the past, including liquid crystals elastomers^{16,17}, hydrogels¹⁸, magnetic soft materials^{6,19}, and shape memory polymers (SMPs)^{1,20-22}. Magnetic soft materials composed of magnetic particles in a soft polymer matrix have drawn great interest recently due to their untethered control for shape change^{23,24}, motion^{6,7,25}, and tunable mechanical properties²⁶. Among them, hard-magnetic soft materials utilize high-remanence, high-coercivity magnetic particles, such as neodymium-iron-boron (NdFeB), to achieve complex programmable shape changes^{6,19,27-29}. Under an applied magnetic field, these particles with programmed domains exert micro-torques, leading to a large macroscopic shape change. However, maintaining the actuated shape needs a constantly applied magnetic field, which is energy inefficient. In many practical applications, such as soft robotic grippers^{30,31} and morphing antennas^{32,33}, it is highly desirable that the actuated shape can be locked so that the material can fulfill certain functions without the constant presence of an external field.

SMPs can be programmed and fixed into a temporary shape and then recover the original shape under external stimuli, such as heat or light^{34,35}. Typically, a thermally triggered SMP uses a transition temperature (Tₜᵣₐₙ), such as glass transition temperature (T_{g}), for the shape memory effect. In a shape memory cycle, an SMP is programmed to a temporary shape by an external force at a temperature above Tₜᵣₐₙ followed by cooling and unloading. The SMP recovers its original shape at temperatures above Tₜᵣₐₙ, achieved by direct heating or inductive heating^{36,37}.

Motivated by the advantages of hard-magnetic soft materials and SMPs, we report a magnetic shape memory polymer (M-SMP) with integrated reprogrammable, untethered, fast, and reversible actuation and shape locking. The M-SMP is composed of two types of magnetic particles (Fe₃O₄ and NdFeB) in an amorphous SMP matrix. The Fe₃O₄ particles enable inductive heating under a high frequency alternating current (AC) magnetic field and thus are employed for shape locking and unlocking of the M-SMP. The NdFeB particles are magnetized and remagnetized with predetermined magnetization profiles for programmable actuation. We demonstrate that the integrated multifunctional shape manipulations offered by M-SMPs can be exploited for a wide range of applications, including soft grippers for heavy loads, sequential logic circuits for digital computing, and reconfigurable morphing antennas.

Results

Design and Characterization

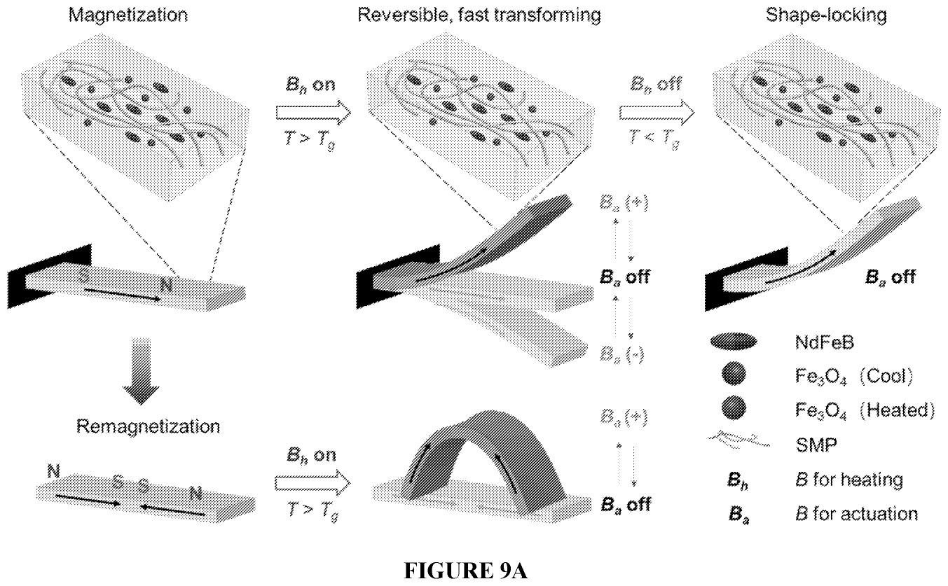

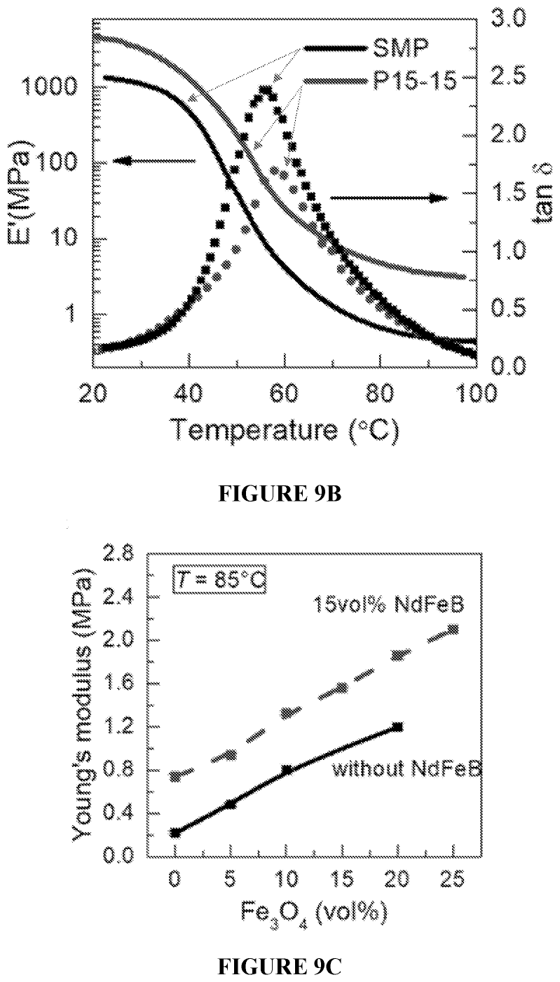

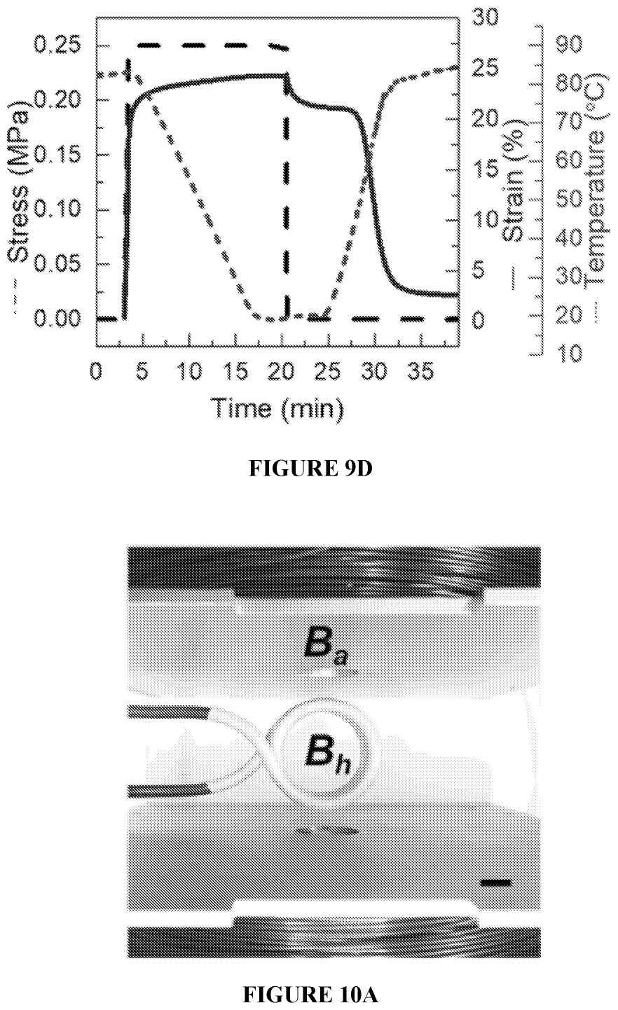

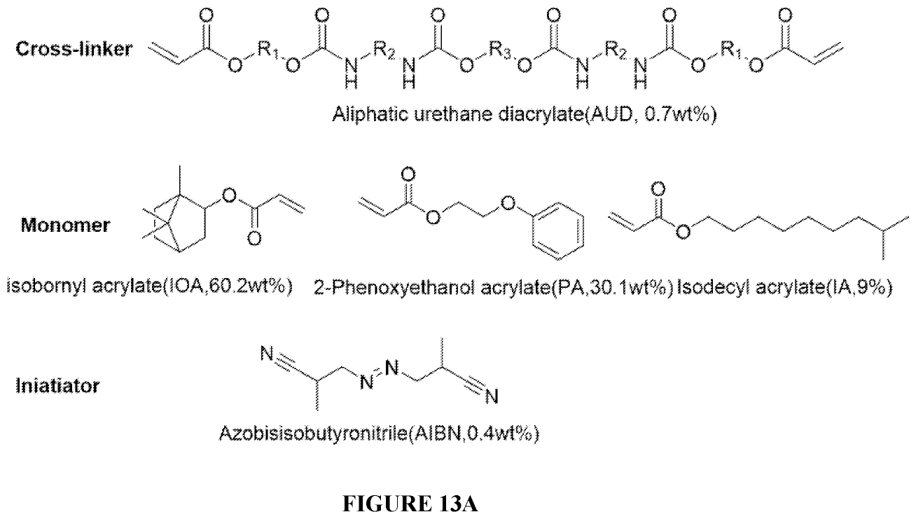

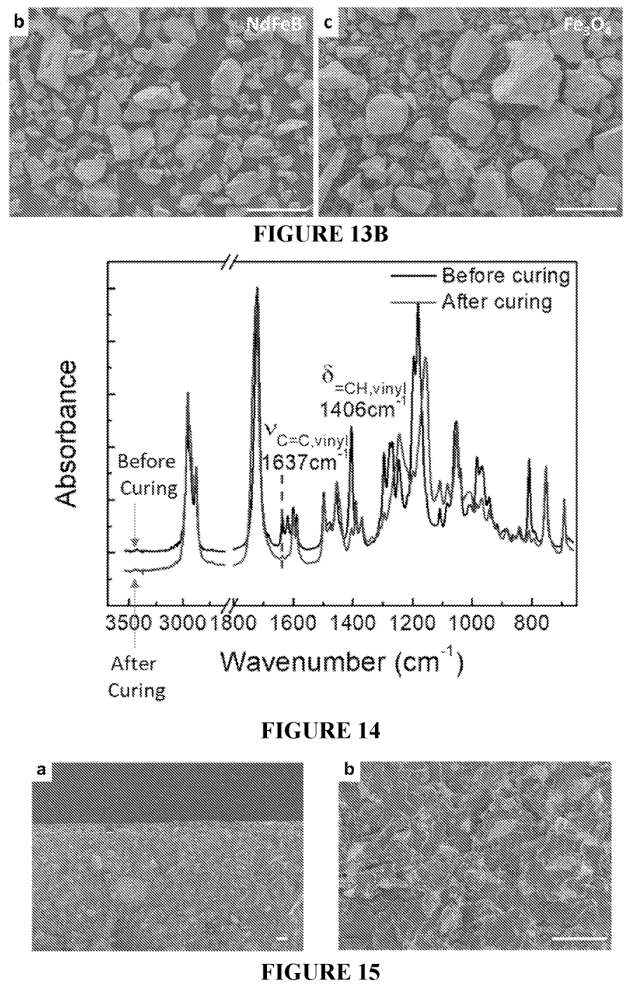

To demonstrate the concept, we fabricate an acrylate-based amorphous SMP with embedded NdFeB microparticles and Fe₃O₄ microparticles (Methods, FIGS. 13-15, Table 28 & 29). Before use, the M-SMP is magnetized to have a desired magnetic profile under an impulse magnetic field (˜1.5 T). FIG. 9A shows the working mechanism by using an M-SMP cantilever with a magnetization polarity along its longitudinal direction. At room temperature, the cantilever is stiff and cannot deform under an actuation magnetic field (Bₐ). When a heating AC magnetic field (Bₕ) is applied, the inductive heating of the Fe₃O₄ particles heats the M-SMP above its T_{g}, and the modulus of the M-SMP drops significantly. Then, a small Bₐ can bend the cantilever. By alternating Bₐ between up (+) and down (−) directions at this moment, fast transforming between upward and downward bending can be easily achieved. Upon removal of Bₕ, the bending shape can be locked without further applying Bₐ once the temperature of the M-SMP drops below its T_{g}. Moreover, the magnetization profile of the M-SMP can be reprogrammed for different shape transformation by remagnetization. For example, remagnetizing the beam when it is mechanically locked in a folding shape will change the actuation shape to folding under the same Bₐ (bottom row of FIG. 9A).

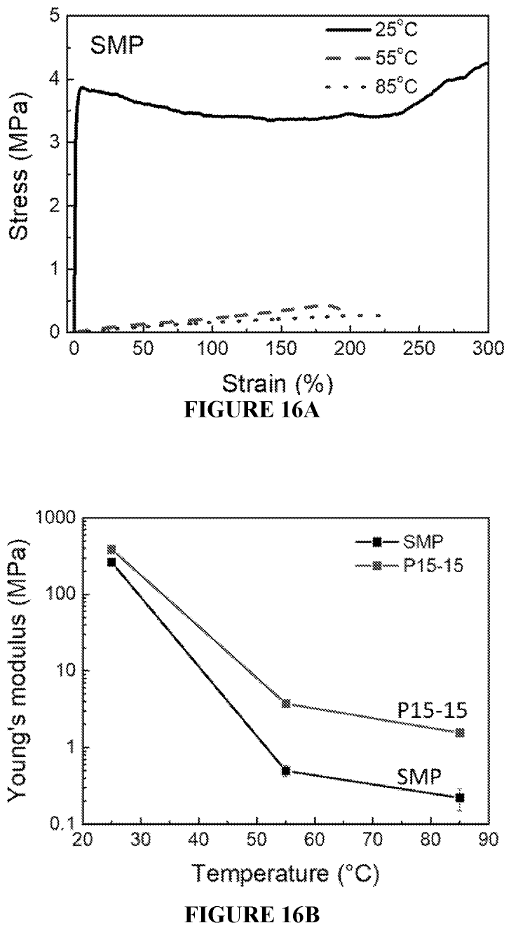

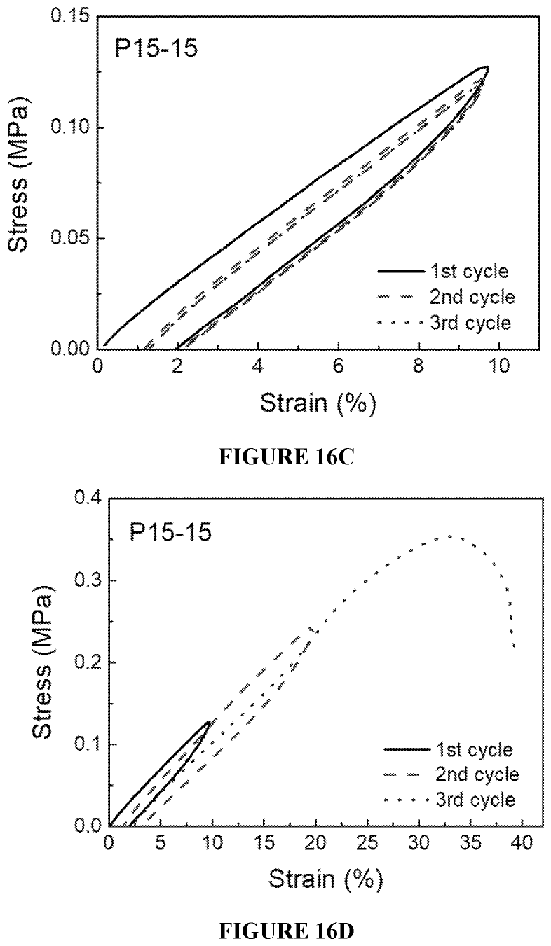

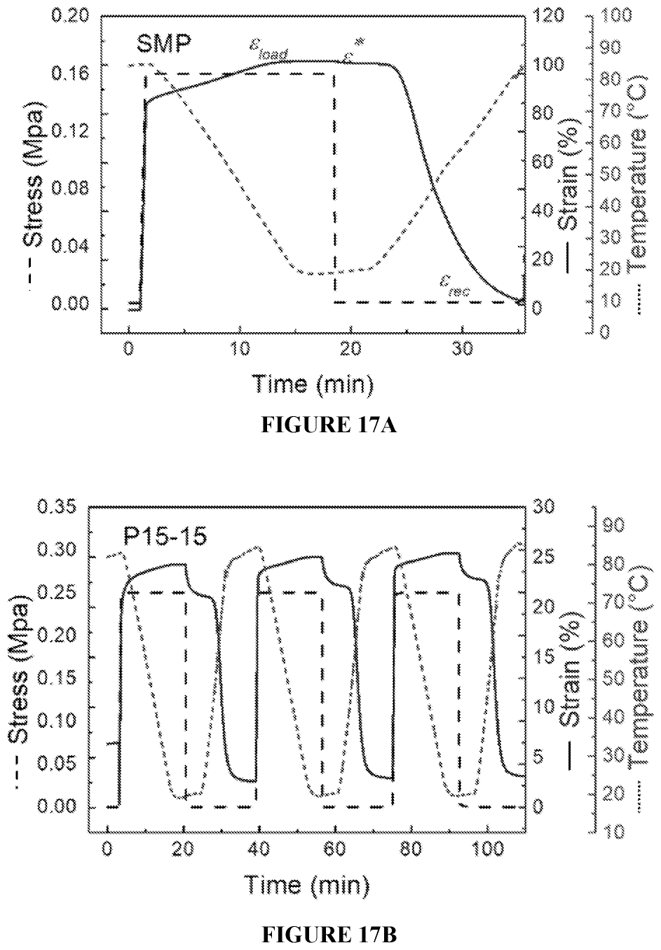

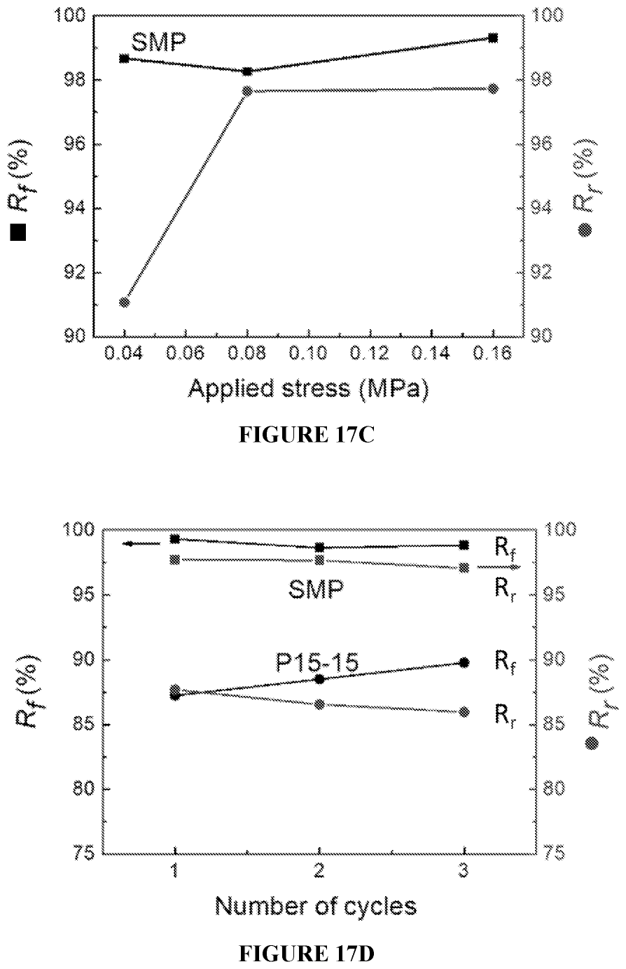

Neat SMP and M-SMP samples are prepared to characterize their thermomechanical properties. FIG. 9B shows the thermomechanical properties of the neat SMP and the M-SMP P15-15, where the two numbers represent the volume fractions of Fe₃O₄ and NdFeB particles, respectively. The storage modulus of P15-15 decreases from 4.6 GPa to 3.0 MPa when the temperature T increases from 20° C. to 100° C. T_{g}, measured as the temperature at the peak of the tan δ curve, is ˜56° C. for the neat SMP, and ˜58° C. for P15-15 (FIG. 16). The Young's modulus of the M-SMP at high-temperature increases linearly with the increasing particle loading (FIG. 9C). FIG. 9D shows the strain, stress, and temperature as functions of time during the shape memory test of P15-15. When P15-15 is programmed at 85° C., it has the shape fixity and shape recovery ratios of 87.8% and 87.2%, respectively (FIG. 17).

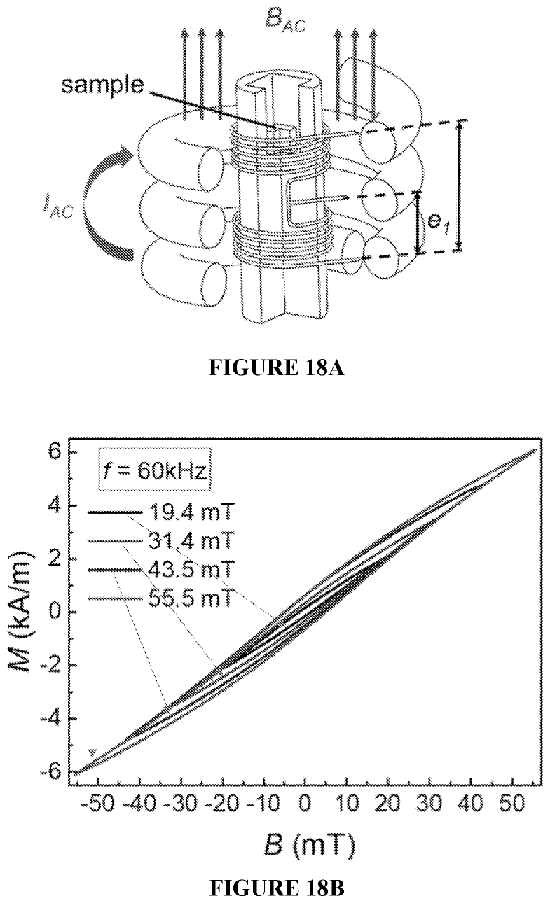

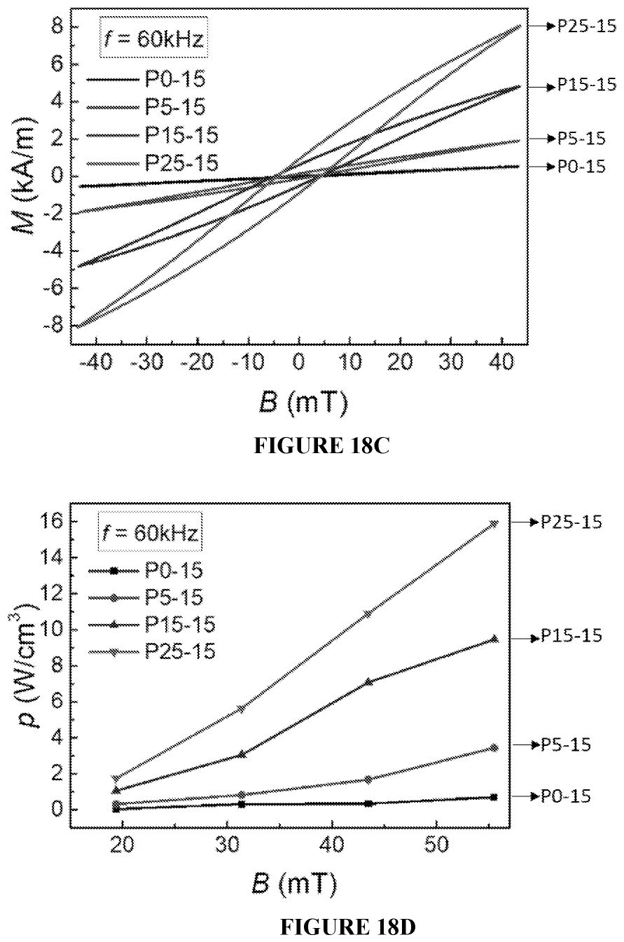

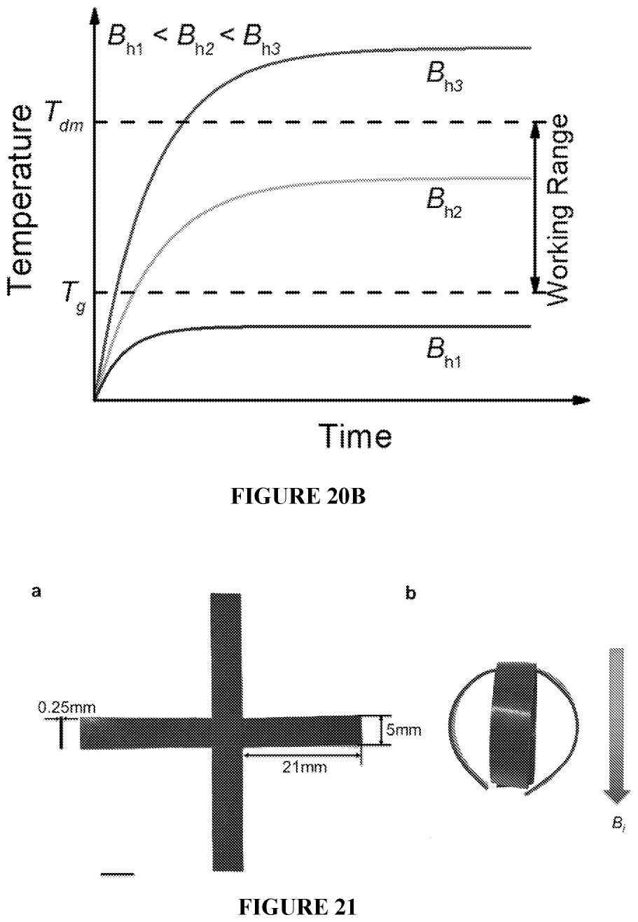

The Fe₃O₄ particles, due to their low coercivity, can be easily magnetized and demagnetized under a small high frequency AC magnetic field, leading to a magnetic hysteresis loss for inductive heating. In contrast, the NdFeB particles, due to their high coercivity, can retain high remnant magnetization for magnetic actuation (FIGS. 18 & 19). Note that the NdFeB particles start to be demagnetized when the temperature is above ˜150° C. (FIG. 20). Therefore, the temperature for shape unlocking and actuation should be limited to below 150° C.

Fast Transforming and Shape Locking

Here, we experimentally demonstrate the remote fast transforming and shape locking of the M-SMP, which can be used as a soft robotic gripper. The experimental setup for M-SMP heating and actuation consists of two types of coils (FIG. 10A): a pair of electromagnetic coils generate Bₐ for actuation; a solenoid provides Bₕ for inductive heating. An M-SMP (P15-15) cantilever is fabricated with magnetization along its longitudinal direction in such a way that the beam will tend to bend under a vertical magnetic field (FIG. 10B). To actuate the beam, we use Bₕ=40 mT at 60 kHz and Bₐ=30 mT. The magnetic field profiles for Bₐ and Bₕ, as well as the measured cantilever displacement versus time, are shown in FIG. 10C. The application of Bₕ gradually increases the temperature and the deflection of the M-SMP. Here, we alternate Bₐ at 0.25 Hz to show the reversible fast transforming. Upon removal of Bₕ at 30 s, the temperature drops by air cooling and the modulus of M-SMP increases dramatically (FIG. 9B). The bending shape can then be locked without further application of Ba. FIG. 10D shows the M-SMP cantilever carrying a weight (23 g) that is 64 times heavier than its own weight (0.36 g).

Soft robotic grippers are intensively researched due to their capability of adapting their morphology to grab irregular objects. However, the low-stiffness nature of soft materials significantly limits the actuation force, making most soft robotic grippers incapable of grabbing heavy objects. Taking M-SMPs' advantage of shape locking, we next demonstrate a soft robotic gripper that grabs an object much heavier than its own weight. FIG. 10E shows the design and magnetization directions of a four-arm gripper (FIG. 21). By applying Bₕ and a positive Bₐ (upward), the gripper softens and opens up for grabbing. Upon switching the Bₐ to negative, the gripper conforms to the lead ball. At this moment, the ball slips if the gripper is lifted (FIG. 10F). However, the gripper can be locked into the actuated shape and provide a large grabbing force when we remove the Bₕ and cool down the material. As demonstrated in FIG. 10G, the stiffened gripper can effectively lift the lead ball without any external stimulation. The weight of the lead ball is 23 g, which is 49 times heavier than the gripper (0.47 g).

Sequential Actuation

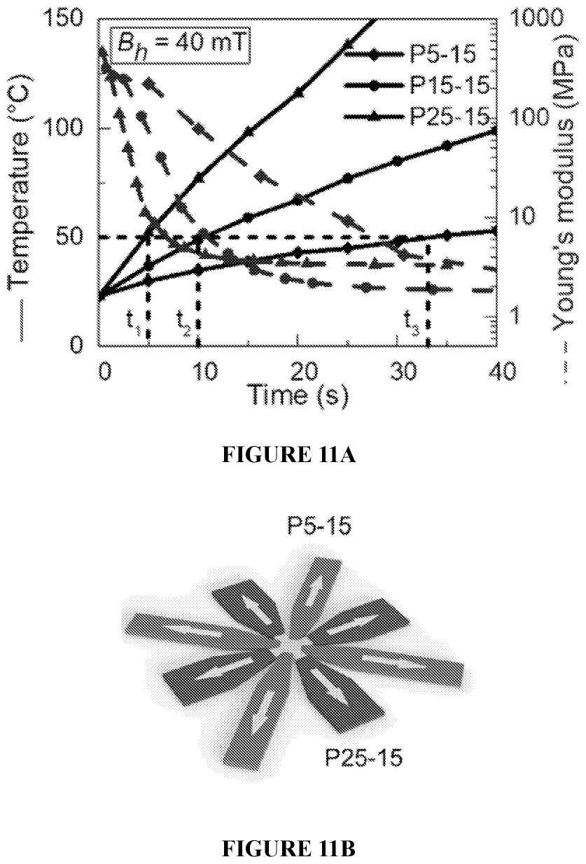

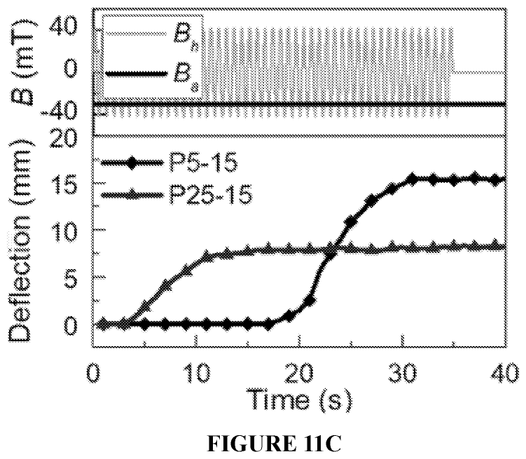

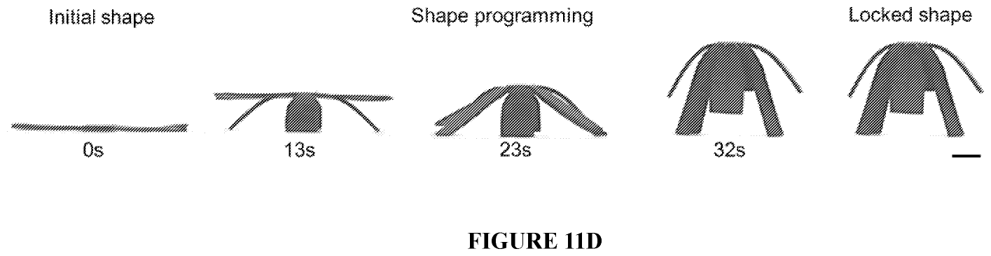

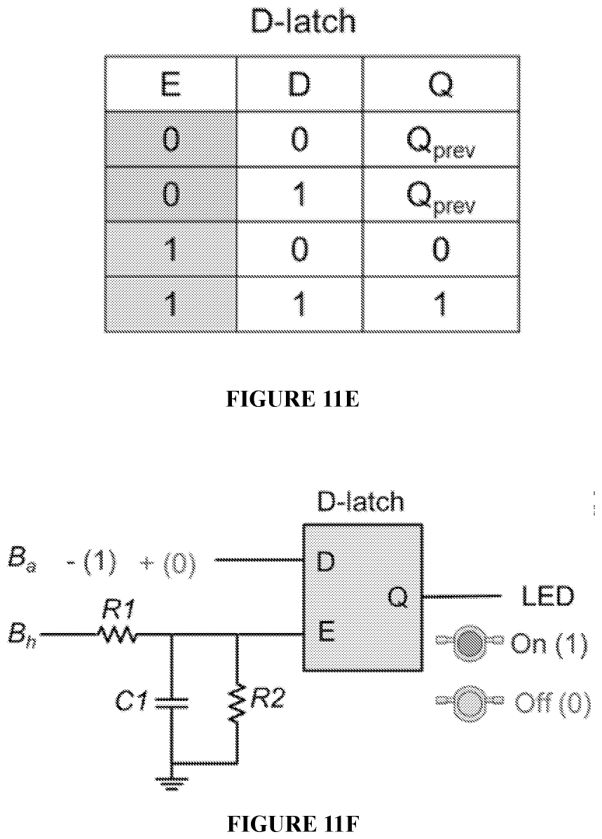

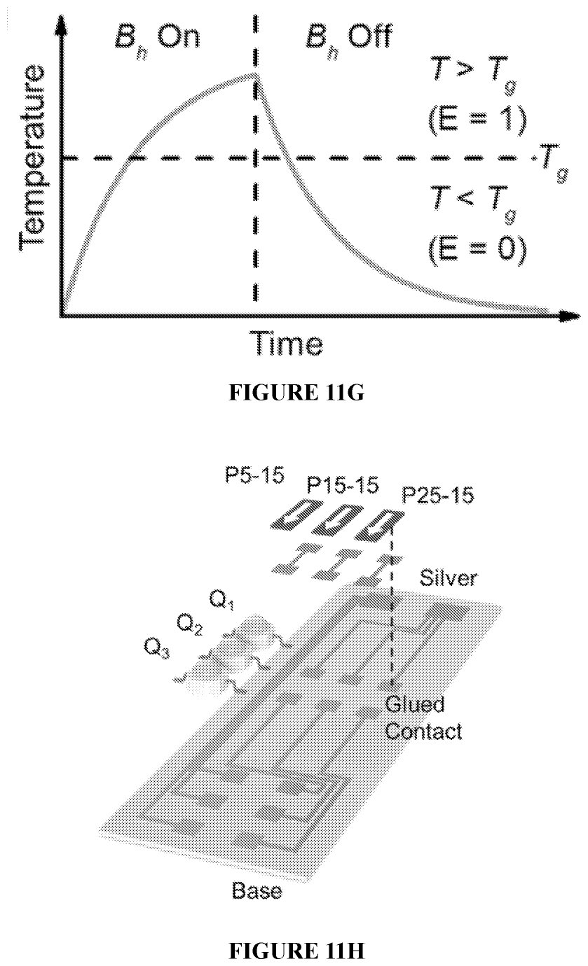

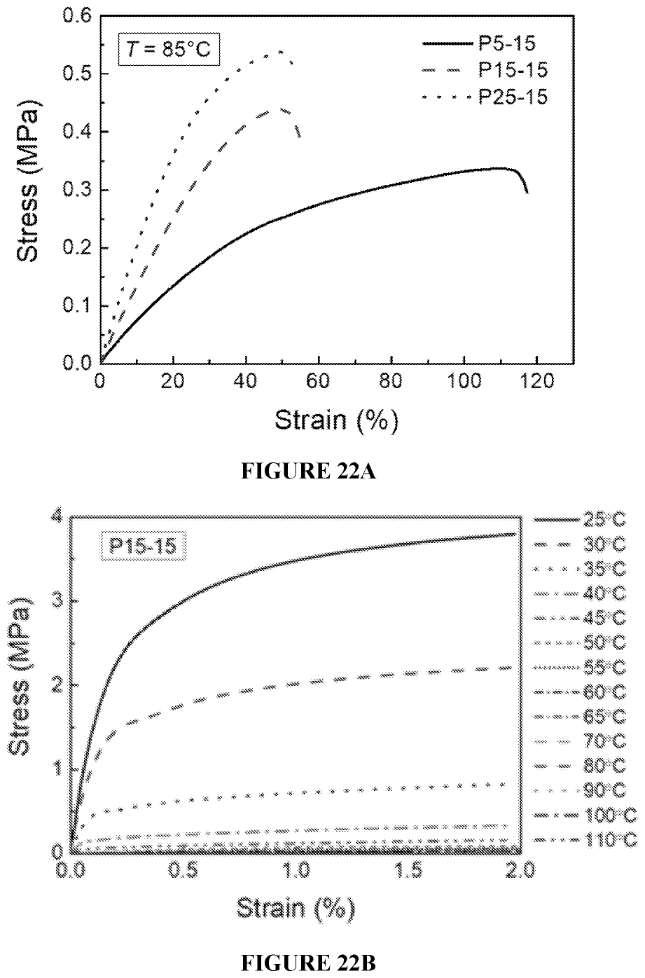

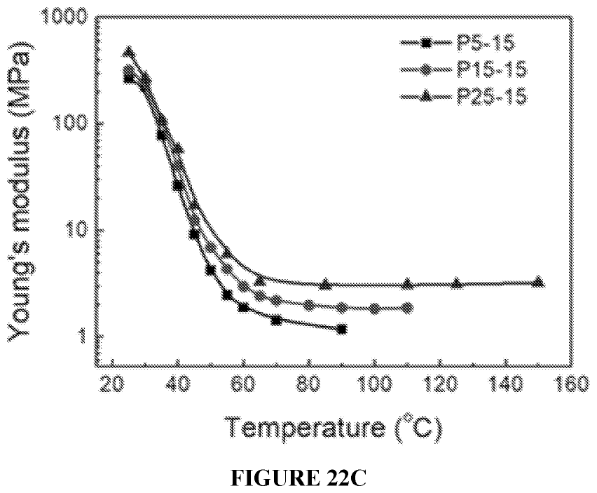

The sequential shape transformation of an object in a predefined sequence can enable a material or system to fulfill multiple functions^{25,38}. Here, we show that the sequential actuation of an M-SMP system can be achieved by designing and actuating material regions with different Fe₃O₄ loadings for different resultant heating temperatures and stiffnesses under the same applied Bₕ. We prepare three M-SMPs with the same dimension containing the same amount of NdFeB (15 vol %) but different amounts of Fe₃O₄ (5 vol %, 15 vol %, and 25 vol %, named as P5-15, P15-15, and P25-15, respectively). FIG. 11A shows the mechanical and heating characterizations of the three M-SMPs under the same Bₕ (Methods, FIG. 22). To reach the temperature (around 50° C.) at which the M-SMPs become reasonably soft to deform under Bₐ, it takes 5 s, 11 s, and 35 s for P25-15, P15-15, and P5-15, respectively.

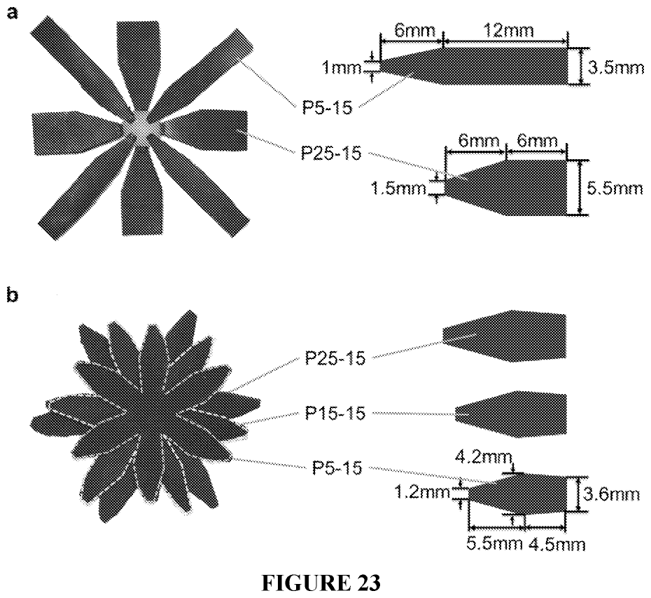

Based on the mechanism of sequential actuation, we design a flower-like structure made of M-SMP petals using P5-15 and P25-15 to demonstrate the programmable sequential motion (FIG. 11B). The P5-15 petals are designed to be longer than the P25-15 ones, and the magnetization is along the outward radial direction for all petals (FIG. 23). FIG. 11C shows the Bₕ (red) and Bₐ (black) profiles as functions of time. The deflections of P5-15 and P25-15 petals, defined as the vertical displacements of the endpoints, are plotted as black and blue curves in FIG. 11C, with the sequential shape change illustrated in FIG. 11D. Upon the application of Bₕ and a negative Bₐ, the P25-15 petals soften and start to bend first due to the large heating power. During this time, the P5-15 petals are heated slowly and remain straight due to their lower temperature and high stiffness. With increasing heating time, the P5-15 petals start to soften and bend at 18 s and are eventually (at 32 s) fully actuated to lift the entire flower. After removing Bₕ and cooling the flower down to room temperature, all petals are locked in their deformed shape. Fast transforming feature of M-SMPs is also demonstrated by switching the magnetic field direction during the actuation process. Data shows a flower blooming-inspired sequential shape-transformation of an M-SMP system using P5-15, P15-15, P25-15.

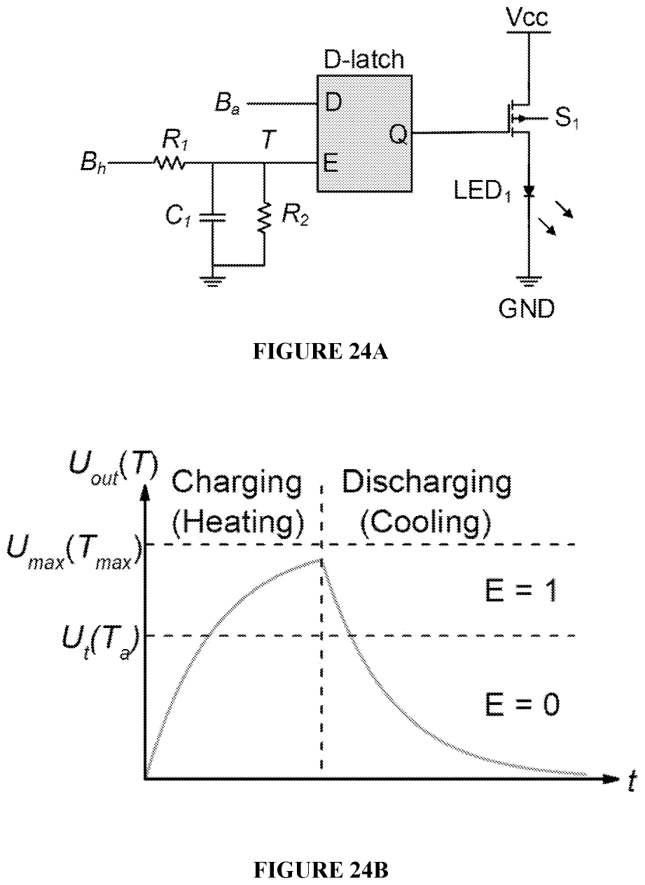

Sequential actuation for digital computing Soft active materials and structures have recently been explored for programmable mechanical computing due to its capability of integrating actuation and computing in soft bodies for potential applications in self-sensing of autonomous soft robots^{39,40}, nonlinear dynamics-enabled nonconventional computing⁴¹, and mechanical logic circuits⁴²⁻⁴⁴. Taking M-SMPs' advantages of reversible actuation and shape locking, we demonstrate that M-SMPs can be used to design a sequential logic device, the D-latch, for storing one bit of information, which can be readily extended to a memory with arbitrary bits. The truth table for D-latch logic is shown in FIG. 11E: when the input E is 1, the output Q keeps the same value as the input D; when the input E is 0, the output Q stays latched and is independent of the input D. We achieve this D-latch logic utilizing the controlled actuation of an M-SMP beam switch (FIGS. 11F & 11G). The magnetic fields Bₕ and Bₐ work as inputs and the LED serves as the indicator of the output. The time-dependent actuation/locking of M-SMPs is interpreted to an RC delay circuit between Bₕ and the D-latch, where the heating/cooling time of the M-SMP is regarded as the charging/discharging time of a capacitor (FIG. 24). When Bₕ is on and the beam is unlocked (T>T_{g}, E=1), the downward Bₐ (D=1) or upward Ba (D=0) determines whether the circuit is closed or open, leading to the on (Q=1) or off (Q=0) state of the LED. When Bₕ is off and the beam is locked (T<T_{g}, E=0), Bₐ is no longer capable of actuating the beam and, consequently, cannot change the status of the LED. In other words, the previous state of Q is stored in the system.

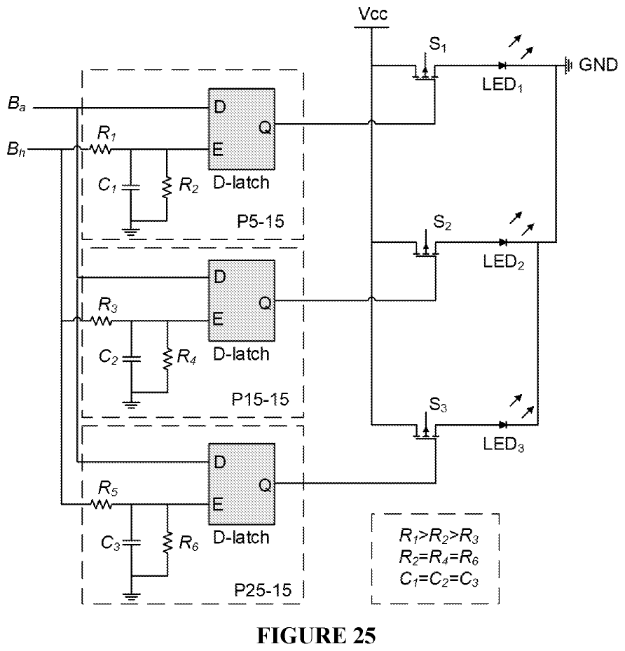

With the M-SMP-enabled D-latch system, we next design a sequential digital logic circuit as a three-bit memory, which contains three M-SMP beams (P5-15, P15-15, and P25-15) and three LEDs shown in FIG. 11H (Methods, FIG. 25). FIG. 11I shows the three-step logic for this three-bit memory, with E₁, E₂ and E₃ representing the input E for P5-15, P15-15, and P25-15, respectively. During the operation, heating for 28 s unlocks all M-SMPs (E₁, E₂, E₃=1); heating for 12 s unlocks P5-15 and P25-15 (E₁=0, E₂, E₃=1); heating for 6 s only unlocks P25-15 (E₁, E₂=0, E₃=1). Followed by cooling and actuation (changing D), the M-SMP switches can lock their shapes and retain the output status. FIG. 11J shows the original state and output states for the three M-SMP switches indicated by the LEDs. In the first step, unlocking all M-SMPs E₂, E₃=1) with D=1 changes the memory state from 0-0-0 to 1-1-1. After cooling and locking (E₁, E₂, E₃=0), we next unlock P15-15 and P25-15 (E₁=0, E₂, E₃=1) and switch D to 0, which changes the memory state from 1-1-1 to 1-0-0. In the third step after locking (E₁, E₂, E₃=0), we only unlock P25-15 (E₁, E₂=0, E₃=1) and switch D to 1 to finally change the memory state to 1-0-1. This example demonstrates that by controlling the two inputs Bₕ (E) and Bₐ (D), we can erase and rewrite the information in the memory (FIGS. 30 & 31).

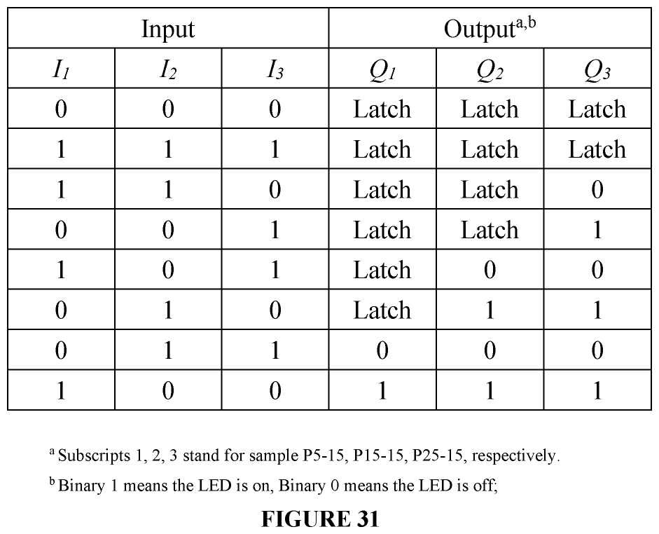

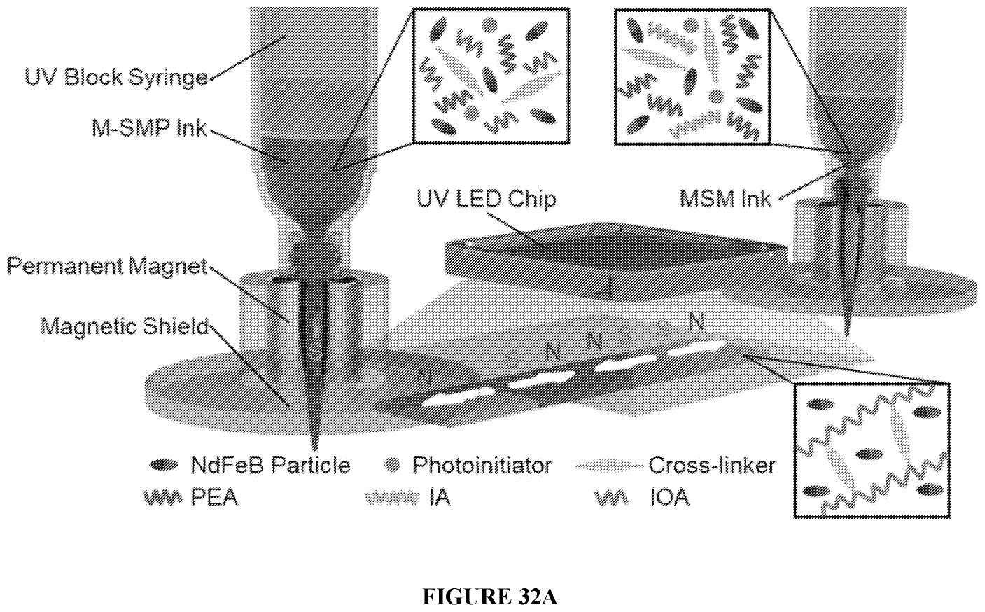

According to FIG. 31, the logical equations can be derived as follows:

$$\{ \begin{matrix}{Q}_{1}^{n + 1} = ( {I}_{1} {I}_{2} {I}_{3} + \overline{{I}_{1} {I}_{2} {I}_{3}} ) {Q}_{1}^{n} + ( ( \overline{{I}_{1} {I}_{2} {I}_{3} + \overline{{I}_{1} {I}_{2} {I}_{3}}} ) ( ( {I}_{2} ▯ {I}_{3} ) {Q}_{1}^{n} + ( {I}_{1} ▯ {I}_{3} ) {Q}_{1}^{n} + ( {I}_{1} ▯ {I}_{2} ) {I}_{3} ) \\ {Q}_{2}^{n + 1} = ( {I}_{1} {I}_{2} {I}_{3} + \overline{{I}_{1} {I}_{2} {I}_{3}} ) {Q}_{2}^{n} + ( ( \overline{{I}_{1} {I}_{2} {I}_{3} + \overline{{I}_{1} {I}_{2} {I}_{3}}} ) ( ( {I}_{2} ▯ {I}_{3} ) {Q}_{2}^{n} + ( {I}_{1} ▯ {I}_{3} ) {I}_{2} + ( {I}_{1} ▯ {I}_{2} ) {I}_{3} ) \\ {Q}_{3}^{n + 1} = ( {I}_{1} {I}_{2} {I}_{3} + \overline{{I}_{1} {I}_{2} {I}_{3}} ) {Q}_{3}^{n} + ( ( \overline{{I}_{1} {I}_{2} {I}_{3} + \overline{{I}_{1} {I}_{2} {I}_{3}}} ) ( ( {I}_{2} ▯ {I}_{3} ) {I}_{1} + ( {I}_{1} ▯ {I}_{3} ) {I}_{2} + ( {I}_{1} ▯ {I}_{2} ) {I}_{3} )\end{matrix} , \qquad ( S6 )$$

where Q₁ⁿ⁺¹ is the next LED state of Q₁ⁿ, =1, 2, and 3.

Theoretically, an electronic device with n-bit memory can be realized with n M-SMPs with varying particle loadings. In this way, 2ⁿ states can be achieved and stored with n steps by manipulating two inputs. Additionally, we can tune the NdFeB particle loading and T_{g} to provide more design flexibility for more complex computing systems using M-SMPS.

Reprogrammable Morphing Radiofrequency Antennas

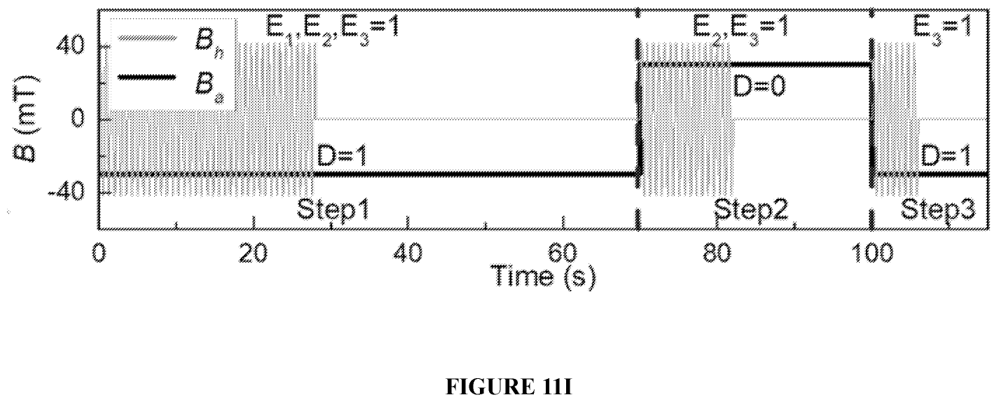

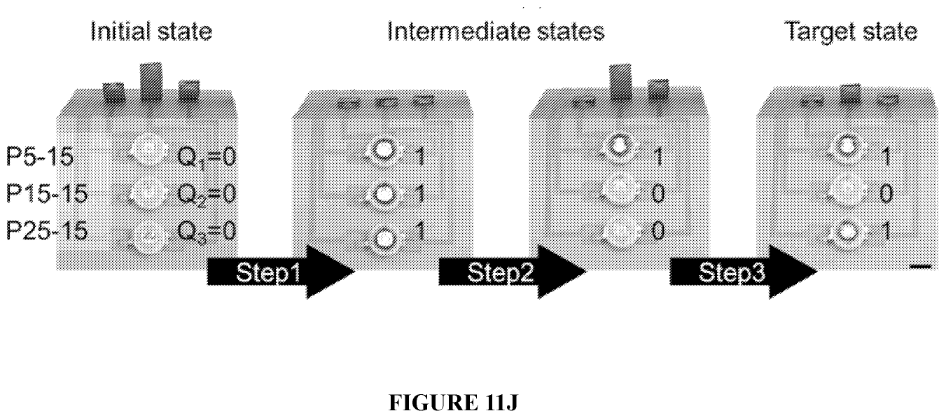

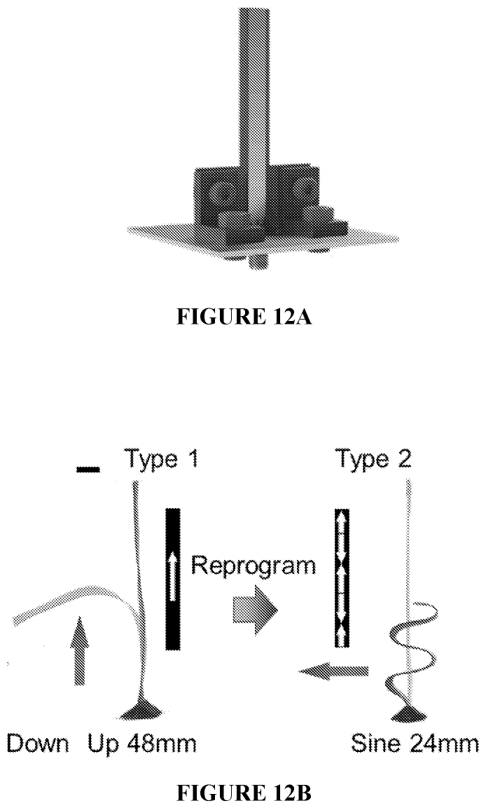

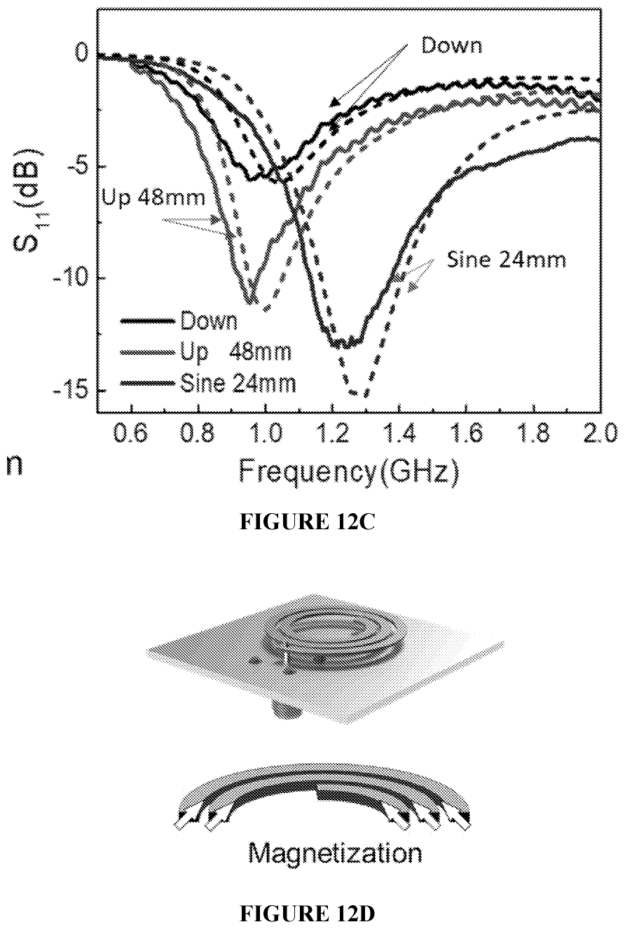

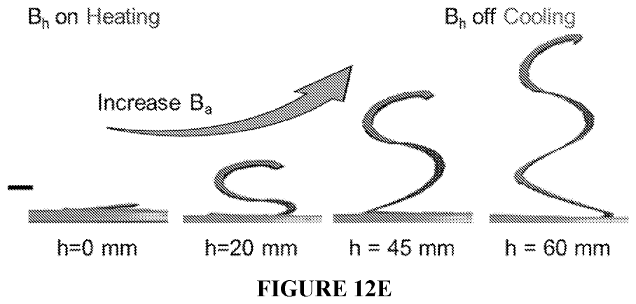

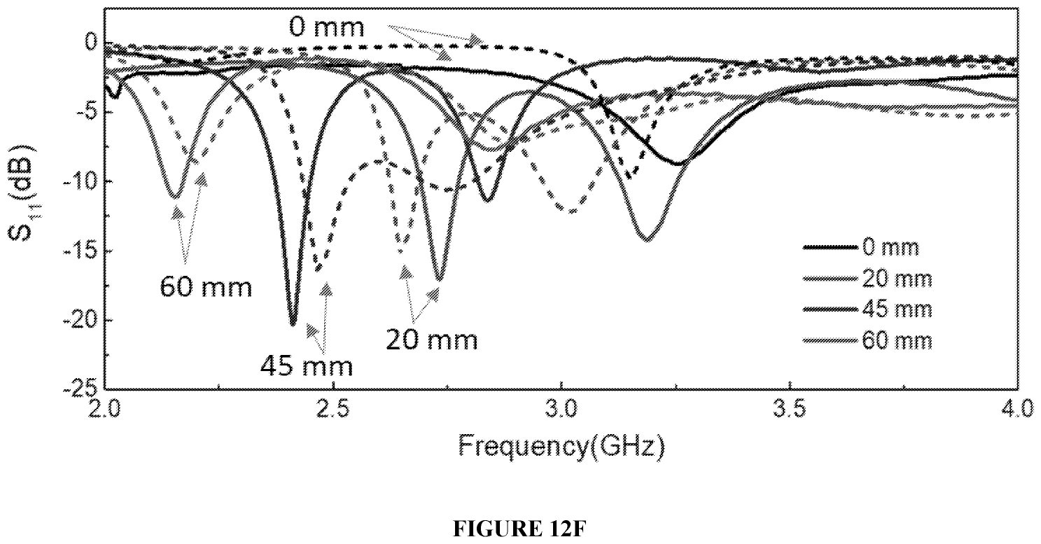

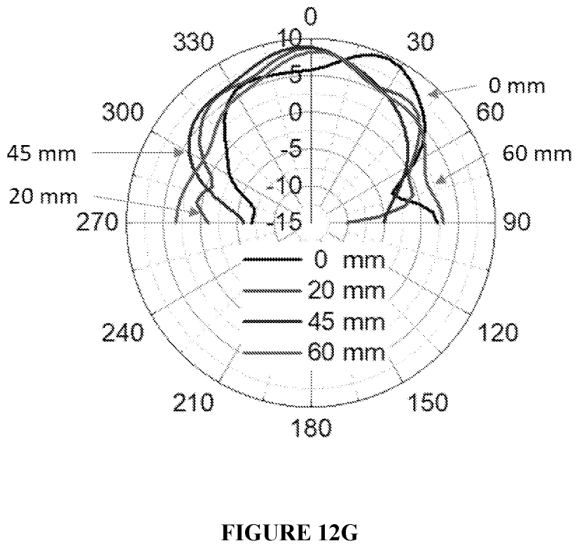

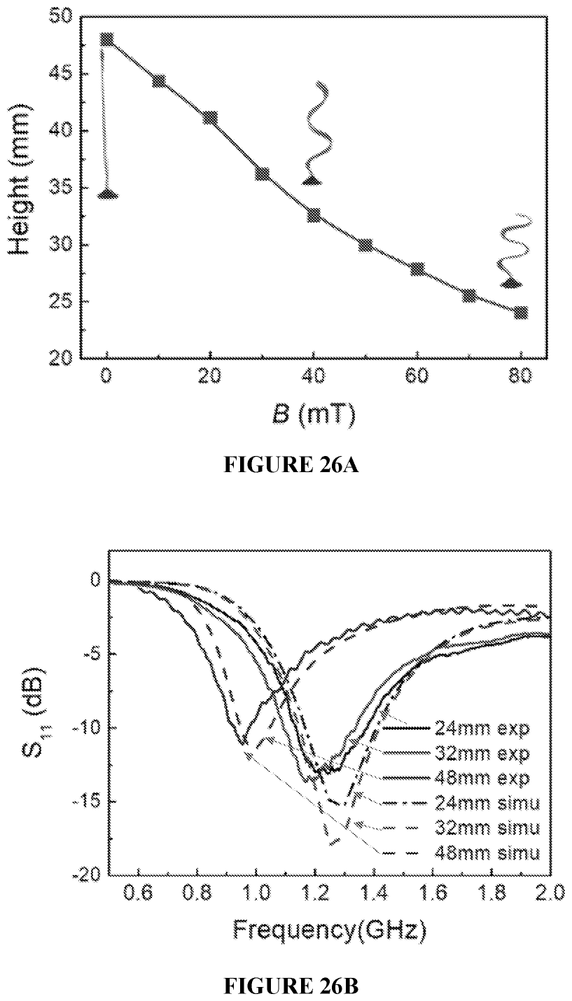

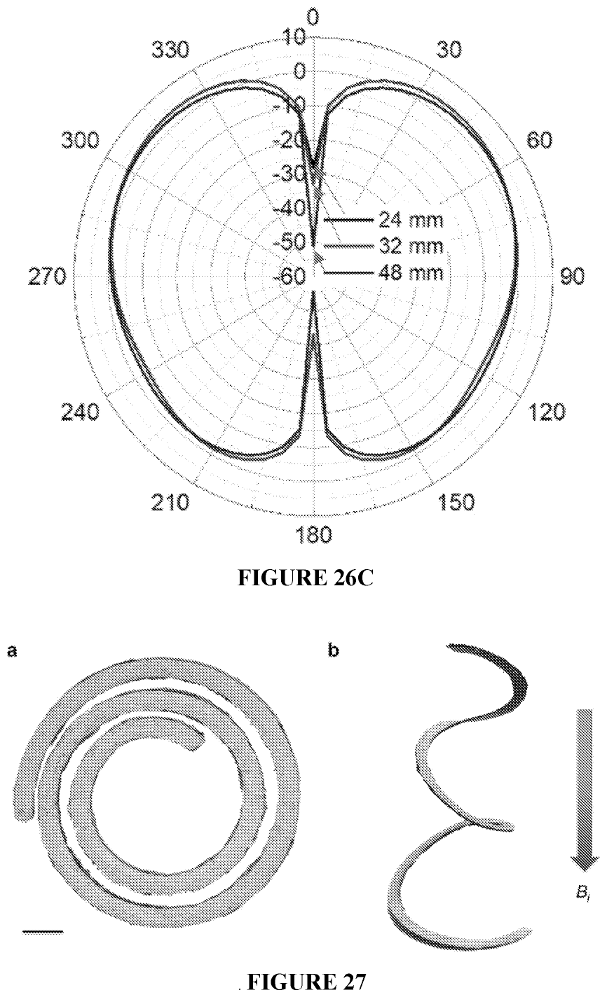

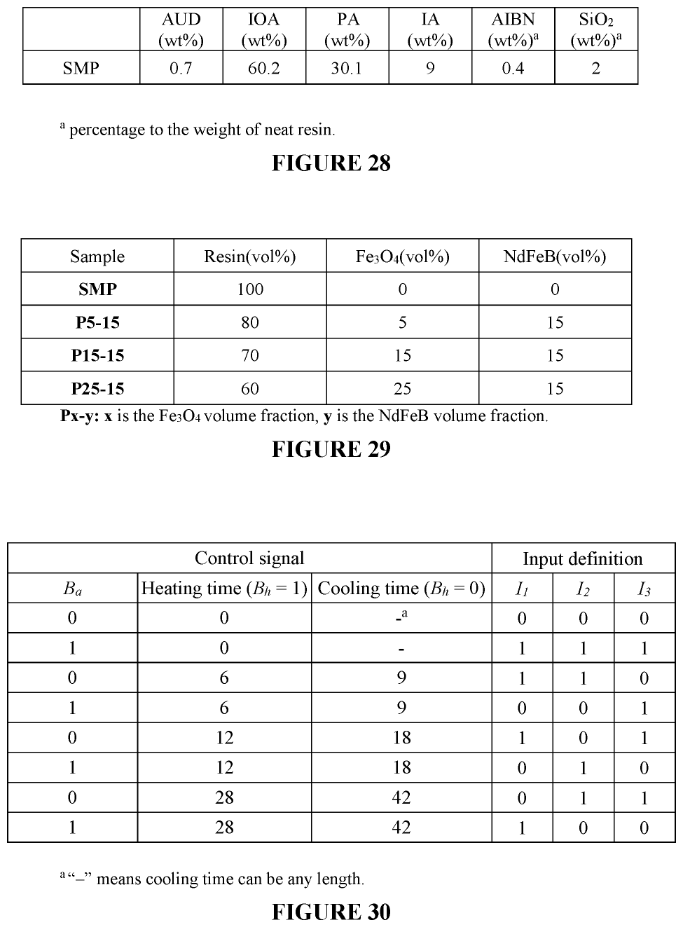

The ability to change the antenna shape on the fly provides the capability to either remotely deploy an antenna^{45,46} or reconfigure its functionality⁴⁷⁻⁴⁹. Here, we demonstrate two morphing radio-frequency (RF) antennas that can rapidly, reversibly transform between on-demand shapes. The shape locking of M-SMPs allows the antennas to retain their actuated, functional shapes without the need for a constant application of external stimulation. FIG. 12A shows the design of a cantilever-based morphing monopole antenna (48 mm long). It can be reprogrammed to different magnetization profiles to transform into different shapes. Being magnetized along its longitudinal direction, gravity drives the cantilever to bend down (Down shape) upon heating. The Down shape can be actuated to the Up shape under Bₐ=20 mT (FIG. 12B). FIG. 12B shows the antenna works as a deployable monopole antenna due to its poor impedance (S₁₁ larger than the acceptable value, −10 dB^{45,47}) in the Down shape butgood S₁₁ value with a resonant frequency of 0.95 GHz in the Up shape. Moreover, this deployable antenna can be altered to a reconfigurable antenna by reprogramming its magnetization profile. Here, the same cantilever is remagnetized to have a sinusoidal shape with a height of 24 mm under Bₐ=80 mT (FIG. 12B, FIG. 26). FIG. 12C shows the resonant frequency of this antenna shifts from 0.95 GHz (Up shape) to 1.25 GHz (sinusoidal shape), representing a 32% change, with good agreement achieved between the simulation and experimental results. The radiation pattern simulations and polar plots are similar for all these configurations (FIG. 26), which is beneficial as a reconfigurable antenna.

Utilizing M-SMP's advantages of shape transformation and locking, the on-demand shape transformation from a planar state to a 3D structure can also be achieved. Here we design a tapered helical antenna to achieve frequency reconfigurability. The antenna is composed of a thin M-SMP substrate with printed conductive silver wire on its surface (FIG. 12D). The M-SMP substrate is magnetized in a stretched, spring-like configuration (FIG. 27) to realize the pop-up actuation with programmable heights and configurations under a controlled vertical Bₐ (FIG. 12E). The simulation and experimental results in FIG. 12F show that the resonant frequencies of the antenna can be readily tuned between 2.15 GHz and 3.26 GHz. The simulated radiation patterns at resonance with similar profiles shown in FIG. 12G indicate that the operating direction of the antenna remains constant, which is desirable for antenna applications. Due to the shape locking capability offered by the M-SMP, the reconfigured antenna can retain the new shape without assistance from the external field, which lowers the overall energy requirements. Using M-SMPs as a substrate material for a remotely controlled reconfigurable antenna is thus advantageous over the mechanically programmed antenna³³ and conventional magnetic-responsive antenna⁵⁰.

Conclusion

In summary, the reported magnetic shape memory polymer integrates reprogrammable, untethered, fast, and reversible shape transformation and shape locking into one system. Utilizing two types of embedded magnetic particles for inductive heating and actuation, the material can be effectively unlocked and locked for energy-efficient operations and functions as soft grippers, sequential actuation devices, digital logic circuits, and deployable/reconfigurable antennas. With recent advances in simulation tools and 3D/4D printing for design optimization and fabrication of complex structures, these demonstrations suggest that the M-SMP can serve as a material platform for a wide range of applications, including biomedical devices for minimum invasive surgery, active metamaterials, morphological computing, autonomous soft robots, and reconfigurable, flexible electronics, etc.

Methods

Preparation of the M-SMPs

Our neat SMP is an acrylate-based amorphous polymer. The resin contains aliphatic urethane diacrylate (Ebecryl 8807, Allnex, Ga.), 2-Phenoxyethanol acrylate (Allnex, Ga.), isobornyl acrylate (Sigma-Aldrich, St. Louis, Mo.), and isodecyl acrylate (Sigma-Aldrich, St. Louis, Mo.) with a weight ratio of 0.7:60.2:30.1:9. A thermally-induced radical initiator (2,2′-Azobis(2-methylpropionitrile), 0.7 w %) is added for thermal curing. Additionally, 2 wt % of fumed silica with an average size of 0.2-0.3 μm (Sigma-Aldrich, St. Louis, Mo.) and 0.4 wt % of 2,2′-Azobis(2-methylpropionitrile) are added to ensure good mixing of the matrix resin with the magnetic particles. The composite is prepared by adding predetermined amounts of Fe₃O₄ (0-25 vol %) (particle size of 30 μm, Alpha Chemicals, MO, USA) and NdFeB magnetic particles (15 vol %) (average particle size of 25 μm, Magnequench, Singapore) in the matrix resin. The M-SMP composite is denoted as Px-y with x of Fe₃O₄ volume fraction and y of NdFeB volume fraction. The reactive mixture is manually mixed, degassed under vacuum, and then sandwiched between two glass slides with different separation thicknesses for thermal curing. The thicknesses are 0.8 mm for the cantilever, 0.5 mm for the gripper, 0.6 mm for the flower-like structure, 0.8 mm for the beams used in the sequential logic circuit, and 0.25 mm for the single beam-based antenna. The thermal curing is conducted by precuring at 80° C. for 4 h and postcuring at 120° C. for 0.5 h. The cured composite films are magnetized and remagnetized by impulse magnetic fields (about 1.5 T for first magnetization and 5.5 T for remagnetization) generated by an in-house built impulse magnetizer. The magnetization profile of the embedded magnetic composite can be manipulated by changing the composite shape then applying the impulse magnetic field.

Electromagnetic Coil System for Actuation and Inductive Heating

We use a pair of in-house built electromagnetic coils with a distance of 74 mm for actuating. The two coils are connected in series and powered by a custom programmable power supply with up to 15 A output current. The coils can generate a central magnetic field with a ratio of 7 mT/A. A water-cooled solenoid is connected to an LH-15A high-frequency induction heater to generate an alternating magnetic field with a frequency of 60 kHz and a magnetic field ranging from 10 mT to 60 mT.

Physical Properties Characterization

Uniaxial tension tests are conducted on a dynamic mechanical analysis (DMA) tester (Q800, TA Instruments, New Castle, Del.) at various temperatures. The film samples (dimension: about 20 mm×3 mm×0.6 mm) are stretched at a strain rate of 0.2/min. At least three tests are conducted for each sample to obtain average values. The dynamic thermomechanical properties are measured on the DMA tester. A preload of 1 mN is applied on the sample, and then the strain is oscillated at a frequency of 1 Hz with a peak-to-peak amplitude of 0.1%. The temperature is ramped from 0° C. to 120° C. at the rate of 3° C./min. The shape memory tests are carried out on the DMA tester in the uniaxial tensile mode with controlled force. The thermal imaging video and temperature profiles (FIG. 10C & FIG. 11A) are recorded using a Compact series thermal imaging camera (Seek Thermal, Inc., Santa Barbara, Calif., USA). The dimensions of the three M-SMPs used for the temperature profiles in FIG. 11A are all 10 mm×10 mm×1 mm.

Cantilever Experiments

The M-SMP film is cut into a strip with a length of 35 mm and width of 4.5 mm. Two acrylic pieces (length: 15 mm, width: 7 mm, thickness: 2 mm.) are used to clamp one end of the M-SMP strip to create a cantilever with a length of 20 mm.

Gripper Experiments

Two M-SMP strips (length: 47 mm, width: 5 mm) are cut and glued together to form a cross shape. The dimension of each arm is 21 mm long and 5 mm wide. The four-arm gripper is heated until soft and mechanically deformed to fully grasp a lead ball (diameter: 15 mm). The gripper was then cooled down and magnetized along the direction shown in FIG. 21. After magnetization, a quartz rod is glued to the central part of the gripper and fixed on a translational stage for the movement in the vertical direction.

Flower-Like Structure Experiments

The flower-like structure has two types of petals, one is P5-15 and one is P25-15. The dimensions of P5-15 and P25-15 petals are shown in FIG. 23. Acrylic molds for petals and the whole structure are cut using a laser cutter. The mold is then pressed on the top of the M-SMP films to cut them into petal shapes. The individual petals are magnetized along the length direction from the narrow end to the wide end. The inactive central part is 3D-printed using a commercial rigid resin using a Formlabs Form2 3D printer (Formlabs, Somerville, Mass., USA). The petals are positioned with the acrylic mold and glued to the central part.

Sequential Logic Circuit Experiments

The beams used as the switches in the sequential logic circuits have the dimension of 20 mm long and 5 mm wide. Each beam is fixed at one end to the printed circuit. Small discs of M-SMPs are punched and glued to the bottom side of the free ends to improve the contact between the beams and the printed circuit. Silver paste (Dupont ME603) is uniformly painted on the bottom surface of the beams and cured at 80° C. for 20 min. The LED leads, the fixed end of beams, and the copper wires for connecting the power supply are all attached to the printed circuit using the silver paste. Finally, the assembled circuit is cured at 80° C. for another 20 min.

Single Cantilever-Based Antenna Experiments

The M-SMP film is cut into a strip with a length of 50 mm and width of 10 mm. The designed silver wire part has a width of 6 mm and a length of 50 mm. Silver paste is painted on one side of the strip and cured at 80° C. for 20 min. One end of the cantilever-based antenna sample is glued to a 3D-printed PLA base. For the Type 1 antenna, the magnetization is along the length direction. For the Type 2 antenna, the strip is heated until soft, folded along the dividing lines of magnetic domains, and then remagnetized along the length direction.

Helical Antenna Experiments

The helical antenna is fabricated with a 3D-printed PVA mold using an Ultimaker S5. The mold is filled with the M-SMP resin mixture and sandwiched between two glass slides for thermal curing. The curing reaction is conducted by precuring at 80° C. for 4 h and post-treatment at 120° C. for 0.5 h. The PVA mold is then dissolved using water. The cured sample is then heated until soft, deformed to the shape as shown in FIG. 27, and magnetized along the height direction.

Antenna Simulation and Measurements

The antenna is transformed to the expected actuated shape and is fed by a 50Ω coaxial probe. The antenna's return loss (Si′) is measured using a Vector Network Analyzer (VNA). In all experiments, the antenna is connected to a 50Ω SMA connector on a 300 mm by 300 mm aluminum ground plane. After achieving the desired antenna shape using Bₕ and Bₐ, the feed pin of the SMA connector is connected to the conductive silver lines on the antenna, exciting the antenna for measurements. The bandwidths of interest during the measurement are from 0.5 GHz to 2 GHz for Type 1 and 2 antennas and 2 GHz to 4 GHz for the helical antenna. All antenna simulations are conducted using ANSYS Electromagnetic Suite V19.10 HFSS.

Supplementary Methods

Fourier transform infrared (FTIR) spectra are recorded on a Nicolet iS50 spectrometer (Thermo Fisher Scientific, Waltham, Mass., USA) by averaging 32 scans of the signal at a resolution of 2 cm⁻¹ in the attenuated total reflectance mode.

Shape memory tests are conducted in a “Control Force” mode on a dynamic mechanical analysis (DMA) tester (model Q800, TA Instruments, Inc., New Castle, Del., USA). Shape fixity and recovery are calculated as follows:

$${R}_{f} = \frac{{ε}^{*}}{{ε}_{load}} \times 100 \% , \qquad ( S1 )$$

$${R}_{r} = \frac{{ε}^{*} - {ε}_{rec}}{{ε}^{*}} \times 100 \% , \qquad ( S2 )$$

where ε_{load} is the maximum applied strain at high temperature, ε* is the fixed strain after cooling and stress removal, and ε_{rec} is the recovered strain.

Scanning Electron Microscopy (SEM) images are obtained by a Hitachi SU8010 SEM (Hitachi Ltd, Chiyoda, Tokyo, Japan) with a working distance of 6-8 mm and a voltage of 5 kV.

High-frequency hysteresis loops are measured to estimate the inductive heating power of the Fe₃O₄ particles within different high-frequency magnetic fields. The measurement setup⁵¹ consists of a measurement coil system placed in the center of the solenoid, which generates a 60 kHz magnetic field. The schematic of the setup is shown in FIG. 18A. The voltages of e₁(t) and e₂(t) are measured using an oscilloscope (EDUX1002A, Keysight Technologies, Inc., Santa Rosa, Calif., USA). The magnetic flux density B(t) and magnetic moment density M(t) can be integrated using the following equations:

$$B ( t ) = \frac{\int {e}_{1} ( t ) d t}{n {S}_{coil}} , \qquad ( S3 )$$

$$M ( t ) = \frac{\int {e}_{2} ( t ) d t}{{μ}_{0} n {φ}_{m} {S}_{m}} , \qquad ( S4 )$$

where n is the number of turns, S_{coil} is the cross-sectional area of the measurement coil, μ₀ is the permeability of vacuum, φₘ is the volume fraction of the M-SMP sample, and Sₘ is the area of the section perpendicular to the direction of the high-frequency magnetic field. In our measurement system, n, S_{coil}, and Sₘ are 5, 314.16 mm², and 100 mm², respectively. The hysteresis loops of M-SMPs with different Fe₃O₄ loadings under different magnetic strengths are obtained and plotted in FIGS. 18B & 18C.

For the Fe₃O₄ particles used in this paper, the inductive heating power mainly comes from the hysteresis loss⁵². The power density p can be calculated from the loop area and the frequency f of the magnetic field by the following equation:

p=f·∫MdB. (S5)

Recall that M is the magnetic moment density of the M-SMP, and B is the applied magnetic flux density. The calculated heating power density for M-SMPs with different Fe₃O₄ loadings under different magnetic field strengths are shown in FIG. 18D. The inductive heating power increases with increasing magnetic field strength and Fe₃O₄ loading.

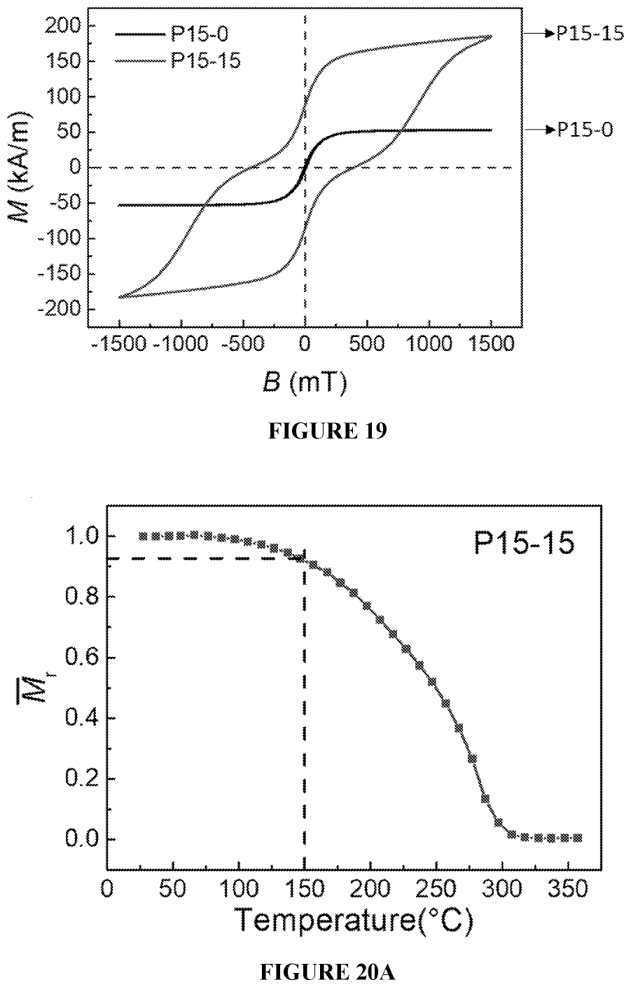

Static magnetization characterizations are performed on a Vibrating Sample Magnetometer (VSM, 7400A series, Lake Shore Cryotronics, Inc., Chicago, Ill., USA). The static magnetization curve of the M-SMP shown in FIG. 19 is measured at room temperature. The external magnetic flux density (B) is from −1.5 T to 1.5 T with a stepwise increase at 0.1 T/step. The measured magnetic moment is divided by the sample's volume to obtain the remnant magnetic moment density (Mᵣ). To measure the M-SMP's magnetization as a function of temperature (FIG. 20), the sample is first placed in the chamber of the VSM and is magnetized under a magnetic field of 1.5 T at 25° C. The magnetic moment is then measured every 10° C. as the temperature in the chamber gradually increases to 355° C. at a heating rate of 5° C./min. The calculated Mᵣ is then divided by its initial value at 25° C. to obtain the normalized remnant magnetic moment density (M̅ᵣ̅).

### REFERENCES

1 Lendlein, A. & Kelch, S. Shape-memory polymers. Angew Chem Int Edit 41, 2034-2057 (2002).
2 Jeon, S.-J., Hauser, A. W. & Hayward, R. C. Shape-Morphing Materials from Stimuli-Responsive Hydrogel Hybrids. Accounts of Chemical Research 50, 161-169 (2017).
3 Liu, Y., Genzer, J. & Dickey, M. D. “2D or not 2D”: Shape-programming polymer sheets. Progress in Polymer Science 52, 79-106 (2016).
4 Jascha, U. S., Hortense Le, F., Paolo, E., André, R. S. & Andres, F. A. Programmable snapping composites with bio-inspired architecture. Bioinspiration & Biomimetics 12, 026012 (2017).
5 Erb, R. M., Sander, J. S., Grisch, R. & Studart, A. R. Self-shaping composites with programmable bioinspired microstructures. Nature communications 4, 1712 (2013).
6 Hu, W., Lum, G. Z., Mastrangeli, M. & Sitti, M. Small-scale soft-bodied robot with multimodal locomotion. Nature 554, 81 (2018).
7 Huang, H.-W., Sakar, M. S., Petruska, A. J., Pane, S. & Nelson, B. J. Soft micromachines with programmable motility and morphology. Nature Communications 7, 12263 (2016).
8 Yuan, J. et al. Shape memory nanocomposite fibers for untethered high-energy microengines. Science 365, 155-158 (2019).
9 Zhang, Y.-F. et al. Fast-Response, Stiffness-Tunable Soft Actuator by Hybrid Multimaterial 3D Printing. Advanced Functional Materials 29, 1806698 (2019).
10 Felton, S., Tolley, M., Demaine, E., Rus, D. & Wood, R. A method for building self-folding machines. Science 345, 644-646 (2014).
11 Faber, J. A., Arrieta, A. F. & Studart, A. R. Bioinspired spring origami. Science 359, 1386-1391 (2018).
12 Qin, J. et al. Injectable superparamagnetic ferrogels for controlled release of hydrophobic drugs. Advanced Materials 21, 1354-1357 (2009).
13 Kobayashi, K., Yoon, C., Oh, S. H., Pagaduan, J. V. & Gracias, D. H. Biodegradable thermomagnetically responsive soft untethered grippers. ACS applied materials & interfaces 11, 151-159 (2018).
14 Hosseinidoust, Z. et al. Bioengineered and biohybrid bacteria-based systems for drug delivery. Advanced drug delivery reviews 106, 27-44 (2016).
15 Mostaghaci, B., Yasa, O., Zhuang, J. & Sitti, M. Bioadhesive bacterial microswimmers for targeted drug delivery in the urinary and gastrointestinal tracts. Advanced Science 4, 1700058 (2017).
16 Ware, T. H., McConney, M. E., Wie, J. J., Tondiglia, V. P. & White, T. J. Voxelated liquid crystal elastomers. Science 347, 982-984 (2015).
17 Donovan, B. R., Matavulj, V. M., Ahn, S.-k., Guin, T. & White, T. J. All-Optical Control of Shape. Advanced Materials 31, 1805750 (2019).
18 Sydney Gladman, A., Matsumoto, E. A., Nuzzo, R. G., Mahadevan, L. & Lewis, J. A. Biomimetic 4D printing. Nat Mater 15, 413-418 (2016).
19 Kim, Y., Yuk, H., Zhao, R., Chester, S. A. & Zhao, X. Printing ferromagnetic domains for untethered fast-transforming soft materials. Nature 558, 274-279 (2018).
20 Xie, T. Tunable polymer multi-shape memory effect. Nature 464, 267-270 (2010).
21 Hu, J. L., Zhu, Y., Huang, H. H. & Lu, J. Recent advances in shape-memory polymers: Structure, mechanism, functionality, modeling and applications. Progress in Polymer Science 37, 1720-1763 (2012).
22 Meng, H. & Li, G. Q. A review of stimuli-responsive shape memory polymer composites. Polymer 54, 2199-2221 (2013).
23 Kim, J. et al. Programming magnetic anisotropy in polymeric microactuators. Nature Materials 10, 747 (2011).
24 Nguyen, V. Q., Ahmed, A. S. & Ramanujan, R. V. Morphing soft magnetic composites. Advanced Materials 24, 4041-4054 (2012).
25 Liu, J. A.-C., Gillen, J. H., Mishra, S. R., Evans, B. A. & Tracy, J. B. Photothermally and magnetically controlled reconfiguration of polymer composites for soft robotics. Science Advances 5, eaaw2897 (2019).
26 Jackson, J. A. et al. Field responsive mechanical metamaterials. Science Advances 4, doi:ARTN eaau6419 10.1126/sciadv.aau6419 (2018).
27 Lum, G. Z. et al. Shape-programmable magnetic soft matter. Proceedings of the National Academy of Sciences 113, E6007-E6015 (2016).
28 Zhao, R., Kim, Y., Chester, S. A., Sharma, P. & Zhao, X. Mechanics of hard-magnetic soft materials. Journal of the Mechanics and Physics of Solids 124, 244-263 (2019).
29 Xu, T., Zhang, J., Salehizadeh, M., Onaizah, O. & Diller, E. Millimeter-scale flexible robots with programmable three-dimensional magnetization and motions. Science Robotics 4, eaav4494 (2019).
30 Wallin, T., Pikul, J. & Shepherd, R. 3D printing of soft robotic systems. Nature Reviews Materials 3, 84 (2018).
31 Shintake, J., Cacucciolo, V., Floreano, D. & Shea, H. Soft Robotic Grippers. Advanced Materials 30, doi:ARTN 1707035 10.1002/adma.201707035 (2018).
32 Al-Dahleh, R., Shafai, C. & Shafai, L. Frequency-agile microstrip patch antenna using a reconfigurable mems ground plane. Microwave and optical technology letters 43, 64-67 (2004).
33 Fu, H. et al. Morphable 3D mesostructures and microelectronic devices by multistable buckling mechanics. Nature materials 17, 268 (2018).
34 Zhao, Q., Qi, H. J. & Xie, T. Recent progress in shape memory polymer: New behavior, enabling materials, and mechanistic understanding. Progress in Polymer Science 49-50, 79-120 (2015).
35 Lendlein, A. & Gould, O. E. C. Reprogrammable recovery and actuation behaviour of shape-memory polymers. Nature Reviews Materials (2019).
36 Kumar, U. N., Kratz, K., Heuchel, M., Behl, M. & Lendlein, A. Shape-Memory Nanocomposites with Magnetically Adjustable Apparent Switching Temperatures. Advanced Materials 23, 4157-4162 (2011).
37 Wang, L. et al. Reprogrammable, magnetically controlled polymeric nanocomposite actuators. Materials Horizons 5, 861-867 (2018).
38 Liu, Y., Shaw, B., Dickey, M. D. & Genzer, J. Sequential self-folding of polymer sheets. Science Advances 3, e1602417 (2017).
39 Polygerinos, P. et al. Soft robotics: Review of fluid-driven intrinsically soft devices; manufacturing, sensing, control, and applications in human-robot interaction. Advanced Engineering Materials 19, 1700016 (2017).
40 Treml, B. E. et al. Autonomous motility of polymer films. Advanced Materials 30, 1705616 (2018).
41 Nakajima, K., Hauser, H., Li, T. & Pfeifer, R. Exploiting the dynamics of soft materials for machine learning. Soft robotics 5, 339-347 (2018).
42 Devaraju, N. S. G. K. & Unger, M. A. Pressure driven digital logic in PDMS based microfluidic devices fabricated by multilayer soft lithography. Lab on a Chip 12, 4809-4815 (2012).
44 Treml, B., Gillman, A., Buskohl, P. & Vaia, R. Origami mechanologic. P Natl Acad Sci USA 115, 6916-6921 (2018).
44 Preston, D. J. et al. Digital logic for soft devices. Proceedings of the National Academy of Sciences 116, 7750-7759 (2019).
45 Yao, S., Liu, X., Gibson, J. & Georgakopoulos, S. V. in 2015 IEEE International Symposium on Antennas and Propagation & USNC/URSI National Radio Science Meeting. 2215-2216 (IEEE).
46 Costantine, J., Tawk, Y., Christodoulou, C. G., Banik, J. & Lane, S. CubeSat deployable antenna using bistable composite tape-springs. IEEE Antennas and Wireless Propagation Letters 11, 285-288 (2012).
47 Kovitz, J. M., Rajagopalan, H. & Rahmat-Samii, Y. Design and implementation of broadband MEMS RHCP/LHCP reconfigurable arrays using rotated E-shaped patch elements. IEEE Transactions on Antennas and Propagation 63, 2497-2507 (2015).
48 Oliveri, G., Werner, D. H. & Massa, A. Reconfigurable electromagnetics through metamaterials—A review. Proceedings of the IEEE 103, 1034-1056 (2015).
49 Bernhard, J. T. Reconfigurable antennas. Synthesis lectures on antennas 2, 1-66 (2007).
50 Langer, J.-C., Zou, J., Liu, C. & Bernhard, J. T. Micromachined reconfigurable out-of-plane microstrip patch antenna using plastic deformation magnetic actuation. IEEE Microwave and Wireless Components Letters 13, 120-122 (2003).
51. Connord, V., Mehdaoui, B., Tan, R., Carrey, J. & Respaud, M. An air-cooled Litz wire coil for measuring the high frequency hysteresis loops of magnetic samples—A useful setup for magnetic hyperthermia applications. Review of Scientific Instruments 85, 093904 (2014).
52. Razzaq, M. Y., Anhalt, M., Frormann, L. & Weidenfeller, B. Thermal, electrical and magnetic studies of magnetite filled polyurethane shape memory polymers. Materials Science and Engineering: A 444, 227-235 (2007).

### Example 4: Magnetic Multi-Material Printing for Multimodal Shape Transformation with Tunable Properties

Introduction

Programmable shape-changing soft materials in response to stimuli including heat¹, light, and electric³ or magnetic fields⁴ have drawn special interest in the developments of soft robotics^{5 6 7}, actuators^{8 9}, metamaterials^{10 11}, and biomedical devices^{12 13 14}. Among a variety of emerging stimuli-responsive soft materials, magnetic soft materials (MSMs) composed of magnetic particles and elastomeric matrices show great application potentials due to their capabilities of untethered, fast, and reversible shape reconfigurations as well as the controllable dynamic motions under the applied magnetic field^{5 15 16 17}. Through programmable magnetization of the MSMs, internal torque is generated under the applied magnetic field, which leads to complex shape transformations. When incorporating with developed three-dimensional (3D) printing techniques, predesigned magnetization distribution can be assigned into the soft structures within complex geometries, leading to functional shape configurations under the magnetic field^{18 19}. To further enhance the materials' functionalities, magnetic shape memory polymers (M-SMPs) embedded magnetic particles in shape memory polymers with remote-controlled actuation and shape locking capabilities are developed^{20 21 22 23}. Due to the temperature-dependent mechanical property, the Young's modulus of SMPs shifts three orders of magnitude between rubbery state and glassy state. When the temperature is higher than the glass transition temperature (T_{g}) of SMPs, the materials undergo fast and reversible actuation under the applied magnetic field, and when the temperature is lower than the T_{g}, the deformed shape can be locked, providing more design flexibility for soft robotics and configurable electronics.

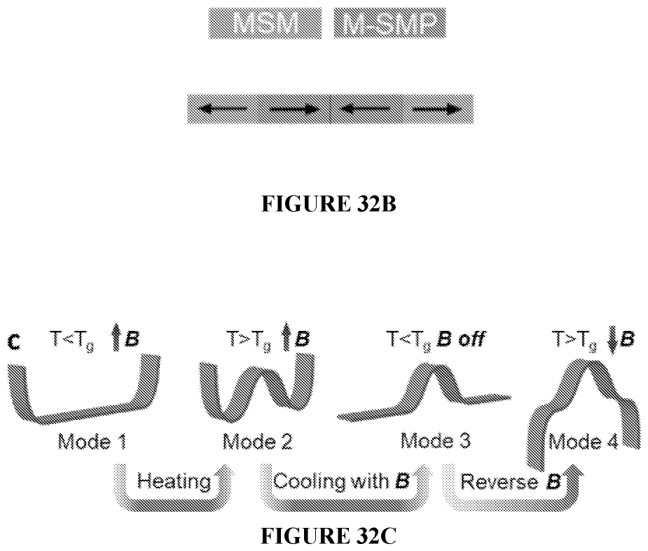

However, so far it is still an open issue on how to precisely fabricate M-SMP into delicate shapes for sophisticated functionalities. Furthermore, M-SMP alone may lack of immediate response for more versatile applications, while the bonding of different materials can be problematic. In the reported fabrication methods for stimuli-responsive soft materials, 3D printing is one of the most versatile due to its features of fast prototyping and multimaterial scalability. Inspired on a direct-ink-writing (DIW) technique for magnetic soft materials¹⁸, we propose a multi-magnetic-material DIW (M³DIW) combining M-SMP with magnetic soft materials (MSM) to enable multimodal actuations and tunable properties. Guided by finite-element (FE) simulations based on a recent theoretical research²⁴, the responses of the multi-magnetic-material structures can be predicted, allowing for the fabrication of structures with desired multimodal shape transformations with actively tunable mechanical properties. FIG. 32A schematically shows the M³DIW fabrication system and the main composition of the inks. Two types of magnetic composite inks M-SMP and MSM, which are composed of uncured polymeric matrices, magnetized neodymium-iron-boron (NdFeB) microparticles, and fumed silica nanoparticles as rheology modifier are loaded in the UV block syringes for multi-material structure printing. A LED panel emitting ultraviolet (UV) light at 385 nm wavelength is utilized for the curing process of the two resins. The photocurable resins are prepared by two combinations of monomers of 2-phenoxyethanol acrylate (PEA), isobornyl acrylate (IOA), and isodecyl acrylate (IA), crosslinker, and photoinitiator for distinct material properties, enabling flexible multi-material structure designs with temperature-dependent properties. After loading into syringes, the NdFeB particles embedded in the composite inks of M-SMP and MSM are magnetized by a 1.5 T impulsive field. During printing, the magnetized particles are reoriented to the direction of the printing nozzles by the printing magnetic field from the attached ring-shape permanent magnets, leading to a programmed magnetization along the printing direction of the extruded filaments. The printing magnetic field near the nozzle tip is measured as 130 mT. To protect the already printed structure from the influence of the printing magnetic field, a steel magnetic shield is added to mitigate the magnetic field. With the interference of the shield, the printing magnetic field near the nozzle tip is reduced to about 1 mT. The direction of the printing magnetic field and the magnetic polarities of the printed filament are shown in FIG. 32A.

By controlling the switching between the two syringes as well as the printing directions, both the material distribution and the magnetization directions can be programmed according to the needs with great design versatility. After curing the printed multi-material magnetic material systems by shedding the UV light, the modulus of M-SMP is orders-of-magnitude higher than MSM at room temperature. While heating above its T_{g}, the modulus of M-SMP significantly drops to the same magnitude of MSM. When actuated by an external magnetic field, the magnetized NdFeB particles exert micro-torques to deform the matrix so as to align their polarities with the direction of the external field. Therefore, the responses of a M-SMP/MSM structure can have at least two different modes when actuated by the same external magnetic field. Moreover, M-SMP can lock its deformed shape and regain high modulus by keeping the actuation field and cooling down below its T_{g}, providing more degrees of freedom for further tuning. This working mechanism can be demonstrated by a simple one-dimensional stripe of four segments. FIG. 32B shows the top view of its material distribution and magnetization directions. FIG. 32C shows four different actuation modes achieved by the joint efforts of temperature changing, shape locking, and magnetic field reversing. We can achieve mode 1 and mode 2 with the same upwards magnetic field B at different temperatures. Only MSM can be actuated by the external magnetic field at room temperature, while both M-SMP and MSM can be actuated at a higher temperature T>T_{g}. Starting from mode 2, mode 3 can be obtained by keeping the external magnetic field and cooling down to below T_{g} so that M-SMP can regain stiffness to lock its deformed shape, while MSM returns to the 2D shape after withdrawing the external magnetic field. Finally, applying an external field of opposite direction brings mode 4, in which MSM reverses its deformation to align with the external field, while M-SMP is stiff enough to withstand the torque. Note that another set of four vertically symmetric deformation modes can be easily obtained by reversing all the directions of external magnetic field in FIG. 32C.

Materials and Methods

Ink Formulation and Preparation. The initial liquid resins of M-SMP and MSM matrices are acrylate-based amorphous polymers with different composition. The neat M-SMP resin comprises of aliphatic urethane diacrylate (Ebecryl 8807, Allnex, Alpharetta, Ga.), 2-phenoxyethanol acrylate (Allnex), and isobornyl acrylate (Sigma-Aldrich, St. Louis, Mo., USA), with a weight ratio of 15:55:30. The neat MSM resin includes aliphatic urethane diacrylate (Ebecryl 8807, Allnex, Alpharetta, Ga.), 2-phenoxyethanol acrylate (Allnex), and isodecyl acrylate (Sigma-Aldrich), with a weight ratio of 10:80:10. Phenylbis (2,4,5-trimethylbenzoyl) phosphine oxide is added as the photoinitiator (1.5 wt % to the resin) to induce free radical polymerization for both M-SMP and MSM. The fumed silica nanoparticles (12 wt % to the resin for M-SMP, and 14 wt % for MSM) with an average size of 0.2-0.3 μm (Sigma-Aldrich) is added as a rheology modifier to increase the ink viscosity, achieving desired printability.

The initial liquid resin is first mixed with the fumed silica nanoparticle by a planetary mixer (AR-100, Thinky) at 2,000 rpm for 4 minutes, then is hand mixed to break the silica aggregates. After another 2 minutes of mixing at 2,000 rpm, sieved NdFeB microparticles (average size of 25 μm, MQFP-B-2007609-089, Magnequench) within the range from 30.8 μm to 43 μm and photoinitiator are added following by 4 minutes of mixing at 2,000 rpm. Then the ink is transferred into a 10 cc UV-block syringe barrel (7012126, Nordson EFD) and defoamed in the mixer at 2,200 rpm for 30 seconds to remove the trapped air. Finally, the ink is magnetized by a 1.5 T impulse magnetic field applied by an in-house built impulse magnetizer.

M³DIW Process.

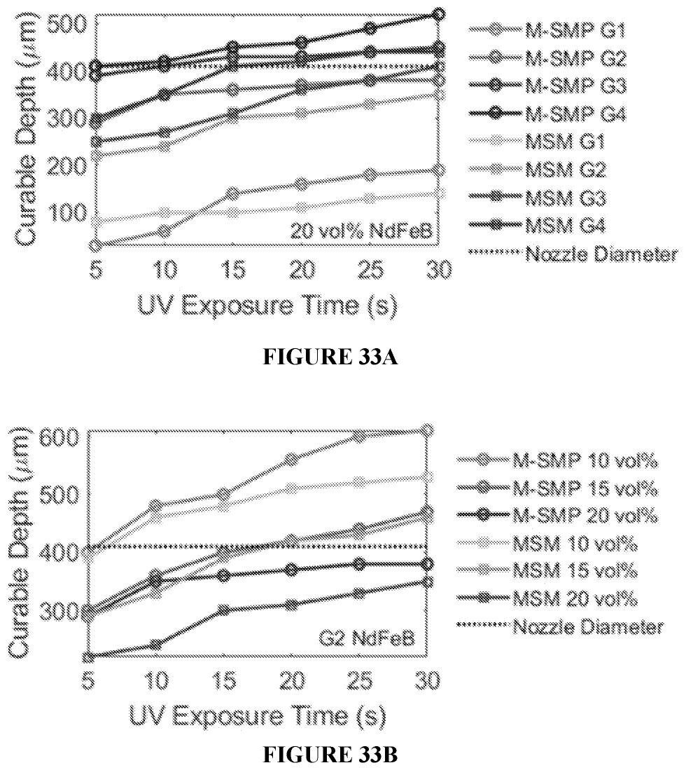

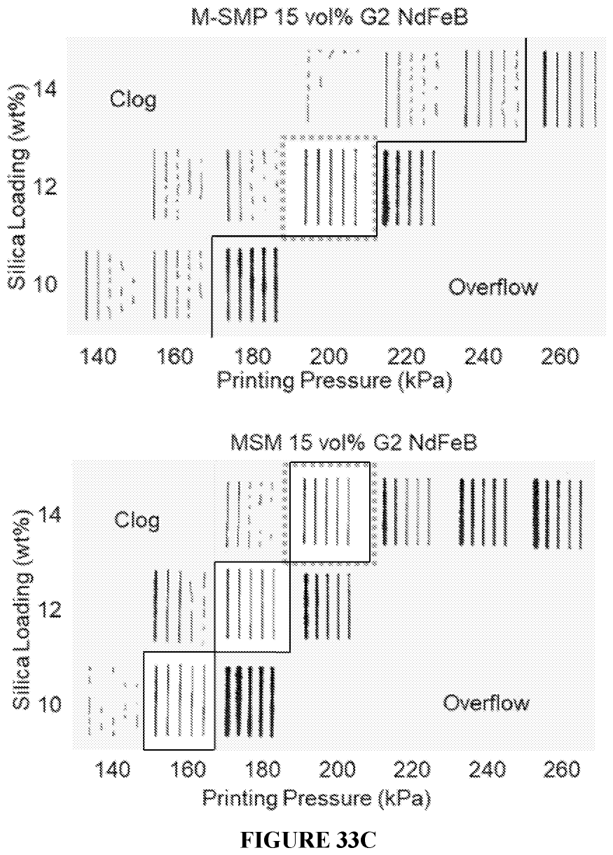

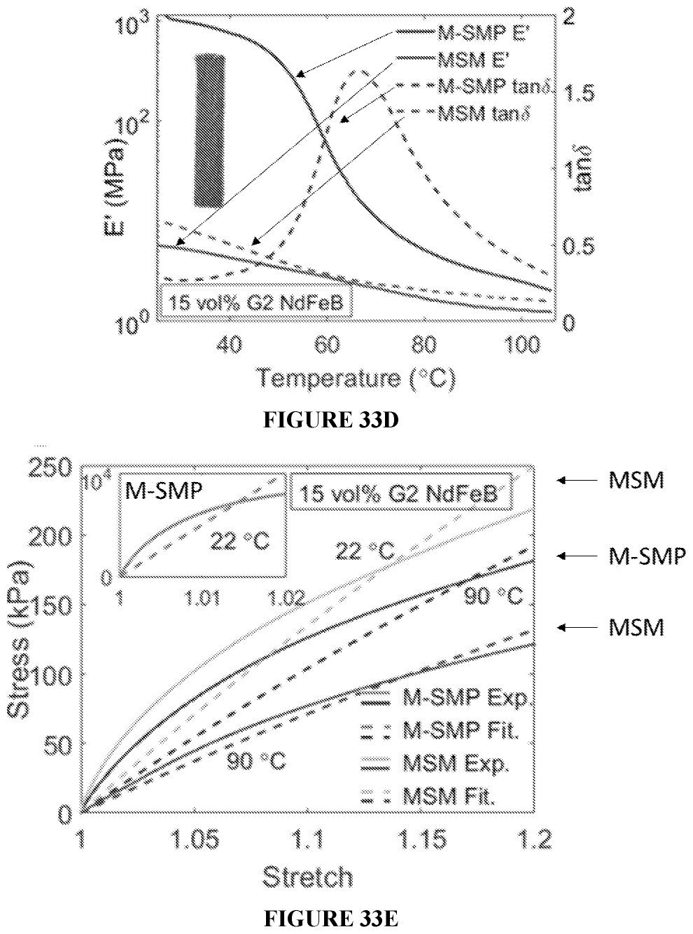

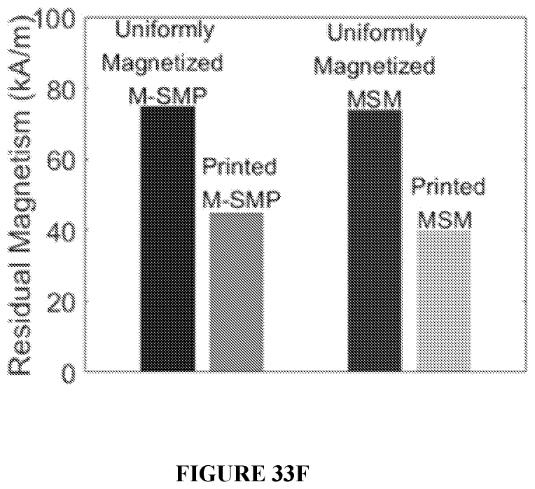

After installing the printing nozzles (7018298, SmoothFlow Tapered Tips, 410 μm inner diameter, Nordson EFD), the two syringe barrels loaded with magnetized M-SMP and MSM inks are mounted to a customized gantry 3D printer (Aerotech). Then the ring-shape NdFeB permanent magnet with a steel magnetic shields are attached to the nozzles. The air pressure to each syringe barrel is individually powered by a high precision dispenser (7012590, Ultimus V, Nordson EFD). The initial pressure is set according to the experiment results in FIG. 33C. Before printing, the relative position of the two syringe nozzles is calibrated to guarantee the accuracy. The printing process was controlled by the printing G-code generated by CADFusion (Aerotech). After printing, the printed structure is exposed to 385 nm UV LED for 30 seconds. The LED is also programmed to move around the printed structure to make sure that all parts are fully cured.

Results and Discussion

Ink Preparations. In M³DIW, the inks are extruded from nozzles of fixed diameter and cured by UV, thus there are two major ink properties influencing the process, i.e., the ink rheology and the curable depth. The former can be tuned by adjusting the loading of fumed silica nanoparticles which serves as a rheological modifier. The latter is mainly determined by the particle size and loading of the NdFeB microparticles as well as the UV exposure time, which are the first to be adjusted due to their fundamental influence.

To measure the curable depth of different inks, first we apply two glass slides separated by two spacers along the edges to squeeze a lump of ink sample into a pie shape with uniform thickness, then expose the sample to a UV LED with fixed power and distance for a period of time. After separating the glass slides and removing the uncured ink, take the slide that directly faces the UV and measure the total thickness of the slide and cured ink t_{S+C} and the thickness of the slide t_{S}, thus we have the curable depth t_{C}=t_{S+C}-t_{S}.

To obtain more choices of particle size, through a set of sieves with mesh sizes of 15 μm, 30.8 μm, 43 μm, 74 μm, and 150 μm, we separate the commercial NdFeB microparticles into 4 groups (G1, 15˜30.8 μm; G2, 30.8˜43 μm; G3, 43˜74 μm; and G4, 74˜150 μm). First, we test M-SMP and MSM inks made from each group of NdFeB at a fixed loading of 20 vol %. Here 10 wt % silica nanoparticles with respect to the composite resins are added in order to maintain the inks in a paste state. FIG. 33A shows the measured curable depth of each ink with different exposure time from 5 seconds to 30 seconds, showing that the curable depths of all inks increase with the particle size and the exposure time, and most of the inks converge to certain curable depths with 30-seconds UV exposure. Satisfying results should be larger than the diameter of the printing nozzle, which is 410 μm in this research as the black dash line depicts. However, larger particle size is more likely to clog the nozzle during printing, and the tendency that the magnetized particles gather to form larger clusters even intensifies the clogging. Therefore, though the curable depths of 20 vol % G2 with 30-seconds exposure are slightly smaller than the nozzle diameter, it is still worthy to reduce the particle loading in exchange for smoother printing process. FIG. 33B illustrates the effect of different particle loadings of G2 to the curable depth, indicating that both M-SMP and MSM using 15 vol % G2 NdFeB are satisfying with UV exposure time longer than 20 seconds. To guarantee the effect of curing, all printed specimens and structures were exposed to UV for 30 seconds.

Different combinations of silica nanoparticle loading, printing pressure, and the nozzle translation speed to obtain the optimal printability. Generally, a lower printing pressure results in a lower extrusion speed, providing the printing magnetic field with more time to align the NdFeB microparticles, yielding a larger magnetization. Therefore, the printing pressure should be as low as possible with the satisfaction of filament continuity. Similarly, a lower silica loading results in a less viscous ink, making it easier for the printing magnetic field to align the NdFeB microparticles, also yielding a larger magnetization. Thus, the silica loading should be as small as possible as long as the particle dispersion and the printed shape are stable throughout the printing process. Finally, with the printing pressure and silica loading being determined, the role of the nozzle translation speed is to control the thickness of the printed filaments.

Using the inks of M-SMP and MSM with fixed 15 vol % G2 NdFeB (referred as “M-SMP” and “MSM” in the following) and 10 wt %, 12 wt %, and 14 wt % silica to the resin, 30 mm long filaments were printed varying the nozzle translation speeds from 5 mm/s to 25 mm/s with a gap of 5 mm/s and the printing pressure from 140 kPa to 260 kPa with a gap of 20 kPa. The printing results are summarized in two phase diagrams as shown in FIG. 33C in which each grid contains five filaments printed at five different nozzle translation speeds increasing from left to right. It can be observed that higher silica loading and lower printing pressure tend to clog the nozzle, while the opposite operations tend to cause overflow, resulting in poor precision and magnetization. The optimal combination can be found in the transition region. For M-SMP, 12 wt % silica with 200 kPa pressure (highlighted by dash line box) is the best combination that shows no obvious accumulation nor discontinuity for all the nozzle translation speeds. Though a higher speed is advantageous for faster fabrication process, we choose 10 mm/s, because a lower nozzle translation speed helps to maintain the filament continuity and to fill the gaps between filaments. For MSM, though the combinations of 10 wt % and 160 kPa, 12 wt % and 180 kPa, and 14 wt % and 200 kPa seem to yield similar filament shapes, we often observe transparent filament segments in a droplet shape during printing of the MSM inks using 10 wt % and 12 wt % silica, indicating that the magnetized NdFeB microparticles in the ink might aggregate elsewhere and leave the resin alone. Thus, we choose MSM inks using 14 wt % silica for the following printing, and the nozzle translation speed is also chosen to be 10 mm/s due to the same reason for M-SMP ink.

The distance between the nozzle tip to the printing substrate is fixed to the nozzle inner diameter.

FIG. 33D shows the thermomechanical properties of M-SMP and MSM. With the temperature increasing from 22° C. to 105° C., the storage modulus of M-SMP significantly drops from 1.16 GPa to 2.02 MPa, while MSM only drops from 5.75 MPa to 1.24 MPa. The T_{g} of M-SMP is measured as 66° C. at which tan δ takes the maximum value. FIG. 33E shows the nominal stress versus stretch at 22° C. and 90° C. obtained from uniaxial tensile experiments using printed M-SMP and MSM specimens (solid lines) and from neo-Hookean fittings (dash lines). According to the fittings, the shear modulus of M-SMP at 22° C. and 90° C. are 180 MPa and 380 kPa, respectively, and those of MSM are 493 kPa and 261 kPa, respectively. Compared with the distinct difference in mechanical properties between M-SMP and MSM at 22° C., their difference at 90° C. is significantly smaller. Such features of M-SMP and MSM enable the design of multimodal actuation and tunable properties.

FIG. 33F shows the magnetic moment densities of M-SMP and MSM specimens. To evaluate the reorientation effectiveness of the printing magnetic field, we not only measure the printed specimens with the printing magnetic field, but also measure the specimens that are first printed without the printing magnetic field and then uniformly magnetized by a 1.5 T impulsive magnetic field.

With the above measurements, we can apply FE simulations to estimate the deformation of the structures and guide the designs before performing the printing.

Pop-Up Structures with Multimodal Actuation.

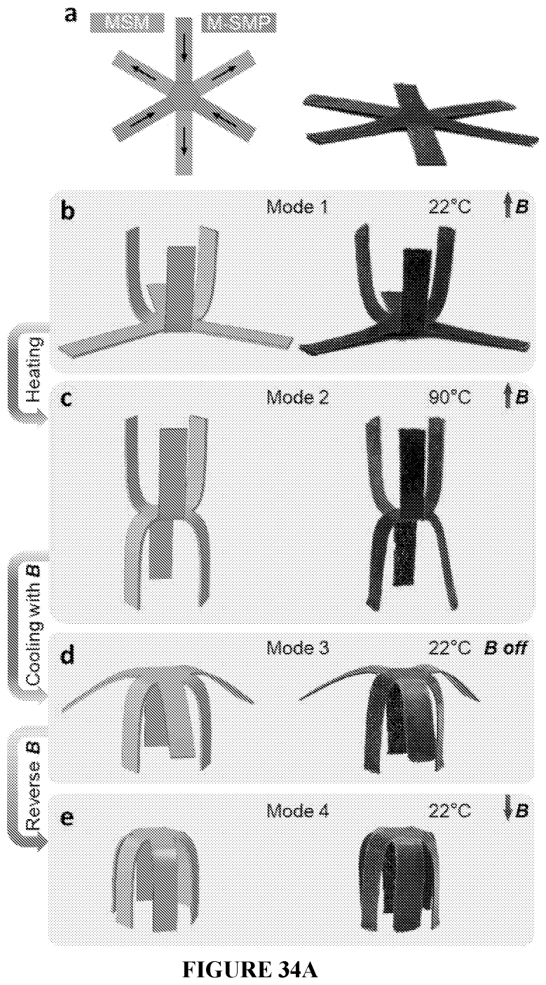

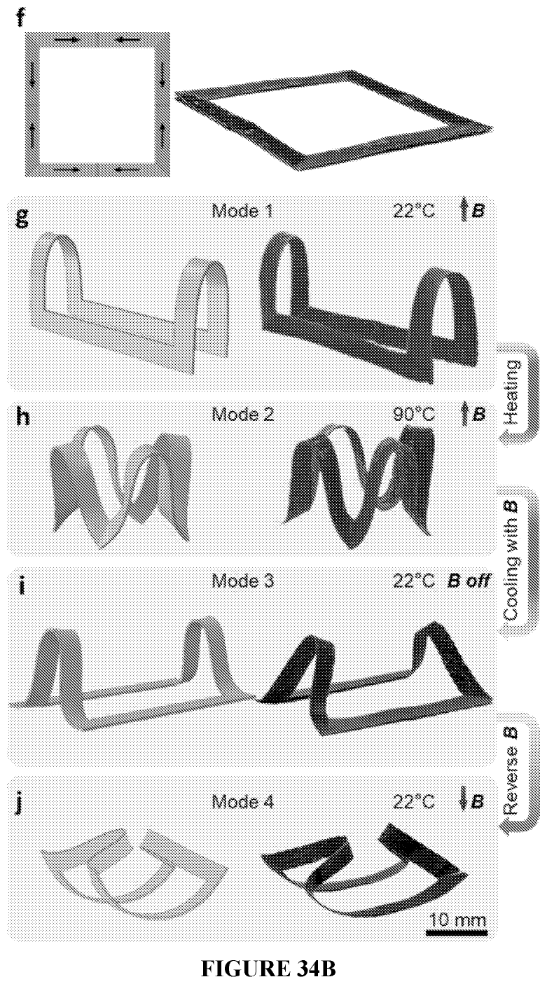

In FIG. 34A-34B, several two-dimensional designs are presented that can pop up to form different three-dimensional shapes by applying external magnetic field at different temperatures. For a M-SMP/MSM combined structure, MSM parts provide the actuation mode of instant response at room temperature. With a higher temperature, the whole structure can be actuated to deform globally, forming another actuation mode with more complex shape. Here, we apply a 70 mT external magnetic field for the actuation of all cases in FIG. 34A-34B except the FIG. 34B (j) in which is 5.6 mT and use an in-house electric hot plate to heat the structures. From one actuation mode to another, these designs show drastic shape morphing. The first two actuation modes can be directly obtained from the initial 2D shape. Under the same external magnetic field, the asterisk design can double its maximum elongation along the actuation direction at 90° C. (FIG. 34A (c) than that at 22° C. (FIG. 34A (b)), and the square frame design can shift from two-fold to four-fold when increasing from 22° C. (FIG. 34B (g) to 90° C. (FIG. 34B (h).

Beyond the two direct actuation modes above, we further exploit the shape locking effect of M-SMP to induce more actuation modes. Starting from mode 2 of global deformation, we stop heating while keeping the magnetic field until the structure cools down, thus the M-SMP parts can lock their deformed shapes even when the magnetic field is removed as shown in FIG. 34A (d) and FIG. 34B (i). Finally, we apply a downward magnetic field to bend MSM to the opposite direction and achieve mode 4 which partially combines the features of the first two actuation modes.

Comparing the deformed shapes obtained from the experiments and simulations, our FE models show good agreements and can be used to guide the designs of more sophisticated structures.

Active Metamaterials with Tunable Properties.

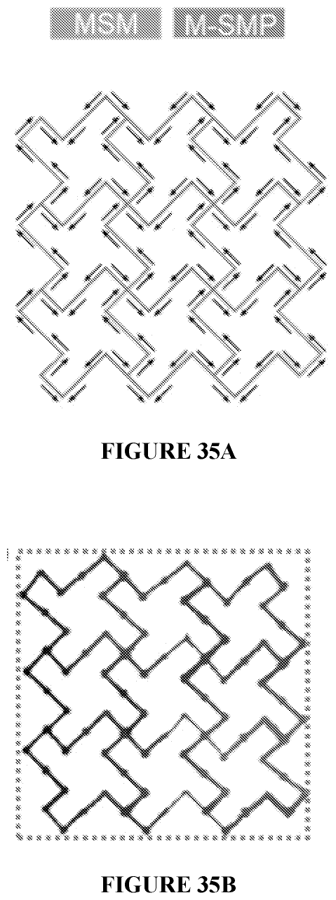

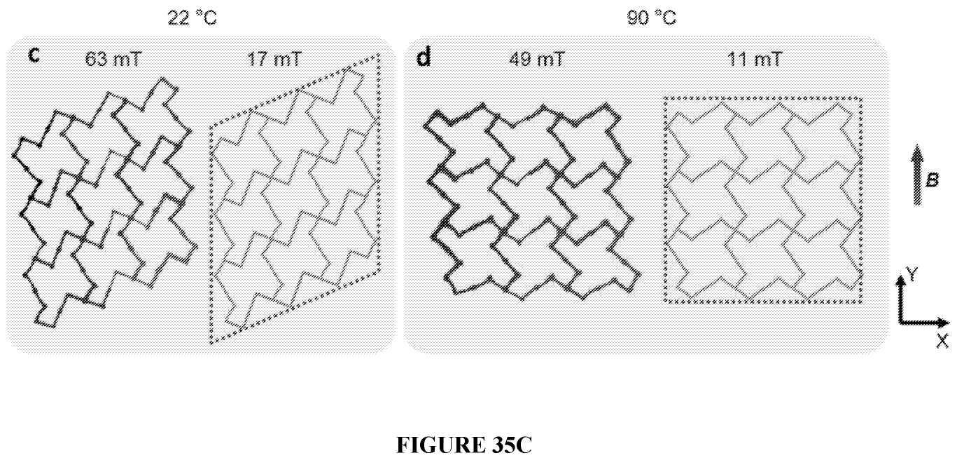

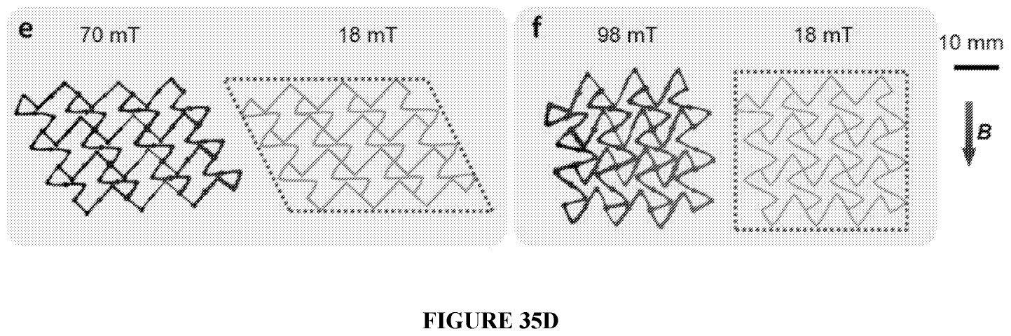

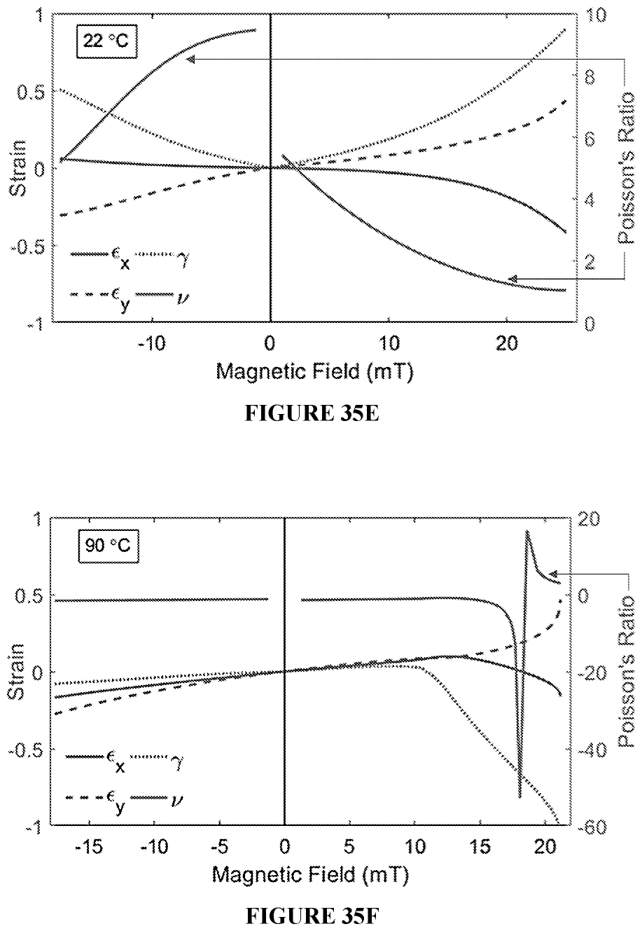

Due to the well-tuned rheological properties of the inks, a certain number of printed filaments can be directly stacked up and stand on their own without extra supporting structures, enabling the fast 3D printing of multilayered structures with more complex deformation. In this section, we present a chiral design of multi-magnetic-material active metamaterial with sign change of Poisson's ratio and tunable shear strain as shown in FIG. 35A-35F. The printed structure is formed by five layers of stacked filaments, and the thickness of each layer equals to the diameter of the printing nozzle. To prevent out-of-plane bending in the experiments, we cover a supported acrylic thin plate above the active metamaterial. At 22° C., the chiral design shows positive Poisson's ratio and positive shear strain under vertical expansion and vertical contraction. The external magnetic field for the expansion and contraction at 22° C. are 63 mT and 70 mT, respectively. In these cases, the metamaterial can be deemed as a set of parallel rigid bars connected by a set of parallel soft springs. While at 90° C., it shows negative Poisson's ratio for both expansion and contraction, and the shear deformation is almost ignorable. The external magnetic field for the expansion and contraction at 90° C. are 49 mT and 98 mT, respectively.

Conclusions

In summary, the reported M³DIW technique enables the integrated 3D printing of M-SMP and MSM. The working mechanism and the multi-functionalities of M-SMP/MSM integrated structures are demonstrated through a series of pop-up designs for multimodal actuation, and two active metamaterial designs with tunable properties including sign change of Poisson's ratio and shear strain integrated in a single initial geometry. While this paper involves only two inks, it is easy to incorporate additional types of functional inks into the current printing system for more sophisticated structures. M³DIW can be envision to be a basic platform for the advanced fabrications of programmable materials, deployable structures, and biomedical devices.

### REFERENCES

1. Ge, Q. et al. Multimaterial 4D Printing with Tailorable Shape Memory Polymers. Sci. Rep. 6, 31110 (2016).
2. Donovan, B. R., Matavulj, V. M., Ahn, S., Guin, T. & White, T. J. All-Optical Control of Shape. Adv. Mater. 31, 1805750 (2019).
3. Ahn, J. et al. Heterogeneous Conductance-Based Locally Shape-Morphable Soft Electrothermal Actuator. Adv. Mater. Technol. 5, 1900997 (2020).
4. Cui, J. et al. Nanomagnetic encoding of shape-morphing micromachines. Nature 575, 164-168 (2019).
5. Hu, W., Lum, G. Z., Mastrangeli, M. & Sitti, M. Small-scale soft-bodied robot with multimodal locomotion. Nature 554, 81-85 (2018).
6. Schaffner, M. et al. 3D printing of robotic soft actuators with programmable bioinspired architectures. Nat. Commun. 9, 878 (2018).
7. Wu, S. et al. Evolutionary Algorithm-Guided Voxel-Encoding Printing of Functional Hard-Magnetic Soft Active Materials. Adv. Intell. Syst. n/a, 2000060.
8. Sundaram, S., Skouras, M., Kim, D. S., van den Heuvel, L. & Matusik, W. Topology optimization and 3D printing of multimaterial magnetic actuators and displays. Sci. Adv. 5, (2019).
9. Zhang, Y.-F. et al. Fast-Response, Stiffness-Tunable Soft Actuator by Hybrid Multimaterial 3D Printing. Adv. Funct. Mater. 29, 1806698 (2019).
10. Zhang, H., Guo, X., Wu, J., Fang, D. & Zhang, Y. Soft mechanical metamaterials with unusual swelling behavior and tunable stress-strain curves. Sci. Adv. 4, eaar8535 (2018).
11. Wu, S. et al. Symmetry-Breaking Actuation Mechanism for Soft Robotics and Active Metamaterials. ACS Appl. Mater. Interfaces 11, 41649-41658 (2019).
12. Kim, Y, Parada, G. A., Liu, S. & Zhao, X. Ferromagnetic soft continuum robots. Sci. Robot. 4, eaax7329 (2019).
13. Yim, S. & Sitti, M. Design and Rolling Locomotion of a Magnetically Actuated Soft Capsule Endoscope. IEEE Trans. Robot. 28, 183-194 (2012).
14. Jeon, S. et al. A Magnetically Controlled Soft Microrobot Steering a Guidewire in a Three-Dimensional Phantom Vascular Network. Soft Robot. 6, 54-68 (2019).
15. Huang, H.-W., Sakar, M. S., Petruska, A. J., Pane, S. & Nelson, B. J. Soft micromachines with programmable motility and morphology. Nat. Commun. 7, 12263 (2016).
16. Kim, J. et al. Programming magnetic anisotropy in polymeric microactuators. Nat. Mater. 10, 747-752 (2011).
17. Ren, Z., Hu, W., Dong, X. & Sitti, M. Multi-functional soft-bodied jellyfish-like swimming. Nat. Commun. 10, 2703 (2019).
18. Kim, Y., Yuk, H., Zhao, R., Chester, S. A. & Zhao, X. Printing ferromagnetic domains for untethered fast-transforming soft materials. Nature 558, 274-279 (2018).
19. Xu, T., Zhang, J., Salehizadeh, M., Onaizah, O. & Diller, E. Millimeter-scale flexible robots with programmable three-dimensional magnetization and motions. Sci. Robot. 4, eaav4494 (2019).
20. Ze, Q. et al. Magnetic Shape Memory Polymers with Integrated Multifunctional Shape Manipulation. Adv. Mater. 32, 1906657 (2020).
21. Liu, J. A.-C., Gillen, J. H., Mishra, S. R., Evans, B. A. & Tracy, J. B. Photothermally and magnetically controlled reconfiguration of polymer composites for soft robotics. Sci. Adv. 5, eaaw2897 (2019).
22. Wang, L. et al. Reprogrammable, magnetically controlled polymeric nanocomposite actuators. Mater. Horiz. 5, 861-867 (2018).
23. He, Z., Satarkar, N., Xie, T., Cheng, Y.-T. & Hilt, J. Z. Remote Controlled Multishape Polymer Nanocomposites with Selective Radiofrequency Actuations. Adv. Mater. 23, 3192-3196 (2011).
24. Zhao, R., Kim, Y., Chester, S. A., Sharma, P. & Zhao, X. Mechanics of hard-magnetic soft materials. J. Mech. Phys. Solids 124, 244-263 (2019).

What is claimed is:

1. A magnetic shape-memory composition comprising a shape memory polymer matrix and a population of hard-magnetic particles dispersed within the polymer matrix.

2. The composition of claim 1, wherein the polymer matrix comprises a biocompatible polymer or blend of biocompatible polymers.

3. The composition of any of claims 1-2, wherein the polymer matrix comprises a polymer or blend of polymers having a Tg of at least 25° C., such as a Tg of from 25° C. to 100° C., a Tg of from 30° C. to 100° C., a Tg of from 30° C. to 80° C., a Tg of from 38° C. to 100° C., a Tg of from 38° C. to 80° C., a Tg of from 40° C. to 100° C., a Tg of from 40° C. to 80° C., a Tg of from 50° C. to 100° C., or a Tg of from 50° C. to 80° C.

4. The composition of any of claims 1-3, wherein the polymer matrix exhibits a Young's modulus of from 10 kPa to 20 MPa (e.g., from 10 kPa to 10 MPa, from 10 kPa to 5 MPa, from 10 kPa to 1 MPa, from 1 MPa to 5 MPa, from 1 MPa to 10 MPa, from 1 MPa to 20 MPa, from 10 kPa to 800 kPa, from 10 kPa to 600 kPa, from 10 kPa to 500 kPa, from 50 kPa to 800 kPa, from 100 kPa to 800 kPa, from 200 kPa to 800 kPa, from 50 kPa to 600 kPa, from 100 kPa to 600 kPa, from 200 kPa to 600 kPa, from 50 kPa to 500 kPa, from 100 kPa to 500 kPa, or from 200 kPa to 500 kPa) when heated to a temperature at or above the Tg of the polymer or blend of polymers (e.g., a temperature equal to the Tg of the polymer or blend of polymers, a temperature equal to 5° C. above the Tg of the polymer or blend of polymers, a temperature equal to 10° C. above the Tg of the polymer or blend of polymers, a temperature equal to 20° C. above the Tg of the polymer or blend of polymers, or a temperature equal to 30° C. above the Tg of the polymer or blend of polymers).

5. The composition of any of claims 1-4, wherein the polymer matrix exhibits a Young's modulus of at least 0.1 GPa (e.g., at least 0.5 GPa, at least 1.0 GPa, at least 1.5 GPa, at least 2.0 GPa, at least 2.5 GPa, at least 3 GPa, at least 3.5 GPa, or at least 4 GPa) at 25° C.

6. The composition of any of claims 1-5, wherein the polymer matrix exhibits a Young's modulus of at least 0.1 GPa (e.g., at least 0.5 GPa, at least 1.0 GPa, at least 1.5 GPa, at least 2.0 GPa, at least 2.5 GPa, at least 3 GPa, at least 3.5 GPa, or at least 4 GPa) at 45° C.

7. The composition of any of claims 1-6, wherein the polymer matrix comprises a thermoplastic polymer or a thermoset.

8. The composition of any of claims 1-7, wherein the polymer matrix comprises a crosslinked epoxy resin, a crosslinked polyacrylate resin, or a crosslinked polyester-polyether.

9. The composition of claim 8, wherein the epoxy resin is derived from the reaction of bisphenol A and epichlorohydrin.

10. The composition of claim 8, wherein the crosslinked polyacrylate resin is derived from acrylate oligomers, cross-linked polyesters multifunctional acid/ester and alcohol, and cross-linked polyethers derived from ethylene oxide.

11. The composition of claim 8, wherein the crosslinked polyester-polyether comprises a polyester (e.g., polycaprolactone, polylactic acid, polyglycolic acid, a polyhydroxyalkanoate, and copolymers thereof), a polyether (e.g., a polyalkylene oxides such as polyethylene glycol, polypropylene oxide, polybutylene oxide, and copolymers thereof), a blend thereof, or a copolymer thereof.

12. The composition of any of claims 1-11, wherein the polymer matrix is elastomeric.

13. The composition of any of claims 1-12, wherein the hard-magnetic particles are present in the polymer matrix at a concentration ranging from 0.1% v/v to 60% v/v hard-magnetic particles, such as from 0.1% v/v to 50% v/v hard-magnetic particles, from 1% v/v to 50% v/v hard-magnetic particles, from 5% v/v to 50% v/v hard-magnetic particles, from 5% v/v to 60% v/v hard-magnetic particles, from 1% v/v to 60% v/v hard-magnetic particles, from 10% v/v to 60% v/v hard-magnetic particles, from 10% v/v to 50% v/v hard-magnetic particles, from 5% v/v to 30% v/v hard-magnetic particles, from 10% v/v to 30% v/v hard-magnetic particles, from 5% v/v to 25% v/v hard-magnetic particles, or from 10% v/v to 25% v/v hard-magnetic particles.

14. The composition of any of claims 1-13, wherein the population of hard-magnetic particles has an average particle size of from 1 nm to 1 mm (e.g., from 1 micron to 50 microns).

15. The composition of any of claims 1-14, wherein the hard-magnetic particles are formed from a rare earth-transition metal-metalloid.

16. The composition of claim 15, wherein the rare earth-transition metal-metalloid magnetic material comprises 10 atomic percent to 15 atomic percent rare earth, 70 atomic percent to 85 atomic percent transition metal, and 5 atomic percent to 10 atomic percent metalloid.

17. The composition of any of claims 15-16, wherein the hard-magnetic particles are formed from a rare earth-transition metal-boron magnetic material.

18. The composition of any of claims 15-17, wherein the hard-magnetic particles comprise NdFeB particles.

19. The composition of any of claims 1-14, wherein the hard-magnetic particles are formed from a hexagonal ferrite.

20. The composition of claim 19, wherein the hexagonal ferrite is defined by the formula AFe₁₂O₁₉, wherein A represents an element selected from the group consisting of Bₐ, Sr, Pb, Ca, and combinations thereof.

21. The composition of any of claims 1-14, wherein the hard-magnetic particles are formed from metal alloy.

22. The composition of any of claims 1-21, wherein the composition further comprises a population of auxiliary magnetic particles dispersed within the polymer matrix.

23. The composition of claim 22, wherein the auxiliary magnetic particles comprise soft magnetic particles.

24. The composition of any one of claim 22 or claim 23, wherein the auxiliary magnetic particles comprise a second population of hard-magnetic particles.

25. The composition of claim 24, wherein the first population of hard-magnetic particles have a higher coercive force than the auxiliary magnetic particles.

26. The composition of any of claim 22-25, wherein the auxiliary magnetic particles exhibit a coercive force of less than 40 kA/m, such as a coercive force ranging from 1 kA/m to less than 40 kA/m, from 5 kA/m to 10 kA/m, from 5 kA/m to less than 40 kA/m, from 5 kA/m to 20 kA/m, from 5 kA/m to 30 kA/m, from 5 kA/m to 40 kA/m.

27. The composition of any of claims 22-26, wherein the auxiliary magnetic particles comprise ferrite particles.

28. The composition of any of claims 22-27, wherein the auxiliary magnetic particles are present in the polymer matrix at a concentration ranging from 0.1% v/v to 60% v/v auxiliary magnetic particles, such as from 0.1% v/v to 50% v/v auxiliary magnetic particles, from 1% v/v to 50% v/v auxiliary magnetic particles, from 5% v/v to 50% v/v auxiliary magnetic particles, from 5% v/v to 60% v/v auxiliary magnetic particles, from 1% v/v to 60% v/v auxiliary magnetic particles, from 10% v/v to 60% v/v auxiliary magnetic particles, from 10% v/v to 50% v/v auxiliary magnetic particles, from 5% v/v to 30% v/v auxiliary magnetic particles, from 10% v/v to 30% v/v auxiliary magnetic particles, from 5% v/v to 25% v/v auxiliary magnetic particles, or from 10% v/v to 25% v/v auxiliary magnetic particles.

29. The composition of any of claims 22-28, wherein the population of auxiliary magnetic particles has an average particle size of from 1 nm to 1 mm (e.g., from 1 micron to 50 microns).

30. An article formed (in whole or in part) from the composition of any of claims 1-29.

31. The article of claim 30, wherein the article comprises a medical device.

32. The article of claim 31, wherein the article comprises a guidewire or portion thereof, such as a guidewire tip (e.g., a TAVR guidewire or TAVR guidewire tip).

33. The article of any of claims 30-32, wherein the article exhibits one or more of (1) reversible, fast, and controllable transforming deformation, 2) shape-locking, and 3) reprogramming capabilities.

34. The article of any of claims 30-33, wherein the article exhibits an actuation speed ranging from 1 millisecond to 10 minutes.

35. A method of actuating the article of any of claims 30-34, comprising the steps of:
providing the article, wherein the device is capable of being programmed to possess a specific primary shape, reformed into a secondary stable shape, and controllably actuated to recover the specific primary shape; and
applying a magnetic field to controllably actuate the article such that it recovers its specific primary shape.

36. The method of claim 35, wherein the magnetic field applied to controllably actuate the article has a frequency of less than 1 kHz and a magnetic field strength of from 0.1 mT to 500 mT.

37. The method of any of claims 35-36, wherein applying the magnetic field comprises inductively heating the polymer matrix to a temperature at or above the Tg of the polymer or blend of polymers forming the shape memory polymer matrix.

38. The method of claim 37, wherein inductively heating the polymer matrix comprises applying magnetic field with a frequency of from 40 Hz to 50 MHz and a magnetic field strength of from 0.1 mT to 100 mT.

39. A method of actuating a device to perform an activity on a subject, comprising the steps of:
positioning a device formed (in whole or in part) from the composition of any of claims 1-29 in a desired position with regard to said subject, wherein the device is capable of being programmed to possess a specific primary shape, reformed into a secondary stable shape, and controllably actuated to recover the specific primary shape; and
actuating the device using an applied magnetic field to controllably actuate the device such that it recovers its specific primary shape.

40. The method of claim 39, wherein the magnetic field applied to controllably actuate the article has a frequency of less than 10 kHz and a magnetic field strength of from 1 mT to 500 mT.

41. The method of any of claims 38-39, further comprising applying a magnetic field to inductively heat the shape memory polymer matrix to a temperature at or above the Tg of the polymer or blend of polymers forming the polymer matrix.

42. The method of claim 41, wherein the magnetic field applied to inductively heat the polymer matrix has a frequency of from 10 kHz to 300 kHz and a magnetic field strength of from 1 mT to 100 mT.
